(19) United States
(12) Patent Application Publication
(10) Pub. No.: US 2026/0269508 A1
(43) Pub. Date: Sep. 10, 2026

(54) RELIABLE, HIGH PERFORMANCE ELECTRICAL CONNECTOR FOR FLEXIBLE CABLE

(71) Applicants: Danren He, Shenzhen (CN); Jingtang Zhou, Shenzhen (CN); Koen Maddens, Hofstade (BE); Amphenol East Asia Electronic Technology (Shenzhen) Co., Ltd., Shenzhen (CN)

(72) Inventors: Danren He, Shenzhen (CN); Jingtang Zhou, Shenzhen (CN); Koen Maddens, Hofstade (BE)

(73) Assignee: Amphenol East Asia Electronic Technology (Shenzhen) Co., Ltd., Shenzhen (CN)

(21) Appl. No.: 19/560,697

(22) Filed: Mar. 9, 2026

(30) Foreign Application Priority Data
Mar. 10, 2025 (CN) 202510287271.8
Dec. 31, 2025 (CN) 202512055028.6
Dec. 31, 2025 (CN) 202522842944.X

(51) Int. Cl. H01R 13/436; H01R 12/77

(52) U.S. Cl. CPC H01R 13/4361; H01R 12/774

(57) ABSTRACT

Reliable, high performance electrical connectors configured for flexible cables. A connector includes terminal(s) for coupling to a flexible cable. Each terminal include a mating end, and a tail having a rigid portion and an elastic beam for cable termination. An inner housing includes a first portion for receiving terminal mating ends, and a second portion for supporting terminal tails and configured to protrude into openings between cable contact pads. An outer housing can cooperate with locking member(s) movable between respective pre-locked positions and locked positions to restrain movement between the components and the cable. A shield may be disposed between the inner and outer housings. A conductive member may be configured to electrically connect the shield and a cable reference layer. Techniques can enable connectors to achieve high performance with enhanced signal integrity, while providing improved durability, insertion and withdrawal cycle life, retention strength, and alignment for flexible cables.

### CROSS-REFERENCE TO RELATED APPLICATIONS

This application claims priority to and the benefit of Chinese Patent Application No. 202522842944.X, filed Dec. 31, 2025. This application also claims priority to and the benefit of Chinese Patent Application No. 202512055028.6, filed Dec. 31, 2025. This application also claims priority to and the benefit of Chinese Patent Application No. 202510287271.8, filed Mar. 10, 2025. The contents of these applications are incorporated herein by reference in their entirety.

### TECHNICAL FIELD

This patent application relates generally to interconnection systems, such as those including electrical connectors, used to interconnect electronic assemblies, and more specifically to electrical connectors for harsh environments, such as in a vehicle.

### BACKGROUND

Electrical connectors are used in many electronic systems. It is generally easier and more cost effective to manufacture a system as separate electronic assemblies, which may be joined together with electrical connectors. Electrical connectors may be used for interconnecting electronic assemblies so that the electronic assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted on the printed circuit boards.

In some systems, connections between electronic assemblies may be made through cables. The cables may be terminated with connectors that mate with connectors mounted on a printed circuit board. In this way, connections between electronic assemblies may be made by plugging a connector that is part of a cable assembly into a board connector that is mounted to the printed circuit board. In other system architectures, a connector terminating a cable may be mated with another connector terminating another cable.

An example of a system in which assemblies are connected through cables is a modern automobile, particularly new energy vehicles that are developed in response to the demand for low-carbon technology and have high requirements for the energy efficiency and reliability of their on-board electronic systems. For example, automotive vehicles include electronic control units (ECUs) for controlling various vehicle systems, such as the engine, transmission (TCUs), security systems, emissions control systems, lighting, advanced driver assistance systems (ADAS), entertainment systems, navigation systems, and cameras. The upgrading and iteration of ADAS increasingly rely on 5G communication technology to achieve high-speed transmission of vehicle-to-infrastructure collaboration data, and big data (including vehicle status data, environmental perception data, user interaction data, etc.) processing capabilities to support core functions, such as environmental perception and path planning. This necessitates that electrical connectors adapt to higher signal transmission rates and stability. These electronic control units may be manufactured as separate assemblies. To simplify manufacture of an automobile, the assemblies may be formed separately and then connected via cables that are terminated with connectors that enable connections to mating board connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal. This interference is particularly pronounced in scenarios involving 5G signal transmission and ADAS data interaction, and may directly impair the accuracy and response speed of vehicle-to-infrastructure collaboration.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators, or power switches. Noise can be particularly disruptive for high speed signals such as those use to communicate data over an automobile network.

### SUMMARY

Aspects of the present disclosure relate to reliable, high performance electrical connectors for flexible cables.

Some embodiments relate to an electrical connector. The electrical connector may comprise a housing comprising a first portion and a second portion, the first portion comprising a plurality of channels, the second portion comprising a plurality of protrusions, and a plurality of grooves disposed between adjacent protrusions of the plurality of protrusions and each in communication with a respective channel of the plurality of channels; a plurality of conductive terminals, each of the plurality of conductive terminals comprising a mating end disposed in a respective channel of the plurality of channels, a tail extending out of the respective channel, and an intermediate portion disposed in the respective channel and between the mating end and the tail; and a flexible cable comprising a connecting portion disposed on the second portion of the housing, the connecting portion comprising a plurality of openings and a plurality of contact pads disposed between adjacent openings of the plurality of openings, each opening of the plurality of openings receiving a respective protrusion of the plurality of protrusions, each contact pad of the plurality of contact pads electrically connected to a respective tail of a respective conductive terminal of the plurality of conductive terminals.

Some embodiments relate to an electrical connector. The electrical connector may comprise a housing comprising an outer housing and an inner housing; a plurality of conductive terminals held in the inner housing, each of the plurality of conductive terminals comprising a mating end, a tail comprising a contact portion, and an intermediate portion between the mating end and the tail; a shield disposed in the outer housing and enclosing the inner housing; a flexible cable comprising a connecting portion disposed in the inner housing and electrically connected to the contact portions of the tails of the plurality of conductive terminals; and a locking member movable between a pre-locked position and a locked position, and configured to engage the outer housing in the pre-locked position, and engage the housing, the shield, and the connecting portion of the flexible cable in the locked position so as to restrain relevant movements therebetween.

Some embodiments relate to an electrical connector. The electrical connector may comprise a housing comprising one or more channels; and one or more conductive terminals held in respective channels of the housing, each of the one or more conductive terminals comprising a mating end, a tail, and an intermediate portion between the mating end and the tail, the tail comprising a rigid portion comprising one or more bulges engaging the housing, and an elastic beam comprising a contact portion configured to electrically couple to a connecting end of a flexible cable.

Some embodiments relate to a method for manufacturing an electrical connector. The method may comprise mounting a conductive terminal to a housing; and inserting a connecting portion of a flexible cable into the housing, wherein: the housing comprises a first feature, and the connecting portion of the flexible cable comprises a second feature; the first feature is configured to form interference with the second feature during the insertion of the connecting portion into the housing, so as to prevent a contact pad on the connecting portion from contacting the conductive terminal; and the first feature is configured to release the interference when the connecting portion is inserted into place in the housing, so as to enable the contact pad to be electrically connected to the conductive terminal.

Some embodiments relate to an electrical connector. The electrical connector may comprise a housing comprising one or more grooves; and one or more conductive terminals held in the housing, each of the one or more conductive terminals comprising a mating end, a tail disposed in a respective groove of the one or more grooves, and an intermediate portion between the mating end and the tail, the tail comprising a rigid portion, and an elastic beam comprising a contact portion configured to electrically couple to a connecting portion of a flexible cable.

Some embodiments relate to an electrical connector. The electrical connector may comprise a housing comprising a first portion and a second portion; a plurality of conductive terminals held in the first portion of the housing, each of the plurality of conductive terminals comprising a mating end, a tail configured for engaging a pad on an FFC, and an intermediate portion between the mating end and the tail, wherein: the second portion of the housing is configured to receive a connecting portion of a flexible cable comprising a plurality of contact pads; and the second portion of the housing is configured to engage the flexible cable such the tails of the plurality of conductive terminals engage respective contact pads of the plurality of contact pads of the flexible cable without wiping the respective contact pads.

Some embodiments relate to an electrical connector. The electrical connector may comprise a housing comprising an outer housing, and an inner housing configured to receive a connecting portion of a flexible cable; a plurality of conductive terminals held in the inner housing, each of the plurality of conductive terminals comprising a mating end, a tail comprising a contact portion configured to be electrically connected to a contact pad of the flexible cable, and an intermediate portion between the mating end and the tail; and a locking member movable between a pre-locked position and a locked position, the locking member configured to engage the outer housing in the pre-locked position, and configured to engage the housing, and the connecting portion of the flexible cable in the locked position so as to restrain movements therebetween.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a top, rear perspective view of an electrical connector, according to some embodiments.

FIG. 1B is a plan view of the electrical connector of FIG. 1A.

FIG. 1C is an exploded perspective view of the electrical connector of FIG. 1A.

FIG. 1D is a cross-sectional view of the electrical connector of FIG. 1A along a line marked “1D-1D” in FIG. 1A.

FIG. 2A is a perspective view of the electrical connector of FIG. 1A, with components hidden and showing terminals connected to a flexible cable.

FIG. 2B is a perspective view of the flexible cable shown in FIG. 2A.

FIG. 3A is a perspective view of a terminal of the electrical connector of FIG. 1A.

FIG. 3B is a plan view of the terminal of FIG. 3A.

FIG. 3C is an elevation view of the terminal of FIG. 3A.

FIG. 3D is a rear view of the terminal of FIG. 3A.

FIG. 4A is a front, bottom perspective view of an outer housing of the electrical connector of FIG. 1A.

FIG. 4B is a top, rear perspective view of the outer housing of FIG. 4A.

FIG. 5A is a cross-sectional view of the electrical connector of FIG. 1A along a line marked “5A-5A” in FIG. 1B.

FIG. 5B is an enlarged view of a region within a dashed box marked “5B” in FIG. 5A.

FIG. 5C is the region of FIG. 5B, with the terminal hidden.

FIG. 6 is a top, rear perspective view of a front member of an inner housing of the electrical connector of FIG. 1A.

FIG. 7 is a top, rear perspective view of a rear member of the inner housing of the electrical connector of FIG. 1A.

FIG. 8 is a perspective view of a conductive member of the electrical connector of FIG. 1A.

FIG. 9A is a perspective view of a locking member of the electrical connector of FIG. 1A.

FIG. 9B is a cross-sectional view of the electrical connector of FIG. 1A along a line marked “9D-9D” in FIG. 1B, showing the locking member in a pre-locked position.

FIG. 9C is a cross-sectional view of the electrical connector of FIG. 1A along a line marked “9D-9D” in FIG. 1B, showing the locking member in a transition position between the pre-locked position and a locked position.

FIG. 9D is a cross-sectional view of the electrical connector of FIG. 1A along the line marked “9D-9D” in FIG. 1B, showing the locking member in the locked position.

FIG. 9E is a cross-sectional view of the electrical connector of FIG. 1A along a line marked “9E-9E” in FIG. 1A.

FIG. 10A is a perspective view of another locking member of the electrical connector of FIG. 1A.

FIG. 10B is a perspective view illustrating the locking member of FIG. 10A in a pre-locked position with respect to the outer housing of the electrical connector of FIG. 1A.

FIG. 10C is a perspective view illustrating the locking member of FIG. 10A in a locked position with respect to the outer housing of the electrical connector of FIG. 1A.

FIG. 11A is a cross-sectional view of the electrical connector of FIG. 1A along a line marked “13A” in FIG. 1B, showing the flexible cable being inserted into position.

FIG. 11B is an enlarged view of a region within a dashed box marked “11B” in FIG. 11A.

FIG. 12A is a cross-sectional view of the electrical connector of FIG. 1A along a line marked “14A” in FIG. 1B, showing the flexible cable being inserted into position.

FIG. 12B is an enlarged view of a region within a dashed box marked “12B” in FIG. 12A.

FIG. 13A is a cross-sectional view of the electrical connector of FIG. 1A along a line marked “13A” in FIG. 1B, showing the flexible cable inserted into position while the locking member of FIG. 9A in the pre-locked position.

FIG. 13B is an enlarged view of a region within a dashed box marked “13B” in FIG. 13A.

FIG. 13C is an enlarged view of a region within a dashed box marked “13C” in FIG. 13A, showing the locking member of FIG. 9A in the locked position.

FIG. 13D is a cross-sectional view of the electrical connector of FIG. 1A along a line marked “13D-13D” in FIG. 9E, showing the locking member of FIG. 9A in the locked position.

FIG. 14A is a cross-sectional view of the electrical connector of FIG. 1A along a line marked “14A” in FIG. 1B, showing the flexible cable inserted into position.

FIG. 14B is an enlarged view of a region within a dashed box marked “14B” in FIG. 14A.

FIG. 15 is a top, rear perspective view of an electrical connector, according to some embodiments.

FIG. 16 is a front, bottom perspective view of the electrical connector of FIG. 15.

FIG. 17 is a cross-sectional perspective view of the electrical connector of FIG. 15.

FIG. 18 is an exploded perspective view of the electrical connector of FIG. 15.

FIG. 19 is an exploded perspective view of a terminal assembly of FIG. 18.

FIG. 20 is a cross-sectional perspective view of the terminal assembly of FIG. 18.

FIG. 21 is another cross-sectional perspective view of the terminal assembly of FIG. 18.

FIG. 22 is a cross-sectional perspective view of the terminal assembly and a locking member of FIG. 18, showing the locking member in a locked position.

FIG. 23 is a cross-sectional perspective view of the terminal assembly and the locking member of FIG. 18, showing the locking member in a pre-locked position.

FIG. 24 is a top, rear perspective view of a first sub-inner housing with conductive terminals of FIG. 19.

FIG. 25 is a partially enlarged view of the first sub-inner housing with the conductive terminals of FIG. 24.

FIG. 26 is a rear perspective view of the first sub-inner housing of FIG. 24.

FIG. 27 is a top, front perspective view of a second sub-inner housing of FIG. 19.

FIG. 28 is a top, rear perspective view of the second sub-inner housing of FIG. 27.

FIG. 29 is an exploded view of the terminal assembly of FIG. 19, with the shield and the second sub-inner housing hidden.

FIG. 30 is a partial perspective view of the terminal assembly of FIG. 19, with the shield and the inner housing hidden.

FIG. 31 is a perspective view of the conductive terminals of FIG. 19.

FIG. 32 is a perspective view of a locking member of the electrical connector of FIG. 15.

FIG. 33 is a perspective view of a conductive member of FIG. 19.

FIG. 34 is an exploded perspective view of an electrical connector, according to some embodiments.

FIG. 35 is a side view of the electrical connector shown in FIG. 34.

FIG. 36 is a perspective view of the electrical connector shown in FIG. 34.

FIG. 37 illustrates an outer housing and a first locking member of the electrical connector shown in FIG. 34.

FIG. 38 is a bottom perspective view of the outer housing of the electrical connector shown in FIG. 34.

FIG. 39 is a perspective view of a first sub-inner housing of the electrical connector shown in FIG. 34.

FIG. 40 is a perspective view of a second sub-inner housing of the electrical connector shown in FIG. 34.

The above accompanying drawings include the following reference signs: 1000, conductive terminal; 1100, mating end; 1200, tail; 1210, 1210′, beam; 1220, contact portion; 1230, bulge; 1240, rigid portion; 1242, first barb; 1250, transition portion; 1300, intermediate portion; 1310, second barb; 1320, terminal protrusion; 1330, flange; 2000, flexible cable; 2001, connecting portion; 2002, first surface; 2003, second surface; 2100, substrate; 2220, contact pad; 2300, insulating layer; 2400, reference layer; 2510, 2520, bonding layer; 2600, first opening; 2700, cable notch; 3000, shield; 3110, mating beam; 3120, first engaging feature; 3130, third engaging feature; 3140, third opening; 3150, shield notch; 4000, conductive member; 4100, first beam; 4200, second beam; 4300, main body; 4310, tab; 5000, inner housing; 5000A, first sub-inner housing; 5000B, second sub-inner housing; 5100, first portion; 5120, second engaging feature; 5200, second portion; 5220, first surface; 5240, top arm; 5300, third portion; 5320, fourth engaging feature; 5340, slot; 5360, second chamfer; 5400, terminal mounting channel; 5410, first groove; 5420, second opening; 5430, second surface; 5440, side groove; 5442, first chamfer; 5450, second groove; 5460, first positioning slot; 5480, limiting groove; 5510, engaging slot; 5520, upper extension; 5530, lower extension; 5540, conductive notch; 5550, top arm; 5560, bottom arm; 5600, first protrusion; 5610, slanted surface; 5620, engaging surface; 5630, top surface; 5700, inner housing notch; 5810, first positioning feature; 5830, separating rib; 5910, second positioning feature; 5912, second positioning slot; 6000, terminal assembly; 6100, assembly engaging feature; 7000, outer housing; 7100, top; 7120, overhanging beam; 7200, bottom; 7210, 7210′, 7210″, first locking portion; 7220, 7220′, 7220″, second locking portion; 7230, first protrusion; 7232, first engaging surface; 7234, first guiding surface; 7240, second protrusion; 7242, second engaging surface; 7244, second guiding surface; 7250, window; 7300, side; 7310, 7310′, first recess; 7321, 7321′, 7231″, first engaging channel; 7322, 7322′, second engaging channel; 7323, 7323′, third engaging channel; 7330, second recess; 7350, third recess; 7500, assembly mounting channel; 7520, outer housing engaging feature; 8000, locking member; 8010, first projection; 8020, second projection; 8030, third projection; 8012, third locking portion; 8050, third body; 8100, first locking member; 8110, first arm; 8111, 8111″, first locking portion; 8113, third engaging surface; 8114, third guiding surface; 8115, slit; 8120, projection; 8122, fourth guiding surface; 8130, first body; 8131, third groove; 8140, third arm; 8200, second locking member; 8210, first projection; 8211, third protrusion; 8220, second projection; 8222, second locking portion; 8230, second body; 9000, connector position assurance.

### DETAILED DESCRIPTION

The inventors have recognized and appreciated connector design techniques for connectors that achieve high performance while providing improved durability, insertion and withdrawal cycle life, retention strength, and alignment for flexible cables. The connectors may be used in the automotive Ethernet application, and may be aimed at lightweighting, and related to the new energy, ADAS, and low-carbon technologies. Conventional designs often suffer from premature wear or deformation of contacts after repeated insertion and withdrawal operations, resulting in poor electrical continuity and reduced service life. Further, the relatively thin and pliable structure of flexible cables can complicate insertion, leading to misaligned or skewed engagement that damages either the cable and/or the connector terminals. Insufficient strength in existing low-profile designs may also raise the risk of unintentional disconnection, particularly in environments subject to vibration or shock, such as those presented by automobiles. Within the complex electrical systems of new energy vehicles that adopt high-precision ADAS signal transmission, this risk exerts a significant negative impact on system reliability. The techniques described herein can provide connectors that both enhance performance and provide reliable mechanical and electrical engagement of the flexible cables under demanding operating conditions. Such connectors may satisfy the stability requirements of automotive Ethernet for high-speed data transmission, while also accommodating the structural optimization demands associated with lightweight design. The techniques described herein may allow manipulations of the flexible cable to be carried out with reduced force.

According to aspects of the present disclosure, a connector may include a housing, conductive terminals, a flexible cable, and a shield. The housing may include an inner housing and an outer housing. The shield may be held between the inner housing and the outer housing. Each conductive terminal may include a mating end, a tail, and an intermediate portion connected between the mating end and the tail. In some embodiments, the inner housing may include terminal mounting channels, so that the conductive terminals are held respectively in the terminal mounting channels. The tails of the conductive terminals may extend out of the respective terminal mounting channels. The tails of the conductive terminals each may be electrically connected to a respective contact pad on a connecting portion of the flexible cable inserted into the inner housing. The shield may surround at least portions of the conductive terminals and/or at least a portion of the connecting portion of the flexible cable.

In some embodiments, the inner housing may comprise a first portion and a second portion. The terminal mounting channels for holding the conductive terminals may be disposed in the first portion of the inner housing. The second portion of the inner housing may comprise first grooves in communication with the terminal mounting channels respectively. The tails of the conductive terminals each may extend into a first groove in communication with a respective terminal mounting channel. The second portion of the inner housing may further comprise first protrusions. The first grooves may be disposed between adjacent first protrusions of the first protrusions. The connecting portion of the flexible cable may comprise first openings for receiving the first protrusions respectively.

In some embodiments, during the insertion of the connecting portion of the flexible cable into the inner housing, the first protrusions on the second portion of the inner housing may lift the connecting portion of the flexible cable along a vertical direction perpendicular to the mating direction of the electrical connector. The contact pads on the connecting portion of the flexible cable may be prevented from contacting the tails of the conductive terminals in the first grooves. Once the connecting portion of the flexible cable is inserted into the inner housing in place, the first openings on the connecting portion may engage with the respective first protrusions. This may allow the lifted connecting portion to lower back into place, bringing the contact pads on the connecting portion of the flexible cable into electrical contact with the tails of the conductive terminals. As a result, during the assembly of the electrical connector, the conductive terminals may not scratch the contact pads of the flexible cable, even after multiple insertion and withdrawal cycle, thereby preventing debris generation. Accumulation of such debris could otherwise impair the electrical performance of the electrical connector.

In some embodiments, the connecting portion of the flexible cable may be held in the inner housing along the mating direction of the electrical connector by engagement of the first protrusions of the second portion with the first openings of the connecting portion. In this way, the contact pads on the connecting portion of the flexible cable may be prevented from moving relative to the tails of the conductive terminals along the mating direction of the electrical connector even in environments subject to vibration or shock, such as those presented by automobiles.

In some embodiments, the electrical connector may include a locking member configured to lock the connecting portion of the flexible cable in the inner housing. In some embodiments, the connecting portion may have a first surface and a second surface opposite to the first surface in the vertical direction of the electrical connector. The first surface may comprise the contact pads and may be supported by the second portion of the inner housing. The locking member may include a protrusion. The protrusion may be inserted into the second portion of the inner housing and may abut against the second surface of the connecting portion, such that the connecting portion of the flexible cable is sandwiched between the second portion of the inner housing and the protrusion of the first locking member along the vertical direction. This may reduce the risks for the first protrusions of the second portion to disengage from the first openings of the connecting portion, providing a reliable electrical connection between the contact pads on the connecting portion of the flexible cable and the tails of the conductive terminals.

In some embodiments, the conductive terminals may be configured to generate desired normal force and provide impedance control at the interface with the flexible cable, thereby providing stable and reliable electrical connection and improving signal integrity performance. In some embodiments, the tails of the conductive terminals each may have an elastic beam. The elastic beam may have a contact portion electrically connected to a respective contact pad on the connecting portion of the flexible cable. The elastic beam may deform to elastically press against the contact pad of the connecting portion by inserting the protrusion into the inner housing. This configuration may protect the contact pad from damage caused by hard contact. Even in environments subject to strong vibration or shock, the contact portion may maintain reliable connection with the contact pad, ensuring consistent signal transmission and reliable signal paths, and avoiding disconnection and/or hard scraping.

In some embodiments, the tails of the conductive terminals each may include a bulge configured to form an interference fit with a limiting groove of the inner housing to reliably fix the tail of the conductive terminal on the second portion of the inner housing and restrict the rotation of the conductive terminal along its circumferential direction. Such a configuration may reduce the risk of a reduction in the contact area between the contact portion and the contact pad caused by the circumferential rotation of the contact portion, as well as poor contact and/or damage to the contact pad by the contact portion.

In some embodiments, the tail of the conductive terminals may include a rigid portion. The bulge may be disposed on the rigid portion. The rigid portion may be parallel to the connecting portion of the flexible cable. The rigid portion may include portions located on opposite sides of the elastic beam along the lateral direction. The rigid portion may provide sufficient mechanical strength to the tail of the conductive terminal, so that the conductive terminal may be reliably mounted to the inner housing through the rigid portion. In some embodiments, barbs may be disposed on opposite sides of the rigid portion along the lateral direction. The barbs may be in interference fit with the limiting groove, which may retain the conductive terminal relative to the inner housing along the mating direction when the rigid portion is inserted into the limiting groove.

In some embodiments, the locking member may be movable between a pre-locked position and a locked position. The locking member may be configured to engage the outer housing in the pre-locked position, and engage the housing, the shield, and the connecting portion of the flexible cable in the locked position so as to restrain relevant movements therebetween. This may enable the connecting portion of the flexible cable to be easily mounted into or removed from the inner housing when the first locking member is in the pre-locked position. Such a configuration may allow the locking member to be pre-installed at a factory, and may enable secure attachment and replacement of the flexible cables in the field.

In some embodiments, the locking member may include a first locking member and a second locking member. The first locking member may include a first body and an arm. Both the arm and the protrusion may extend from the first body along a lateral direction perpendicular to the mating direction of the electrical connector. The first body may be configured to be spaced apart from the side of the outer housing when the first locking member is in the pre-locked position. The first body may be configured to be disposed in the recess of the side of the outer housing when the first locking member is in the locked position. In some embodiments, the arm of the first locking member may be configured to latch to the first locking portion at the bottom of the outer housing when the first locking member is in the pre-locked position, and to latch to the second locking portion at the bottom of the outer housing when the first locking member is in the locked position.

In some embodiments, the second locking member may include a protrusion. The housing may include a housing notch, and the flexible cable may include a cable notch. The protrusion may be inserted into the housing notch and the cable notch to further position the inner housing and the connecting portion of the flexible cable along the mating direction. In some embodiments, the second locking member may comprise a second body and an arm. Both the protrusion and the arm may extend from the second body of the second locking member along a vertical direction perpendicular to both the mating direction and the lateral direction of the electrical connector. The side of the outer housing may comprise a first protrusion, and a second protrusion.

In some embodiments, the second locking member may be movable between a pre-locked position and a locked position. The arm of the second locking member may be configured to latch to the first protrusion on the side of the outer housing when the second locking member is in the pre-locked position, and to latch to the second protrusion on the side of the outer housing when the second locking member is in the locked position. When both the first locking member and the second locking member are in respective pre-locked positions, the flexible cable may be moved freely along the mating direction, which enables the flexible cable to be inserted into or withdrawn from the inner housing without damaging the contact pads of the flexible cable.

In some embodiments, to enhance electromagnetic interference (EMI) shielding performance, exemplarily, the flexible cable may comprise a reference layer covering at least a portion of the conductive layer. The reference layer may be electrically isolated from the conductive layer. The reference layer may be formed from a conductive material, such as conductive tape, copper foil, or aluminum foil.

In some embodiments, the electrical connector may comprise a conductive member configured to electrically connect the shield and the reference layer of the flexible cable. In some embodiments, the conductive member may be made of a metal material, for example, fabricated via processes such as stamping or casting. Optionally, the conductive member may comprise a first beam in electrical contact with the reference layer of the flexible cable and a second beam in electrical contact with the shield.

According to some aspects of the present disclosure, a method for manufacturing an electrical connector may comprise mounting conductive terminals into a housing; and inserting a connecting portion of a flexible cable into the housing. The housing may comprise a first feature, and the connecting portion of the flexible cable may comprise a second feature. The first feature may be configured to form interference with the second feature during the insertion of the connecting portion into the housing, so as to prevent contact pads on the connecting portion from contacting the conductive terminals, and to release the interference when the connecting portion is inserted into the housing in place, so as to electrically connect the contact pads with the conductive terminals. Such a method may reduce the risk for the conductive terminals to scratch the contact pads of the flexible cable during the insertion and withdrawal of the flexible cable, thereby reducing the risk of damaging the contact pads of the flexible cable and generating debris that could impair electrical performance.

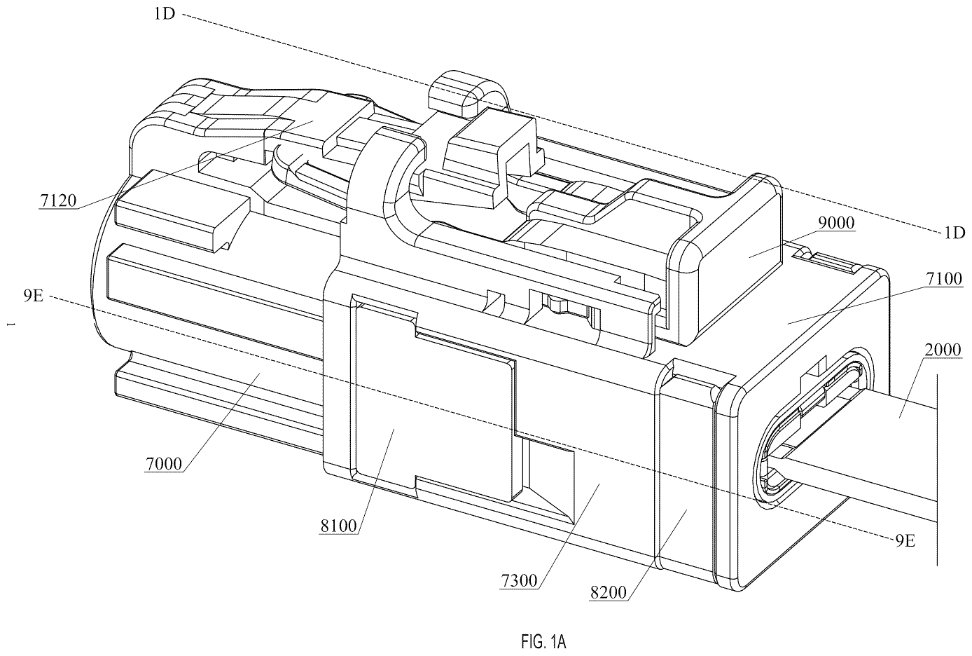

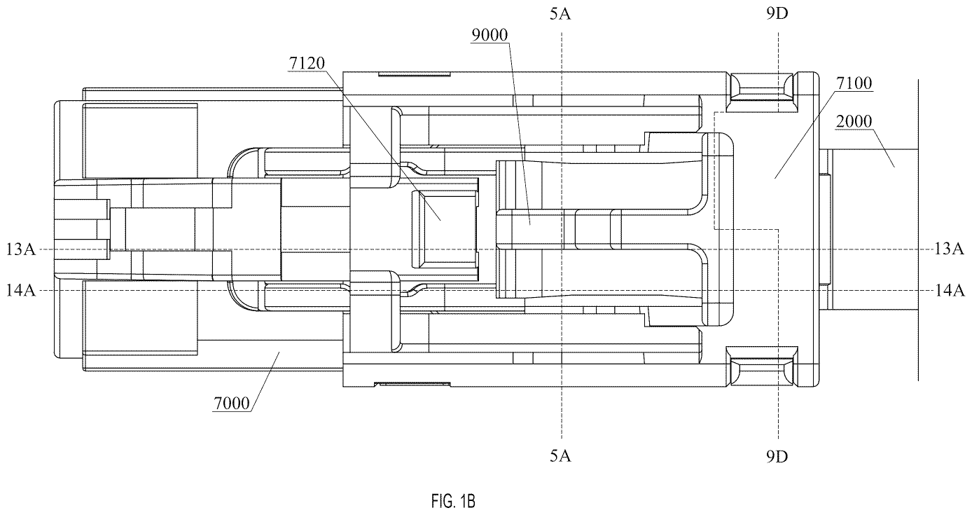

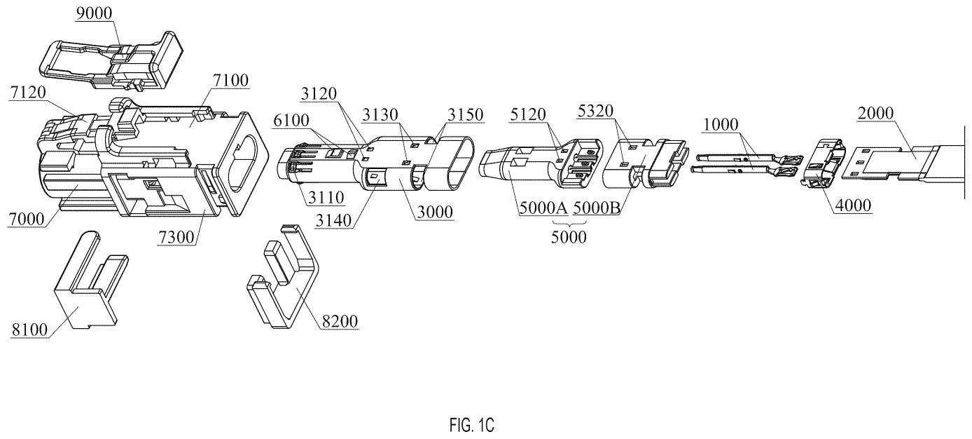

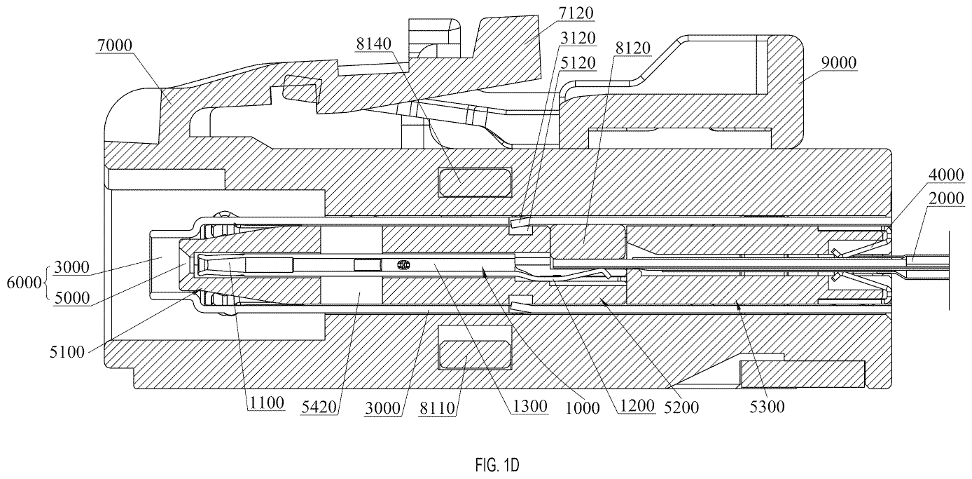

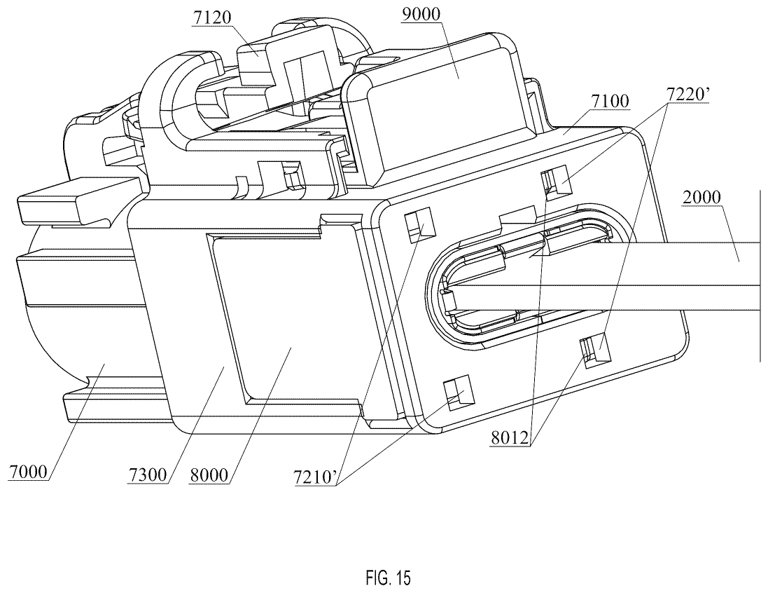

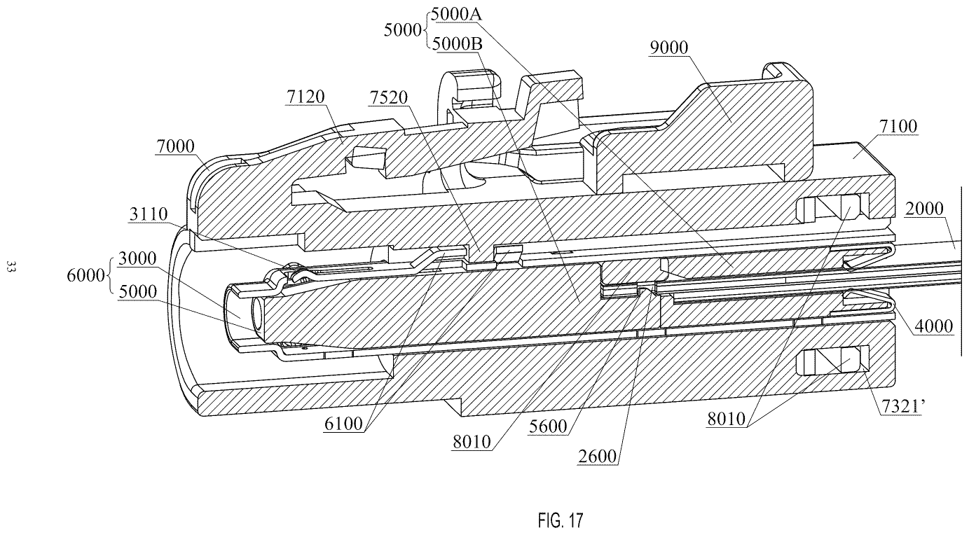

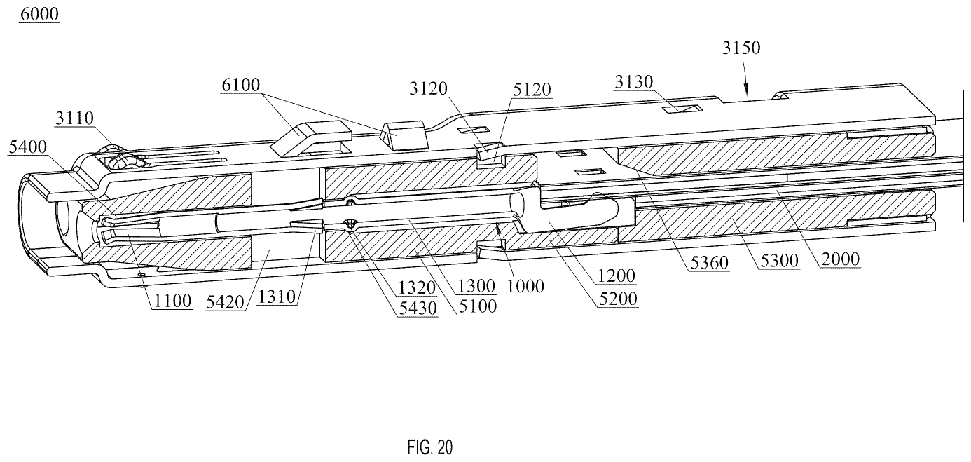

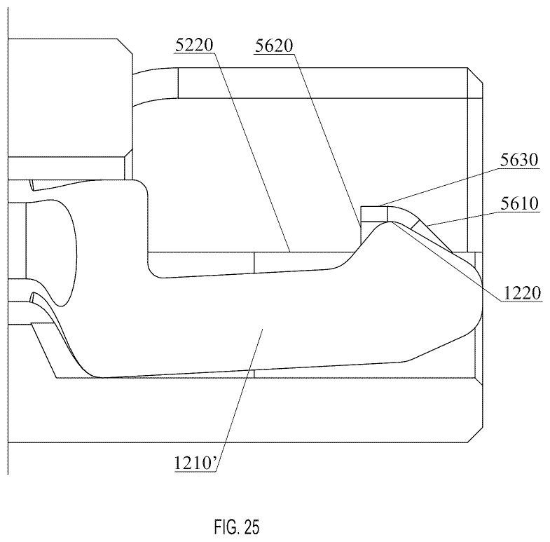

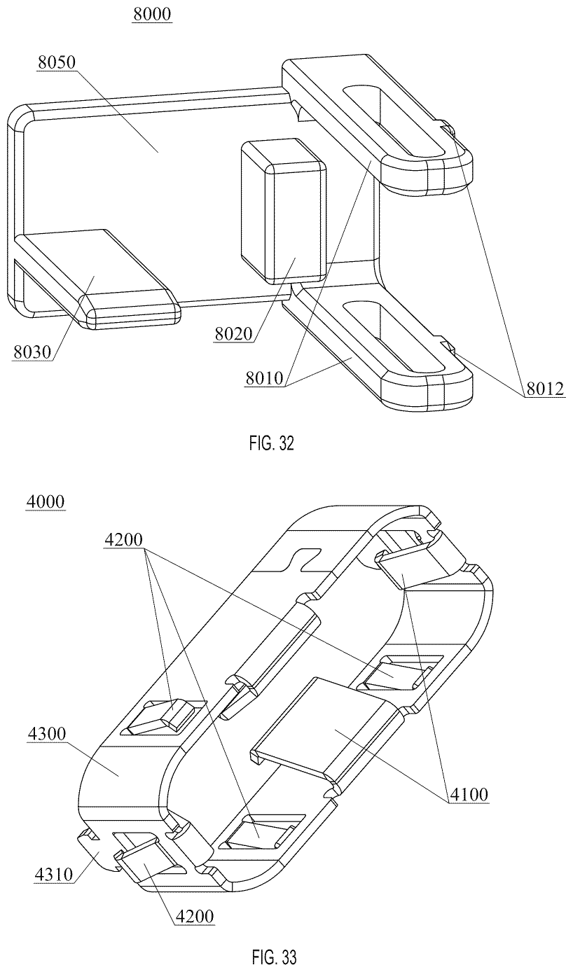

FIGS. 1A to 14B show an electrical connector according to some embodiments of the present disclosure, while FIGS. 15 to 33 show an electrical connector according to some other embodiments of the present disclosure. The electrical connector provided by the embodiments of the present application can be used to interconnect a plurality of electronic assemblies in an electronic system by mating with a complementary electrical component. The electrical connector may be a cable connector. The complementary electrical component may be a board connector, a cable connector, or a circuit board, etc. The board connector may be mounted to a circuit board (not shown), such as a first circuit board. The cable connector may be electrically connected to an electronic assembly such as another circuit board (e.g., a second circuit board) via a cable, enabling the second circuit board to be positioned remotely from the first circuit board. The cable may comprise a Flexible Flat Cable (FFC) and/or a Flexible Printed Circuit (FPC). The cable connector and the board connector may provide interconnection between the first circuit board and the second circuit board. The first circuit board, onto which the board connector is mounted, may be fixed within another electronic assembly. In harsh environments such as those presented by automobiles, the electronic system can provide transmit data signals and/or supply power while withstanding vibration.

The cable connector may comprise a mating portion, e.g., front portion, which is configured to mate with a complementary electrical component (e.g., a board connector). The mating portion may be shaped to match the complementary electrical component, enabling reliable connection therebetween. The cable connector may further comprise a mounting portion. The mounting portion may be opposite to the mating portion along a mating direction of the cable connector with the board connector. Thus, the conductive components in the cable connector may be substantially straight. In an alternative, unillustrated embodiment, the mounting portion may be perpendicular to the mating portion, such that the conductive components in the cable connector may have bends. The conductive components may be mounted into the housing of the cable connector from the mounting portion to the mating portion. A connector position assurance 9000 may be mounted onto the top of the cable connector. Exemplarily, the connector position assurance 9000 may cooperate with a feature on the top of the cable connector to lock the cable connector and the board connector, preventing accidental disconnection.

In some embodiments, the conductive components in the cable connector may comprise a plurality of conductive terminals 1000 and one or more flexible cables 2000. The plurality of conductive terminals 1000 may be arranged in an array, such as a 1×n or 2×n array, where n is greater than or equal to 2. When the plurality of conductive terminals 1000 are arranged in a 2×n array, the conductive components may comprise two flexible cables 2000 with each flexible cable 2000 connected to n conductive terminals 1000 in one row. Alternatively, the n conductive terminals 1000 in each row may also be connected to a plurality of flexible cables 2000 arranged along a direction parallel to the row. The flexible cables 2000 connected to the two rows of conductive terminals 1000 may be stacked along a direction perpendicular to the row. One end of each of the plurality of conductive terminals 1000 may extend to the mating portion of the cable connector for engagement with a complementary electrical component, while the other end of each of the plurality of conductive terminals 1000 may be electrically connected to a proximal end of a respective flexible cable 2000. The proximal end of the flexible cable 2000 may be held in the mounting portion of the cable connector. The distal end of the flexible cable 2000 may extend out of the mounting portion of the cable connector to connect electrically to a remote electronic assembly.

In some embodiments, the proximal end of the flexible cable 2000 may extend all the way to the mating portion of the cable connector to establish electrical connection with the complementary electrical component. For example, a support portion may be disposed in the mating portion of the cable connector, and the proximal end of the flexible cable 2000 may be attached to the support portion to facilitate the electrical connection with the complementary electrical component.

As shown in FIG. 1C, the electrical connector may comprise a housing such as an inner housing 5000. Optionally, the inner housing 5000 may be molded from insulating materials such as plastics. Plastics may include, but are not limited to, liquid crystal polymer (LCP), polyphenylene sulfide (PPS), high-temperature nylon, poly-p-phenylene oxide (PPO), or polypropylene (PP), or any other material. In some cases, the plastic may be a thermosetting plastic. In some cases, the insulating plastic may include an insulating material such as fiberglass reinforcement. The inner housing 5000 may comprise a first portion 5100 and a second portion 5200. The first portion 5100 may comprise a plurality of channels, such as a plurality of terminal mounting channels 5400. The plurality of terminal mounting channels 5400 may be disposed in one-to-one correspondence with the plurality of conductive terminals 1000. Each of the terminal mounting channels 5400 may extend along the mating direction of the electrical connector.

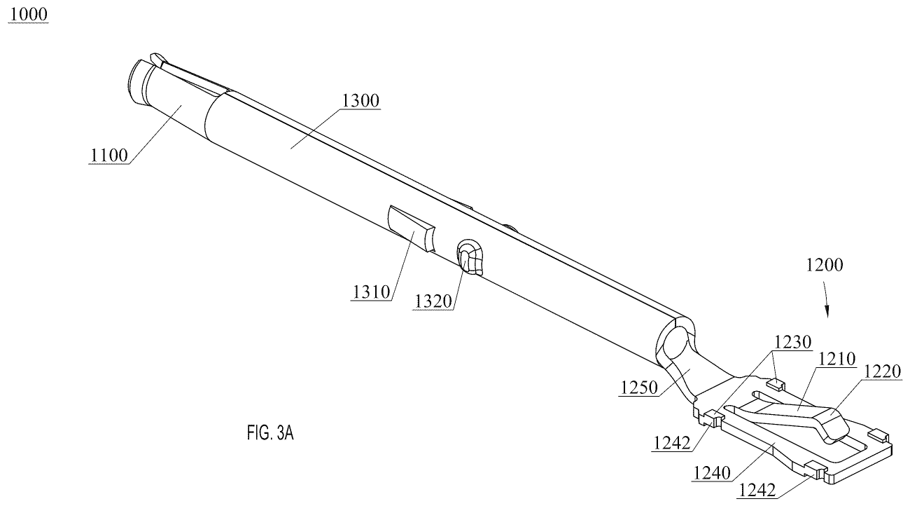

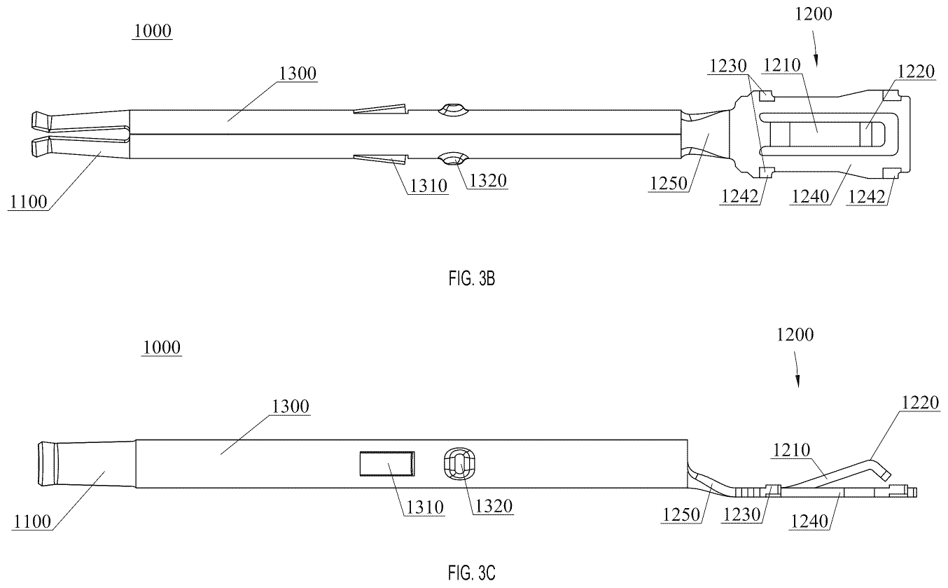

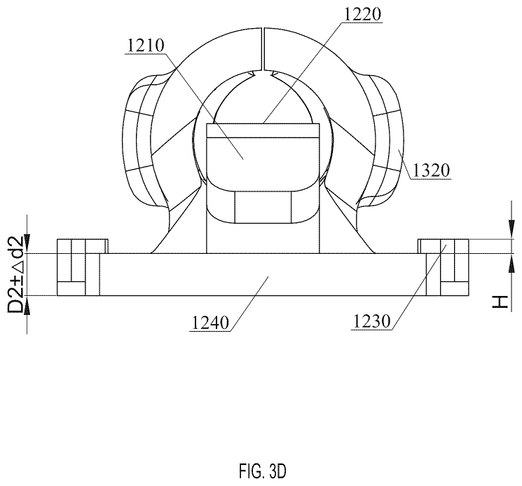

As shown in FIGS. 3A to 3D, the conductive terminals 1000 may be made of conductive materials. Suitable materials for manufacturing the conductive terminals 1000 may include metals or metal alloys, such as copper or copper alloys. Exemplarily, the conductive terminals 1000 each may be made of a metal sheet. The conductive terminals 1000 each may comprise a mating end 1100 disposed in a corresponding terminal mounting channel 5400, a tail 1200 extending out of the corresponding terminal mounting channel 5400, and an intermediate portion 1300 disposed in the corresponding terminal mounting channel 5400 and connecting the mating end 1100 and the tail 1200. The mating end 1100 may be located at the front end of the conductive terminal 1000 for contacting a respective conductor of the complementary electrical component to establish electrical connection between the electrical connector and the complementary electrical component. The complementary electrical component comprises, but is not limited to, an electrical connector or a circuit board. The tail 1200 may be located at the rear end of the conductive terminal 1000 opposite to the mating end 1100 along the length direction of the conductive terminal 1000. The mating end 1100 and the intermediate portion 1300 may be tubular. In the illustrated embodiment, the conductive terminals 1000 may be in the shape of a straight rod with their length direction substantially parallel to the mating direction of the electrical connector. In an alternative, unillustrated embodiment, the conductive terminals 1000 may have other shapes, for example, the conductive terminals 1000 may be bent along their length direction. The terminal mounting channels 5400 may space the conductive terminals 1000 apart from each other, ensuring electrical insulation between the conductive terminals 1000.

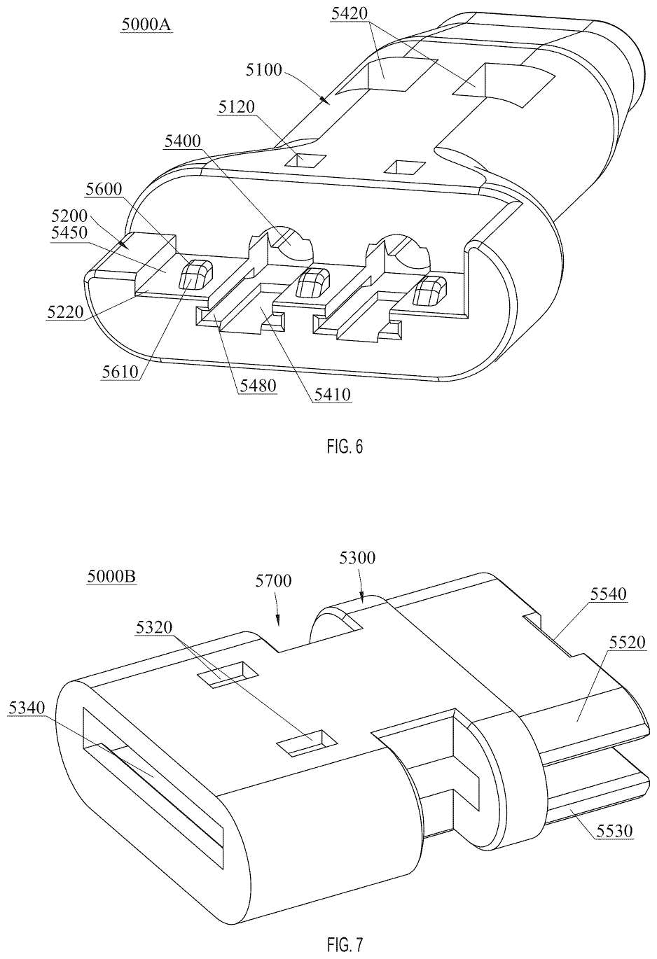

As shown in FIGS. 6 and 7, the second portion 5200 of the inner housing 5000 may comprise a plurality of first grooves 5410. The first grooves 5410 may communicate with the terminal mounting channel 5400 respectively. Each of the tails 1200 of the conductive terminals 1000 extends out of a respective terminal mounting channel 5400 and is disposed in a first groove 5410 communicating with the respective terminal mounting channel 5400. The second portion 5200 of the inner housing 5000 may further comprise a plurality of first features, such as first protrusions 5600. The first grooves 5410 may be disposed between adjacent first protrusions 5600 among the first protrusions 5600. In the illustrated embodiment, the first grooves 5410 and the first protrusions 5600 are arranged alternately, and the first grooves 5410 each may be disposed between two adjacent first protrusions 5600. However, in some unillustrated embodiments, the number of first protrusions 5600 may vary. For example, only two first protrusions 5600 may be provided, with all first grooves 5410 disposed between the two first protrusions 5600. Alternatively, the first grooves 5410 may be disposed between only some of the first protrusions 5600.

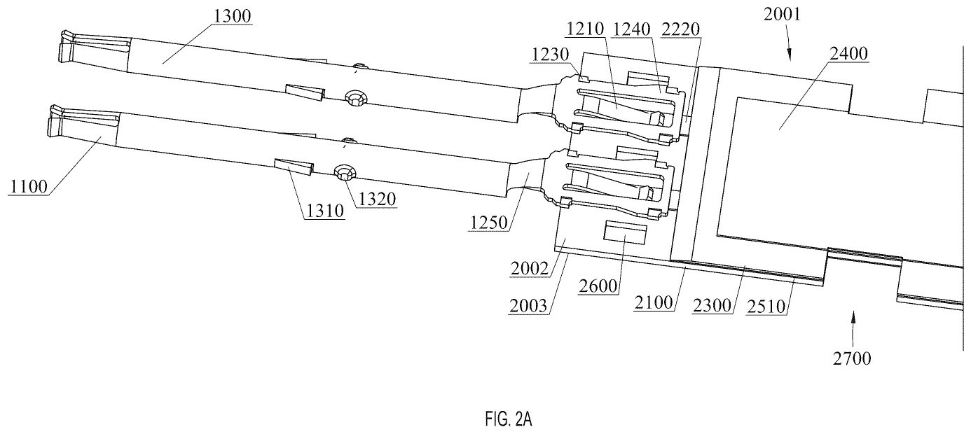

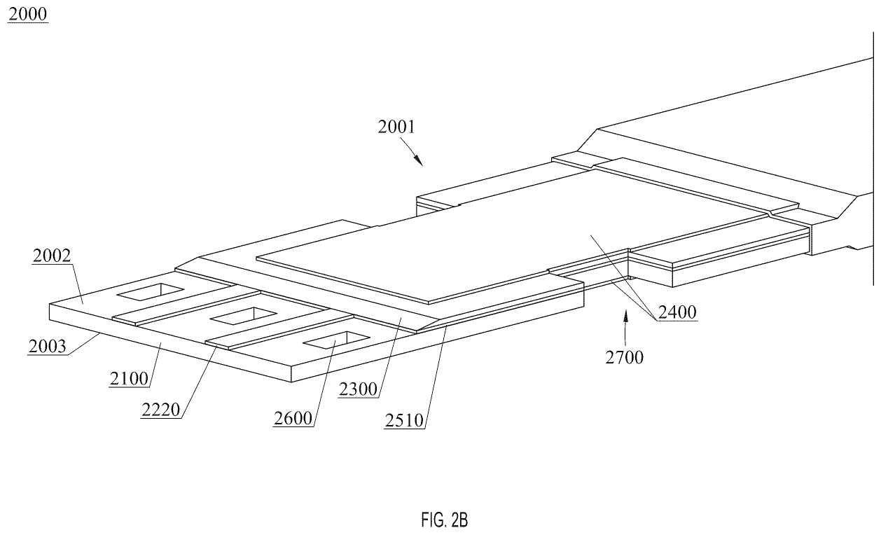

As shown in FIGS. 2A and 2B, the flexible cable 2000 may comprise a connecting portion 2001, which is disposed on the second portion 5200 of the inner housing 5000. The connecting portion 2001 may comprise a plurality of second features, such as first openings 2600, and a plurality of contact pads 2220. The contact pads 2220 are disposed between adjacent first openings 2600. The first openings 2600 may be configured to receive the first protrusions 5600, respectively. The number of the first protrusions 5600 may correspond to that of the first openings 2600, so that the first protrusions 5600 may be respectively engaged with the first openings 2600 to position the flexible cable 2000 at least along the mating direction of the electrical connector. Each of the contact pads 2220 may be electrically connected to a respective tail 1200 of a respective conductive terminal 1000.

As shown in FIGS. 3A to 3D, the tail 1200 of the conductive terminal 1000 may comprise a contact portion 1220, through which the tail 1200 of the conductive terminal 1000 establishes electrical contact with a respective contact pad 2220 of the flexible cable 2000. Exemplarily, the tail 1200 of the conductive terminal 1000 may comprise a beam 1210, with the contact portion 1220 disposed thereon. The beam 1210 may have elasticity, so that the contact portion 1220 on the beam 1210 applies elastic pressure to the respective contact pad 2220 on the flexible cable 2000, thus preventing damage to the contact pad 2220 from excessive pressure. The beam 1210 may comprise a bend, and the contact portion 1220 may comprise a convex surface of the bend.

The conductive terminal 1000 may be fabricated from a metal sheet. If the conductive terminal 1000 is improperly mounted in the terminal mounting channel 5400, for example, with a circumferential offset (see FIGS. 3A to 3D), at least one of two side edges of the contact portion 1220 of the tail 1200 of the conductive terminal 1000 may come into contact with the contact pad 2220. This may cause the edge of the first contact portion 1220 to scratch the contact pad 2220. Additionally, the reduced contact area between the contact portion 1220 and the contact pad 2220 may lead to increased impedance. To ensure proper mounting of the conductive terminal 1000 into the terminal mounting channel 5400, exemplarily, the conductive terminal 1000 may further comprise a first limiting portion, while the inner housing 5000 may comprise a second limiting portion. For each of the conductive terminals 1000, the second limiting portion may be configured to engage with the first limiting portion to prevent the conductive terminal 1000 from rotating circumferentially about the axis of the conductive terminal 1000. Exemplarily, refer to FIGS. 3A to 3D, the first limiting portion of the conductive terminal 1000 may comprise a bulge 1230 protruding from the surface thereof. As shown in FIG. 6, the second limiting portion of the inner housing 5000 may be a limiting groove 5480 configured to receive the first limiting portion. The first limiting portion forms an interference fit with the limiting groove 5480 through the bulge 1230, thereby preventing any slight circumferential rotation of the conductive terminal 1000 about its axis. Exemplarily, the limiting groove 5480 may be disposed in the second portion 5200 of the inner housing 5000. For example, the limiting groove 5480 may be recessed from a sidewall of the first groove 5410 of the second portion 5200 of the inner housing 5000. Correspondingly, the first limiting portion may be located at the tail 1200 of the conductive terminal 1000.

Exemplarily, as shown in FIGS. 2A and 3A to 3C, the tail 1200 of each conductive terminal 1000 may comprise a rigid portion 1240. The rigid portion 1240 may be parallel to the connecting portion 2001 of the flexible cable 2000. The beam 1210 for electrical connection with the contact pad 2220 may be disposed on the rigid portion 1240. The rigid portion 1240 may comprise sub-portions located on opposite sides of the beam 1210, for example, along the lateral direction of the electrical connector that may be parallel to the width direction of the flexible cable 2000. The first limiting portion may comprise the sub-portions. Exemplarily, the rigid portion 1240 may include a frame around the elastic beam 1210. The elastic beam 1210 protrudes from the frame in the vertical direction of the electrical connector. The bulges 1230 may also protrude from the frame along the vertical direction. There may be four bulges 1230 on the rigid portion 1240 at the four corners of the frame. Each bulge 1230 is adjacent to a respective corner of the frame.

The tail 1200 comprising the rigid portion 1240 and the beam 1210 may be made of a metal sheet by a suitable method, such as stamping. The beam 1210 may have a smaller dimension in the vertical direction of the electrical connector and a larger dimension in the lateral direction. The vertical direction may be perpendicular to both the mating direction and the lateral direction, for example, parallel to the thickness direction of the flexible cable 2000. This design enables the beam 1210 to achieve a relatively large contact area when in electrical contact with the contact pad 2220, ensuring stable and reliable electrical connection, while allowing the beam 1210 to elastically deform more easily to prevent damage to the contact pad 2220 caused by hard contact.

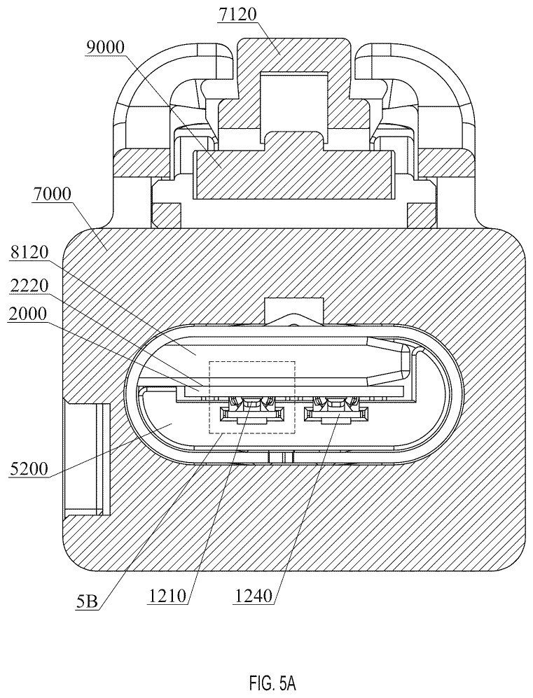

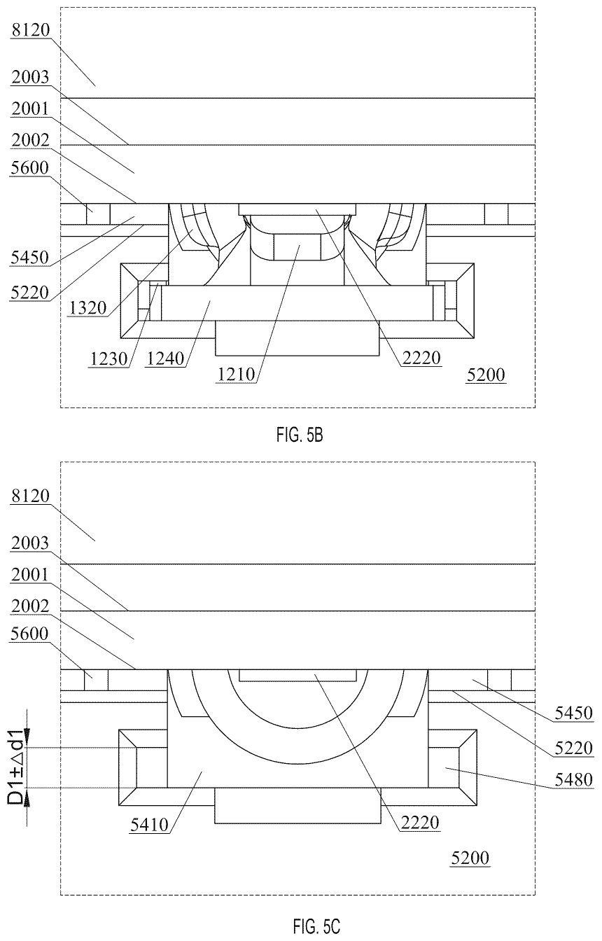

Exemplarily, the bulge 1230 may be formed on the sub-portions of the rigid portion 1240 by a suitable method, such as, stamping. Along the vertical direction, i.e., the protruding direction of the bulge 1230, the dimension of the limiting groove 5480 is D₁±d₁ (in FIG. 5C), and the thickness of the rigid portion 1240 is D2±Δd₂ (in FIG. 3D). Here, D₁>D₂, with Δd₁ and Δd₂ representing the machining tolerances of the limiting groove 5480 and the rigid portion 1240, respectively. Along the protruding direction of the bulge 1230, the thickness H of the bulge 1230 may range between H₁ and H₂, where H₁<H₂. The rigid portion 1240, the bulge 1230 thereon, and the limiting groove 5480 may be processed in accordance with the following relationship: D₁+Δd₁=D₂−Δd₂+H₁. In a specific embodiment, the rigid portion 1240 may have a vertical thickness ranging from 0.14 mm to 0.16 mm; the bulge 1230 may have a vertical thickness ranging from 0.04 mm to 0.06 mm; and the limiting groove 5480 may have a vertical thickness ranging from 0.16 mm to 0.18 mm. This ensures that within the machining tolerance range, the sum of the thicknesses of the rigid portion 1240 and the bulge 1230 may be greater than or equal to the dimension of the limiting groove 5480 in the vertical direction, ensuring interference fit between the finished conductive terminal 1000 and the inner housing 5000.

Exemplarily, first barbs 1242 may be disposed on opposite side surfaces of the rigid portion 1240 along the lateral direction of the electrical connector, as shown in FIGS. 3A to 3B. The first barbs 1242 form an interference fit with the limiting groove 5480 along the lateral direction, further preventing the rigid portion 1240 from being pulled backward out of the limiting groove 5480 along the mating direction of the electrical connector.

Exemplarily, as shown in FIG. 3C, the tail 1200 of the conductive terminal 1000 may be offset from the intermediate portion 1300 in the vertical direction of the electrical connector. The contact portion 1220 of the tail 1200 may face an opposite direction of the offset. For example, the tail 1200 may be offset downward from the intermediate portion 1300 in the vertical direction, and the contact portion 1220 faces upward. Exemplarily, the conductive terminal 1000 may comprise a transition portion 1250 connecting the intermediate portion 1300 and the rigid portion 1240 of the tail 1200, so that the intermediate portion 1300 may be substantially aligned with the connecting portion 2001 of the flexible cable 2000 along the mating direction. Exemplarily, as shown in FIG. 7, the inner housing 5000 may further comprise a third portion 5300, which may be located behind the second portion 5200 in the mating direction. The third portion 5300 may comprise a slot 5340, through which the connecting portion 2001 of the flexible cable 2000 may pass to be mounted on the second portion 5200. The slot 5340 may position the connecting portion 2001 in the lateral direction and the vertical direction of the electrical connector. Since the intermediate portion 1300 of the conductive terminal 1000 is substantially aligned with the connecting portion 2001 along the mating direction, the terminal mounting channel 5400 and the slot 5340 may also be substantially aligned. Consequently, in the vertical direction, a upper sub-portion of the first portion 5100 above the terminal mounting channel 5400 may have a thicknesses substantially consistent with a lower sub-portion of the first portion 5100 below the terminal mounting channel 5400, similarly, a upper sub-portion of the third portion 5300 above the slot 5340 may have a thicknesses substantially consistent with a lower sub-portion of the third portion 5300 below the slot 5340. In this way, a relatively uniform characteristic impedance can be formed along the signal transmission path, enhancing the signal integrity performance of the electrical connecter.

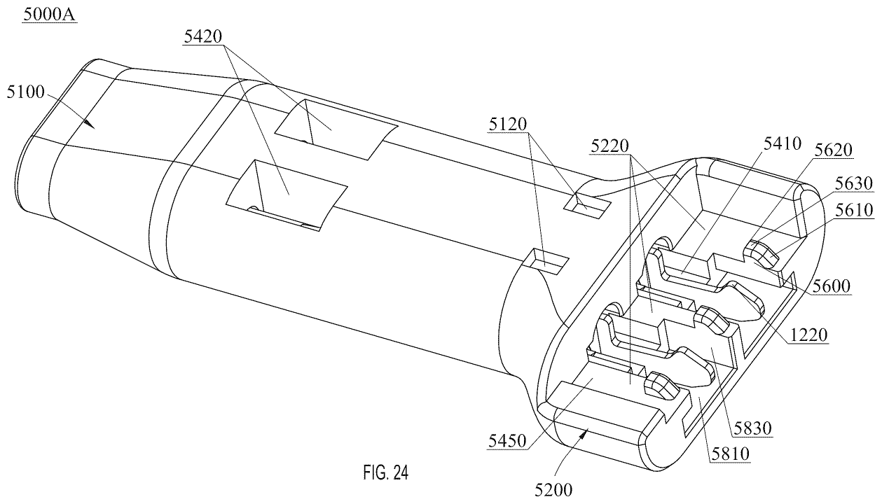

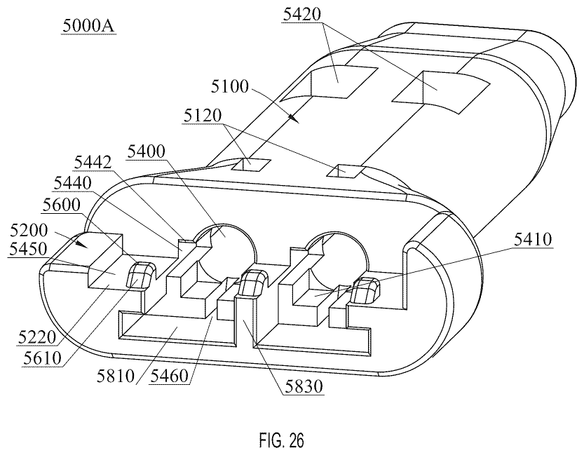

FIGS. 15 to 33 show an electrical connector according to some embodiments of the present disclosure. Specifically, as shown in FIGS. 24-25 and 31, the beam 1210′ of the tail 1200 of each conductive terminal 1000 may be configured to be a metal sheet perpendicular to the connecting portion 2001 of the flexible cable 2000. The contact portion 1220 may comprise the side surface of the metal sheet. For any cross-section of the beam 1210′, the contact portion 1220 is parallel to the corresponding contact pad 2220 on the connecting portion 2001 of the flexible cable 2000. Thus, if the conductive terminal 1000 is improperly mounted in the terminal mounting channel 5400, for example, with circumferential deflection, one of the side edges of the contact portion 1220 may contact the contact pad 2220. This could scratch the contact pad 2220 and degrade the contact resistance between the contact portion 1220 and the contact pad 2220. In the illustrated embodiment, the height (i.e., in the vertical dimension) of the beam 1210′ is significantly larger than its thickness (in the lateral dimension), so the beam 1210′ may have small elasticity or almost no elasticity in the vertical direction. The beam 1210′ may apply reliable pressure to the contact pad 2220 on the connecting portion 2001 of the flexible cable 2000 to ensure reliable electrical contact between the conductive terminal 1000 and the corresponding contact pad 2220 on the connecting portion 2001 of the flexible cable 2000. Therefore, it is more desirable that the conductive terminal 1000 is accurately mounted in the terminal mounting channel 5400. Exemplarily, the first limiting portion of each conductive terminal 1000 may comprise a side flange 1330 protruding from the outer side surface of the intermediate portion 1300. As shown in FIG. 26, the inner housing 5000 may further comprise a side groove 5440. The side flange 1330 may engage with the side groove 5440 to restrict circumferential movement of the conductive terminal 1000. This prevents insufficient contact between the contact portion 1220 on the conductive terminal 1000 and the contact pad 2220 of the flexible cable 2000 caused by circumferential movement of the conductive terminal 1000. Exemplarily, the side groove 5440 may be located in the first portion 5100 of the inner housing 5000, for example, recessed from the inner sidewall of the respective terminal mounting channel 5400. The side groove 5440 may be positioned at the rear end of the respective terminal mounting channel 5400 to facilitate insertion of the side flange 1330 on the conductive terminal 1000.

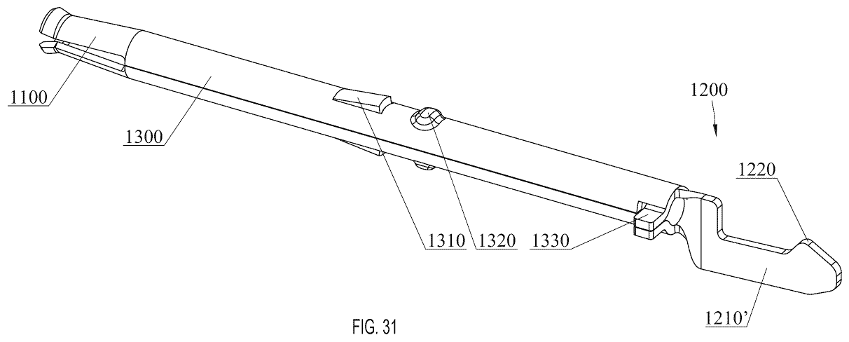

Exemplarily, in combination with FIGS. 26 and 31, the side flange 1330 of each conductive terminal 1000 protrudes along the lateral direction of the electrical connector and abuts against the inner housing 5000 along the lateral direction. The plurality of conductive terminals 1000 are generally arranged in a row parallel to the lateral direction, and in electrical contact with the contact pads 2220 on the flexible cable 2000, respectively. By abutting the inner housing 5000 laterally, the side flanges 1330 maintain a desired pitch between adjacent conductive terminals 1000, enabling consistent impedance matching along the entire length of the conductive terminals 1000. Exemplarily, when the conductive terminals 1000 are mounted to the inner housing 5000, the side grooves 5440 of the inner housing 5000 may engage with the side flanges 1330 of the conductive terminals 1000 in the mating direction, respectively, to limit the positions of the conductive terminals 1000 on the inner housing 5000 forwardly.

Similar to the embodiments in FIGS. 1A to 14B, the second portion 5200 of the inner housing 5000, as shown in FIG. 26, may comprise first grooves 5410 communicating with the terminal mounting channels 5400 in front of the first grooves 5410, respectively. The tails 1200 of the conductive terminals 1000 extending out of the terminal mounting channels 5400 may be disposed in the first grooves 5410, respectively. The second portion 5200 of the inner housing 5000 may further comprise a plurality of first protrusions 5600. The first grooves 5410 may be disposed between adjacent first protrusions 5600 of the plurality of first protrusions 5600. Exemplarily, each of the first grooves 5410 may comprise a first positioning slot 5460. Exemplarily, in the circumferential direction of the respective conductive terminal 1000, the side flange 1330 is offset by 90 degrees relative to the beam 1210′. The beam 1210′ of the tail 1200 of the conductive terminal 1000 may be inserted into the first positioning slot 5460. Exemplarily, a first chamfer 5442 may be disposed at the opening of the side groove 5440. The first chamfer 5442 may guide the side flange 1330 to enter the side groove 5440 smoothly, thereby facilitating insertion of the sheet-like beam 1210′ into the narrower first positioning slot 5460.

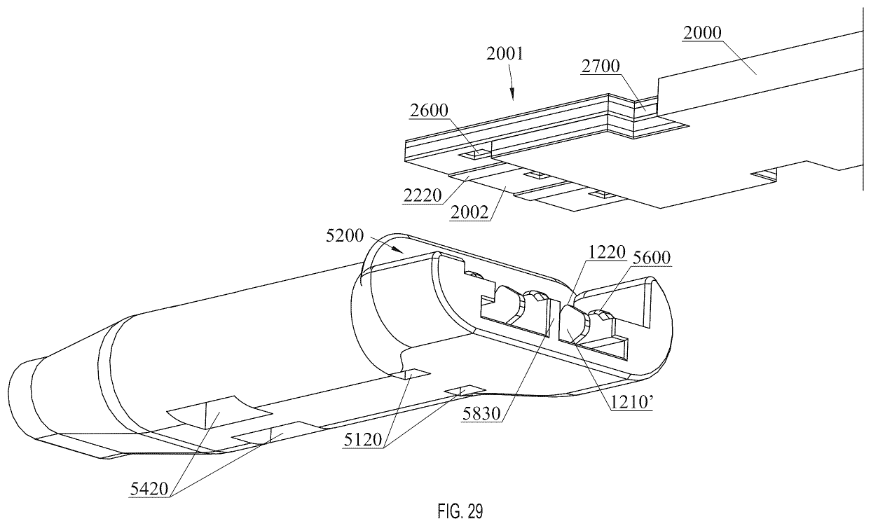

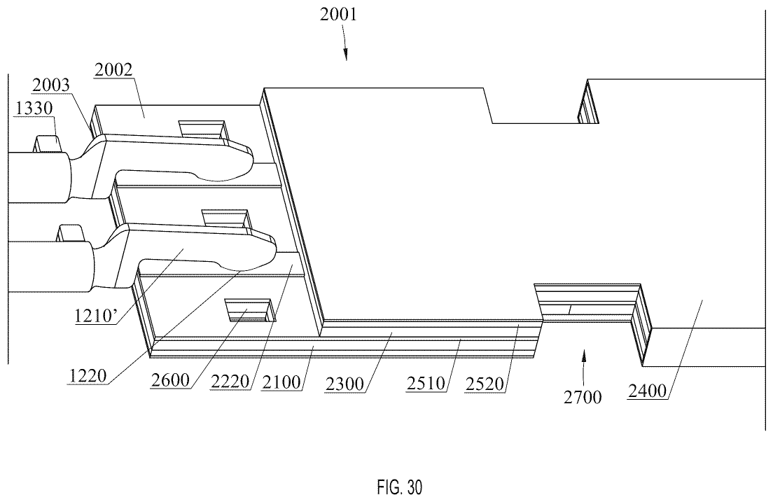

Similar to the embodiments in FIGS. 1A to 14B, the connecting portion 2001 of the flexible cable 2000, as shown in FIGS. 29 to 30, may comprise a plurality of first openings 2600 and a plurality of contact pads 2220 disposed between adjacent first openings 2600 of the plurality of first openings 2600. The first openings 2600 are configured to receive the aforementioned first protrusions 5600, respectively, to limit the position of the flexible cable 2000 at least along the mating direction of the electrical connector. Each of the contact pads 2220 may be electrically connected to the tail 1200 of the respective conductive terminal 1000. The identical reference numerals are used for identical or similar components in the two sets of embodiments. For the sake of brevity, the identical or similar components in the two sets of embodiments are not described repeatedly. In the following, unless otherwise specified, the principles of the present application are described by taking the first set of embodiments as an example with reference to FIGS. 1A to 14B.

Exemplarily, as shown in FIG. 1D, after the electrical connector is assembled, the second portion 5200 of the inner housing 5000 may be located between the first portion 5100 and the third portion 5300. The flexible cable 2000 extends through the slot 5340 of the third portion 5300 of the inner housing 5000 and is mounted onto the second portion 5200 of the inner housing 5000, e.g., along a first direction that may be parallel to the mating direction, such as a forward direction. The slot 5340 may be configured to limit the position of the connecting portion 2001 of the flexible cable 2000 along the lateral direction and/or the vertical direction. The first openings 2600 on the connecting portion 2001 of the flexible cable 2000 are configured to engage with the first protrusions 5600 on the second portion 5200 of the inner housing 5000 after the connecting portion 2001 is inserted into the inner housing 5000 in place along the first direction, so as to limit the position of the flexible cable 2000 along the insertion direction of the flexible cable 2000.

Further, besides preventing the flexible cable 2000 from being pulled out of the inner housing 5000 along a second direction opposite to the first direction, the first protrusions 5600 and the first openings 2600 may be configured to prevent the beams 1210 of the conductive terminals 1000 from contacting the contact pads 2220 of the flexible cable 2000 before they engage. Exemplarily, the first protrusions 5600 and the beams 1210 of the conductive terminals 1000 may be located on the same side of the flexible cable 2000, so that the first protrusions 5600 can keep the connecting portion 2001 of the flexible cable 2000 away from the beams 1210 until they engage with the first openings 2600. In this way, the beams 1210 of the conductive terminals 1000 are impossible to scratch the contact pads 2220 and generate debris during assembling. As the connecting portion 2001 of the flexible cable 2000 is connected to and disconnected from the conductive terminal 1000 over multiple cycles, repeated scratching of the contact pads 2220 by the beams 1210 would lead to debris accumulation inside the connector, which could affect its electrical performance.

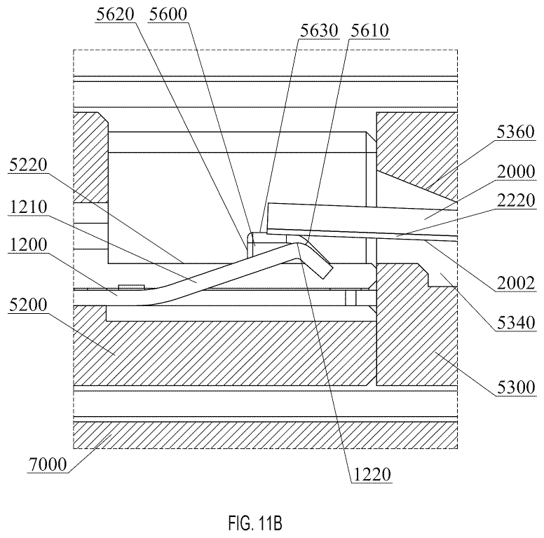

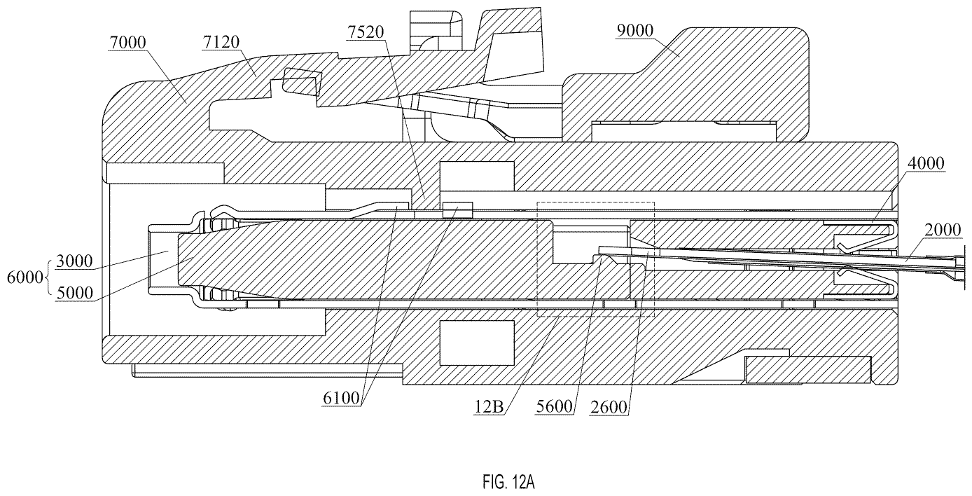

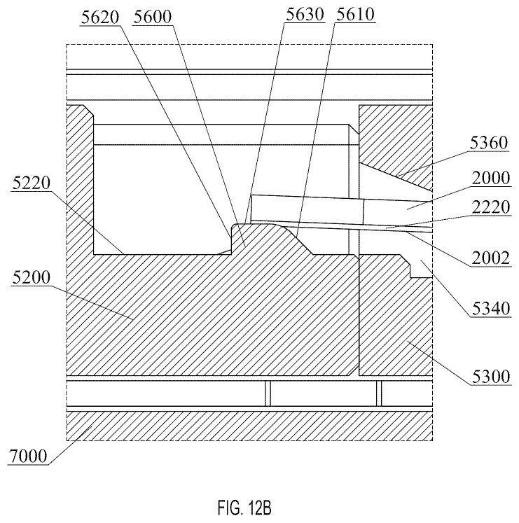

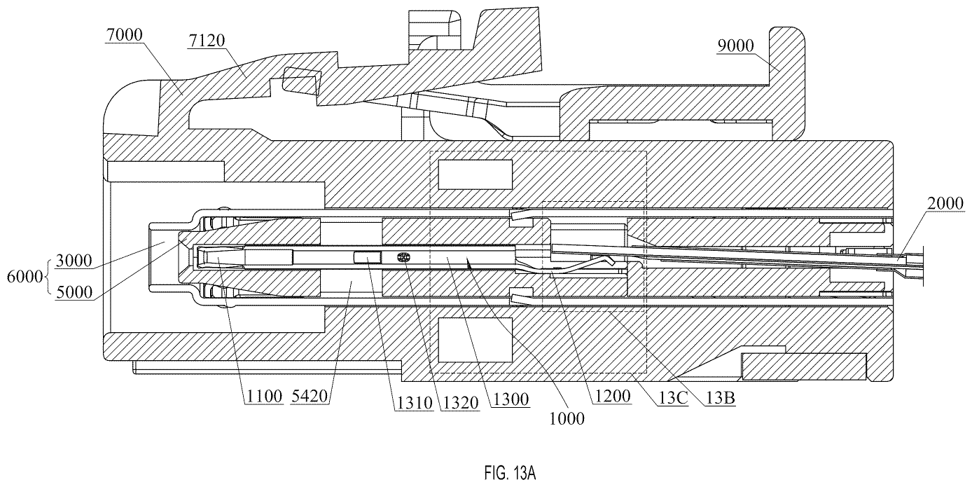

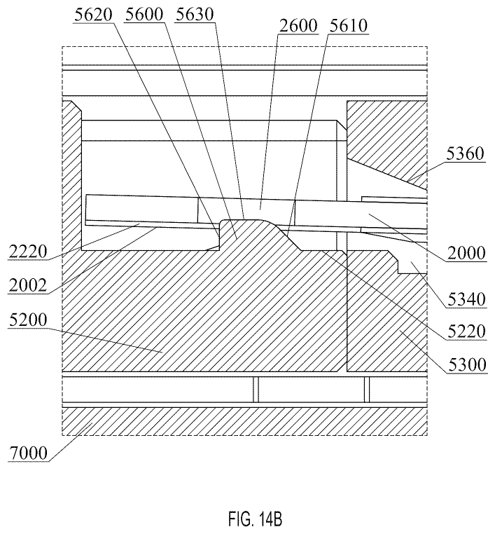

Exemplarily, each of the first protrusions 5600 may include a first guiding surface, such as a slanted surface 5610, as shown in FIGS. 6, 11B, 12B, and 14B. The slanted surface 5610 may face away from the mating ends 1100 of the plurality of conductive terminals 1000, for example, toward the second direction opposite to the insertion direction of the connecting portion 2001. Alternatively, the first guiding surface may be a curved surface, provided that the first guiding surface is closer to the second portion 5200 of the inner housing 5000 as it extends along the second direction. As the connecting portion 2001 of the flexible cable 2000 is mounted to the second portion 5200 of the inner housing 5000 along the first direction, the connecting portion 2001 may be gradually lifted by the first guiding surface, such as the slanted surface 5610 (as shown in FIGS. 11B and 12B), until the first openings 2600 of the connecting portion 2001 are vertically aligned with the first protrusions 5600 of the inner housing 5000, allowing the first protrusions 5600 to engage with the first openings 2600, respectively (as shown in FIG. 14B). In the illustrated embodiment, when the first openings 2600 of the connecting portion 2001 align with the first protrusions 5600 under the guide of the slanted surface 5610, the connecting portion 2001 falls back under gravity, so that the first protrusions 5600 can be inserted into the first openings 2600, respectively. The first surface 2002 of the connecting portion 2001 where the contact pads 2220 are located may face the first protrusions 5600, so that during the falling back of the connecting portion 2001 under gravity, the first protrusions 5600 fit into the first openings 2600 from the side of the first surface 2002. Thus, the flexible cable 2000 can be prevented from moving backward. To ensure reliable engagement between the first openings 2600 and the first protrusions 5600, exemplarily, the first protrusions 5600 may further include engaging surfaces 5620 facing the mating ends 1100 of the plurality of conductive terminals 1000. The engaging surfaces 5620 may be steeper than the slanted surfaces 5610. For example, the engaging surfaces 5620 may be substantially perpendicular to the mating direction of the electrical connector.

Exemplarily, the first protrusions 5600 may further include top surfaces 5630 that connect the slanted surfaces 5610 and the engaging surfaces 5620. The contact portions 1220 on the beams 1210 of the tails 1200 of the conductive terminals 1000 may be electrically coupled to the contact pads 2220 through physical contact, respectively. At least a portion of the top surfaces 5630 may be vertically higher than the contact portions 1220, as shown in FIG. 11B. When the connecting portion 2001 of the flexible cable 2000 is inserted into the second portion 5200 through the third portion 5300 of the inner housing 5000, the contact pads 2220 on the first surface 2002 can be prevented from contacting the contact portions 1220 of the conductive terminals 1000, thereby avoiding scratches on the contact pads 2220.

Exemplarily, the second portion 5200 of the inner housing 5000 may include a first surface 5220, and the plurality of first protrusions 5600 of the inner housing 5000 may protrude from the first surface 5220. The slanted surfaces 5610 may be gradually rise above the first surface 5220 as they extend toward the mating ends 1100 of the conductive terminals 1000. In this way, when the connecting portion 2001 of the flexible cable 2000 is inserted into the inner housing 5000 along the first direction, the slanted surfaces 5610 can guide the connecting portion 2001 to gradually move away from the first surface 5220 in the vertical direction. Exemplarily, as shown in FIG. 11B, the slanted surfaces 5610 may protrude beyond the contact portions 1220 in the direction away from the mating ends 1100 of the conductive terminals 1000 (i.e., the second direction opposite to the first direction). Positioned behind the contact portions 1220, the slanted surface 5610 can prevent the contact pads 2220 from contacting the contact portions 1220 during the insertion of the flexible cable 2000 into the inner housing 5000. Exemplarily, at least portions of the first protrusions 5600 may protrude beyond the contact portions 1220 in their protruding direction. At least one first protrusion 5600 is higher than the contact portion 1220 in the vertical direction of the electrical connector. In this way, during the insertion of the flexible cable 2000 into the inner housing 5000, the portions of the first protrusions 5600 protruding beyond the contact portions 1220 can lift the connecting portion 2001, preventing the contact pads 2220 from contacting the contact portions 1220. Portions of the slanted surfaces 5610 may be vertically higher than the first surface 5220 and disposed on the rear side of the contact portions 1220. The distance between the top surfaces 5630 and the first surface 5220 may be slightly larger than the height of the contact portions 1220 protruding from the first surface 5220 in the vertical direction. Once the flexible cable 2000 is mounted in place, the connecting portion 2001 may be supported on the first surface 5220.

Exemplarily, as shown in FIG. 11B, to ensure sufficient space for the connecting portion 2001 when it is lifted by the slanted surface 5610 of the inner housing 5000, the inner housing 5000 may include a second chamfer 5360. The second chamfer 5360 may face the slanted surface 5610 and be located behind the slanted surface 5610. The second chamfer 5360 may be disposed at the front end of the slot 5340 of the third portion 5300 of the inner housing 5000.

In some unillustrated embodiments, the first features may be configured as grooves, while the second features may be configured as protrusions. In some alternative embodiments, both the first features and the second features may be configured as protrusions. In such embodiments, the height of the contact portions 1220 of the conductive terminals 1000 protruding from the first surface 5220 may be no less than that of the protrusions on the inner housing 5000 protruding from the first surface 5220 in the vertical direction. When the flexible cable 2000 is inserted into the inner housing 5000, contact between the protrusions on the connecting portion 2001 of the flexible cable 2000 and those on the inner housing 5000 causes the protrusions on the inner housing 5000 to lift the connecting portion 2001. Prior to this lifting, the contact portions 1220 of the conductive terminals 1000 are positioned forward of the connecting portion 2001 along the mating direction, preventing contact between the terminal contact portions 1220 and the cable's contact pads 2220. Once the flexible cable 2000 is inserted in place, the connecting portion 2001 drops downward in the vertical direction, bring the contact portions 1220 of the conductive terminals 1000 into electrical contact with the contact pads 2220. Simultaneously, the protrusions on the inner housing 5000 engage the protrusions on the connecting portion 2001 of the flexible cable 2000 along the mating direction, restricting backward movement of the flexible cable 2000. Forward movement of the connecting portion 2001 of the flexible cable 2000 may be limited by the transition portions 1250 that connect the intermediate portions 1300 and the tails 1200 of the conductive terminals 1000.

As shown in FIGS. 6 and 5B to 5C, the second portion 5200 of the inner housing 5000 may have a second groove 5450. The second groove 5450 may be recessed from the upper surface of the second portion 5200. The front end of the connecting portion 2001 of the flexible cable 2000 may be received in the second groove 5450. The bottom surface of the second groove 5450 may serve as the first surface 5220 for supporting the connecting portion 2001. Exemplarily, the depth of the second groove 5450 may be approximately equal to the thickness of the connecting portion 2001. Thus, when the front end of the connecting portion 2001 is seated in the second groove 5450, the second surface 2003 of the connecting portion 2001 (vertically opposite the first surface 2002 where the contact pads 2220 are located) is substantially flush with the upper surface of the second portion 5200 or slightly higher than the upper surface of the second portion 5200. The areas of the first surface 2002 of the connecting portion 2001 not covered by a conductive layer may abut against the first surface 5220 at the bottom of the second groove 5450. The second groove 5450 may restrict the connecting portion 2001 along the lateral direction.

Generally, the flexible cable 2000 may include a substrate 2100, a conductive layer formed on the substrate 2100, and an insulating layer 2300 covering the conductive layer. A bonding layer 2510 may be formed between the substrate 2100 and the conductive layer for bonding the two adjacent layers together. Optionally, a similar bonding layer may also be disposed between the conductive layer and the insulating layer 2300, or the insulating layer 2300 may be directly attached to the conductive layer and the substrate 2100 by using its own material properties (e.g., thermosetting property). Alternatively, since the conductive layer only covers a part of the substrate 2100, the insulating layer 2300 may be attached to the substrate 2100 by using the bonding layer 2510 not covered by the conductive layer, thereby sandwiching the conductive layer between the bonding layer 2510 and the insulating layer 2300. The conductive layer may comprise a plurality of conductive traces. Exemplarily, the conductive traces extend to the connecting portion 2001 and are exposed outside the insulating layer 2300 to form the contact pads 2220. The conductive layer may be formed by any suitable method, such as photolithography, or printing.

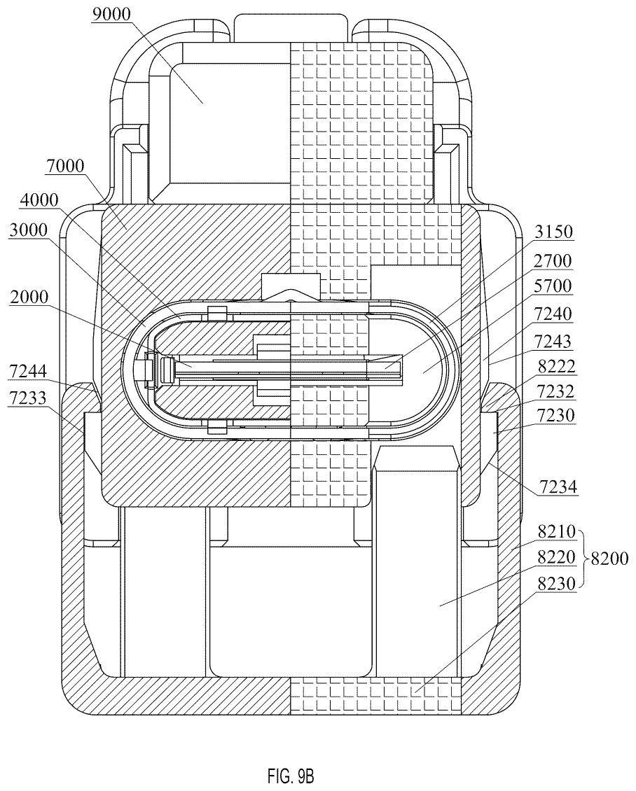

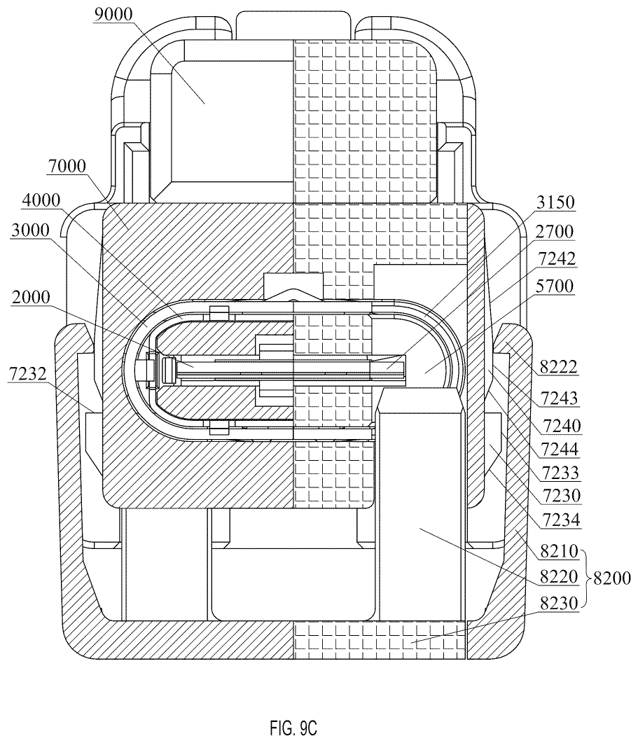

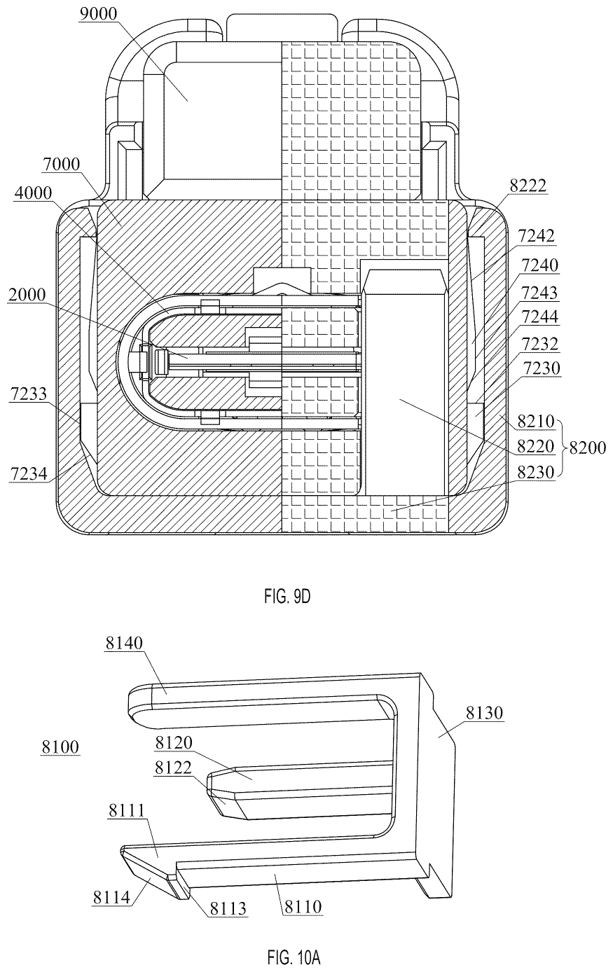

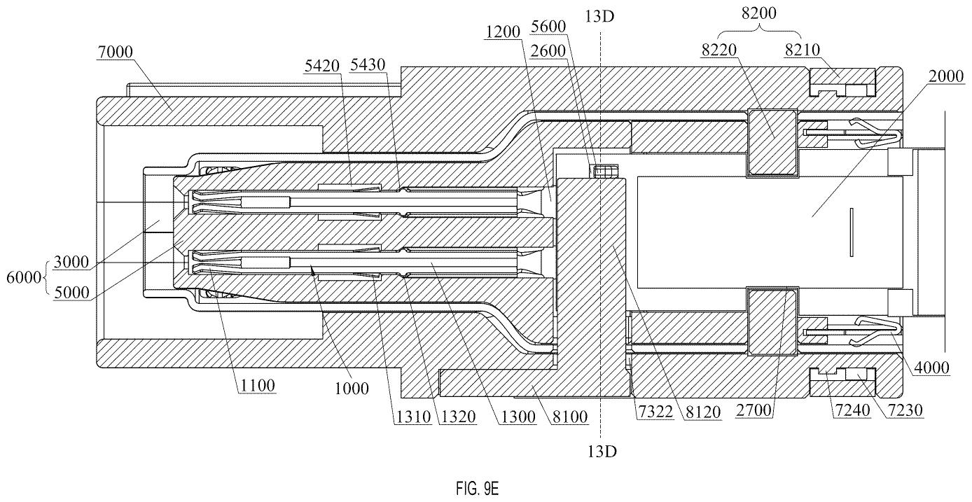

Exemplarily, the conductive terminals 1000 may comprise third features on side walls thereof, and the inner housing 5000 may comprise fourth features. The third features engage with the fourth features to position the conductive terminals 1000 within the inner housing 5000 along the mating direction of the electrical connector. Exemplarily, the fourth features may include second openings 5420, see FIGS. 6 and 9D, which may be disposed on the first portion 5100 of the inner housing 5000. The second openings 5420 each may communicate with a respective terminal mounting channel 5400 in the vertical or lateral direction. The third features of the conductive terminals 1000 may include second barbs 1310 protruding from the side surfaces of the conductive terminals 1000, as shown in FIGS. 3A to 3C. Exemplarily, the second barbs 1310 may be disposed on the intermediate portions 1300 of the conductive terminals 1000. The second barbs 1310 may be tapered forward. The second barbs 1310 of the conductive terminals 1000 may engage with the second openings 5420 respectively, to position the conductive terminals 1000 against backward movement. Specifically, when the conductive terminals 1000 are respectively inserted into the terminal mounting channels 5400 from the rear, the second barbs 1310 and/or the terminal mounting channels 5400 may undergo elastic deformation. Once the conductive terminals 1000 are fully inserted, they return to their original shapes, with the second barbs 1310 abutting against the rear sidewalls of the second openings 5420, thereby preventing the conductive terminals 1000 from being pulled out backward. Thus, the conductive terminals 1000 can be positioned in the terminal mounting channels 5400, respectively. In this embodiment, each conductive terminal 1000 is provided with second barbs 1310 on opposite sides along the vertical direction. The second openings 5420 may extend vertically from the outer side surface of the inner housing 5000 to the terminal mounting channels 5400, reducing manufacturing complexity.

Exemplarily, the third features may further include terminal protrusions 1320 protruding outward from the side walls of the conductive terminals 1000. Exemplarily, the terminal protrusions 1320 may be disposed on the intermediate portions 1300 of the conductive terminals 1000. The terminal protrusions 1320 may be located on the rear side of the second barbs 1310. The fourth features may further include second surfaces 5430 formed on the sidewalls of the terminal mounting channels 5400, see FIG. 9D. The second surfaces 5430 may be located behind the second openings 5420 and face the tails 1200 of the conductive terminals 1000. Once the second barbs 1310 engage with the second openings 5420, the terminal protrusions 1320 of the conductive terminals 1000 may abut forwardly against the second surfaces 5430, so that the conductive terminals 1000 can be secured in the terminal mounting channels 5400 respectively. Rear portions of the terminal mounting channels 5400 located behind the second surfaces 5430 may be thicker than front portions of the terminal mounting channels 5400 located in front of the second surfaces 5430. The thicker rear portions may allow the terminal protrusions 1320 to pass through, while the thinner front portions may restrict movement of the conductive terminals 1000 in directions perpendicular to the axes of the conductive terminals 1000. Exemplarily, the second surfaces 5430 may each slope toward the outer periphery of the terminal mounting channels 5400 respectively, as they extend backward. In this way, even if there is a machining tolerance in the distance between the second barbs 1310 and the terminal protrusions 1320, the terminal protrusions 1320 can still abut against the second surfaces 5430.

Additionally, the first openings 2600 of the connecting portion 2001 of the flexible cable 2000 may engage with the first protrusions 5600, so that the conductive terminals 1000 and the connecting portion 2001 of the flexible cable 2000 are securely retained on the inner housing 5000. This secures reliable electrical connection between the tails 1200 of the conductive terminals 1000 and the contact pads 2220 of the connecting portion 2001 of the flexible cable 2000, as well as with the complementary electrical component. In environments subjected to strong vibration or shock, such as the harsh environments presented in vehicles, the conductive terminals 1000 and the flexible cable 2000 can maintain a stable connection, thereby ensuring consistent signal transmission and reliable signal paths. Furthermore, the compact design of the conductive terminals 1000 contributes to the overall miniaturization of the electrical connector.

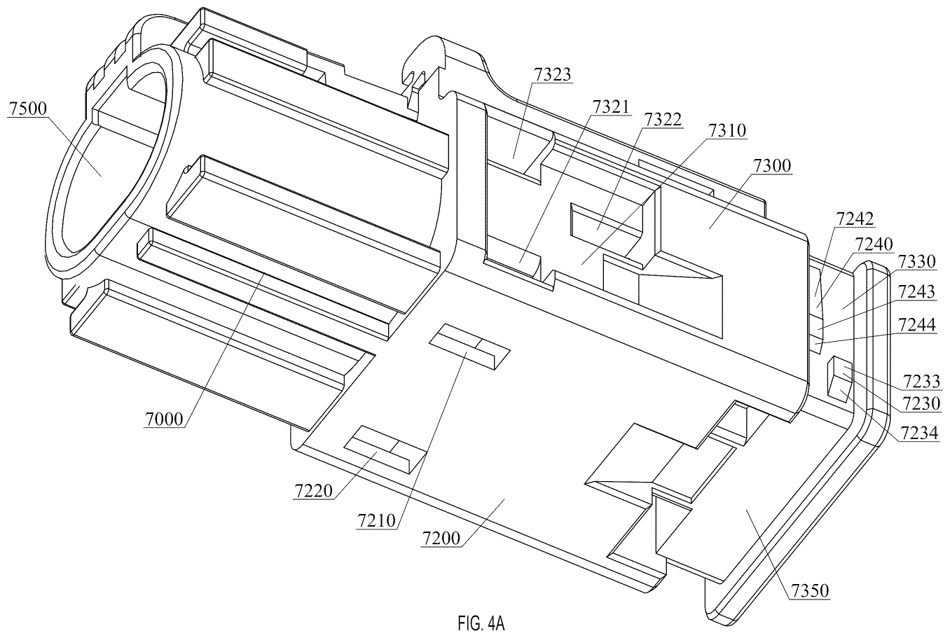

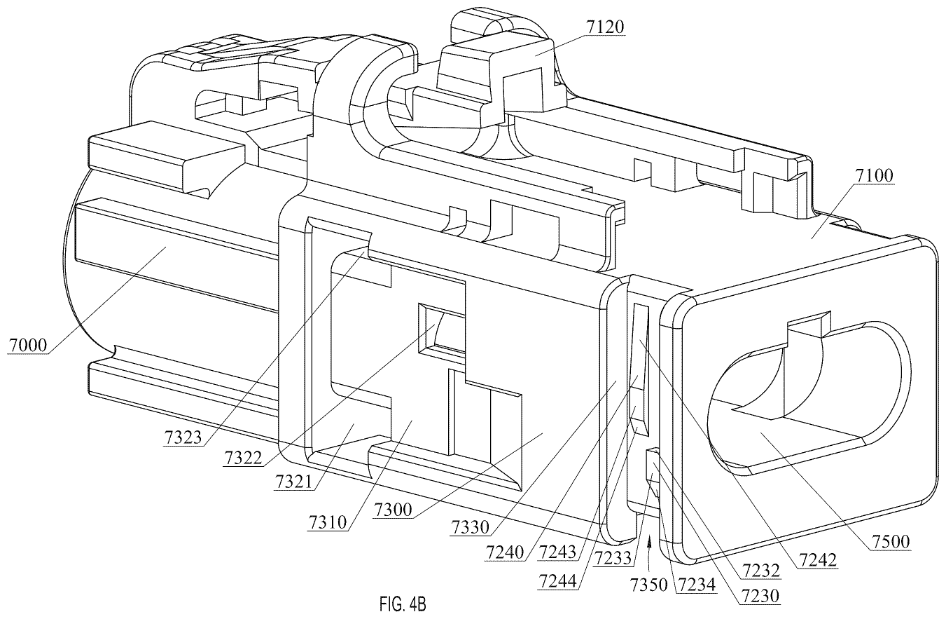

As shown in FIGS. 1A-1C and 4A-4B, the electrical connector may further comprise a housing, such as outer housing 7000. Optionally, the outer housing 7000 may be molded from insulating materials, such as plastics. Plastics may include, but are not limited to, liquid crystal polymer (LCP), polyphenylene sulfide (PPS), high-temperature nylon, poly-p-phenylene oxide (PPO), or polypropylene (PP), or any other materials. In some cases, the plastic may be a thermosetting plastic. Exemplarily, as shown in FIGS. 1C, 10A-10C, and 13C-13D, the electrical connector may further comprise a first locking member 8100. The first locking member 8100 may at least cooperate with the beams 1210 of the conductive terminals 1000 to clamp the connecting portion 2001 of the flexible cable 2000. Specifically, the first locking member 8100 may comprise a first body 8130 and a projection 8120. The projection 8120 extends from the first body 8130, for example, along the lateral direction of the electrical connector.

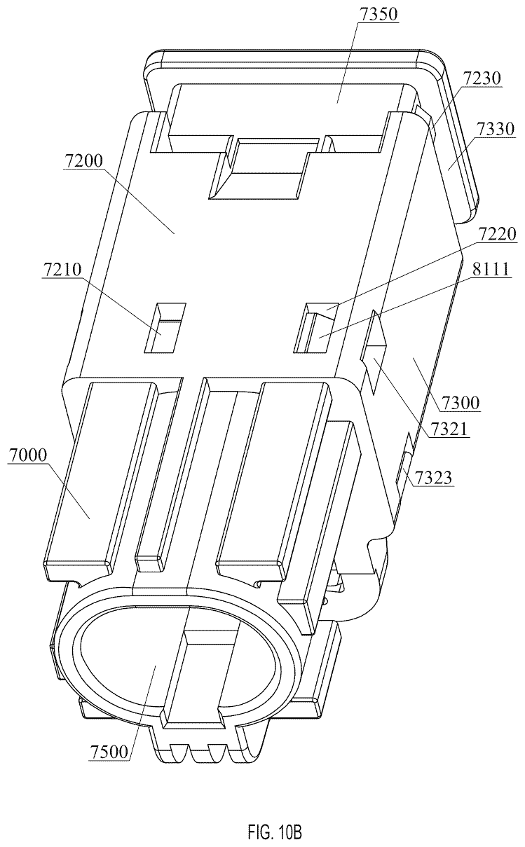

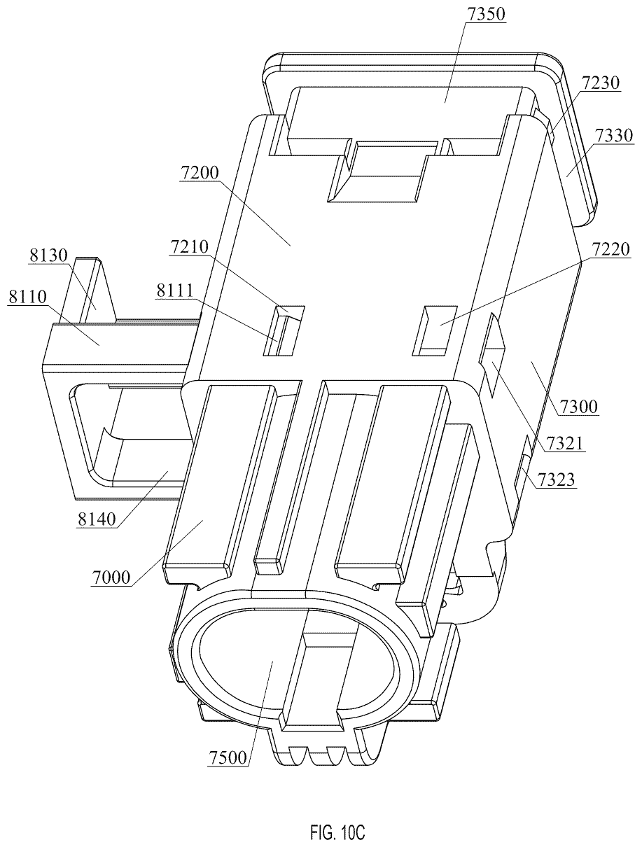

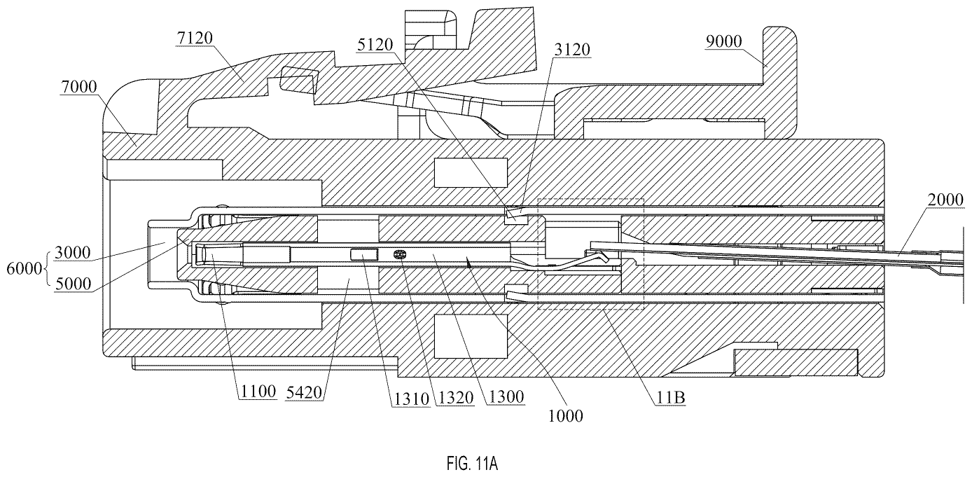

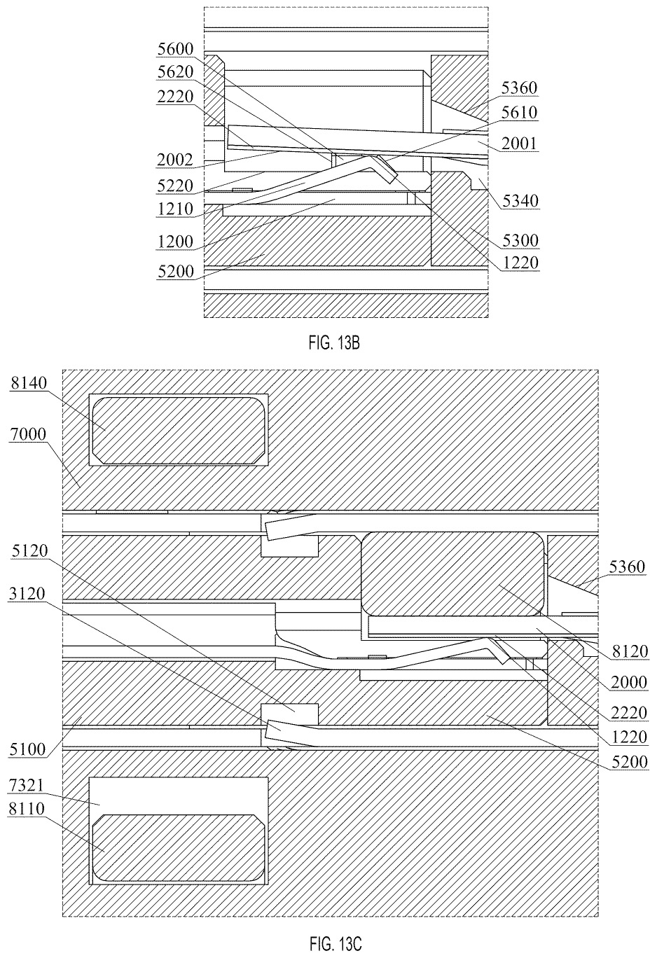

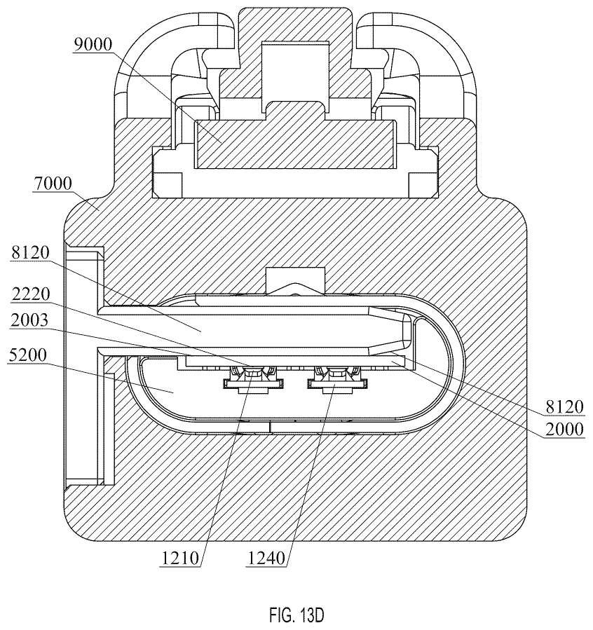

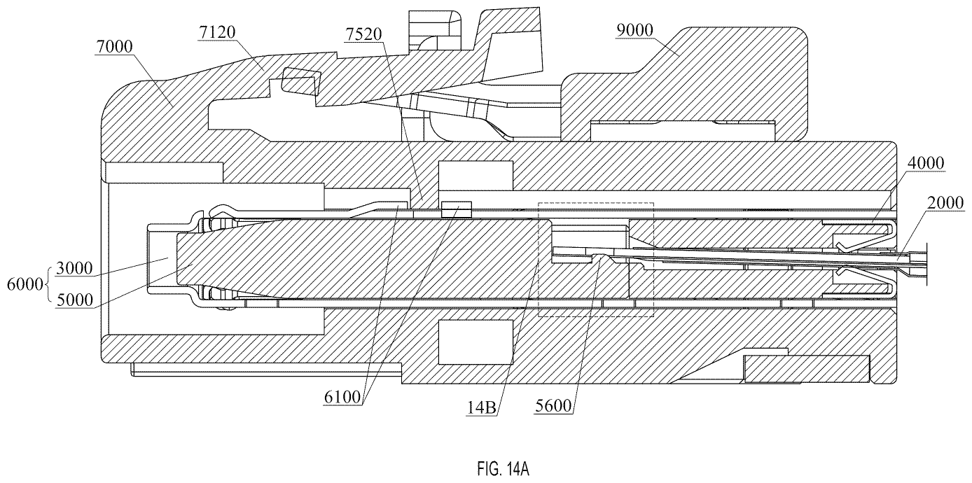

As shown in FIGS. 4A to 4B, exemplarily, the outer housing 7000 may comprise a top 7100, a bottom 7200, and a side 7300. The side 7300 is connected between the top 7100 and the bottom 7200. The side 7300, together with the top 7100 and the bottom 7200, form an assembly mounting channel 7500 for accommodating the inner housing 5000, the conductive terminals 1000, and other components. The top 7100 may have an overhanging beam 7120. The overhanging beam 7120 may cooperate with the connector position assurance 9000, as shown in FIG. 1C, to lock the electrical connector to the complementary electrical component. As shown in FIGS. 4A to 4B, the side 7300 of the outer housing 7000 may comprise a first recess 7310. As illustrated in FIG. 10A, the first body 8130 of the first locking member 8100 may be seated in the first recess 7310 of the side 7300 of the outer housing 7000. The projection 8120 of the first locking member 8100 extends over the second portion 5200 of the inner housing 5000 from the first body 8130, as shown in FIG. 13D, so that the connecting portion 2001 of the flexible cable 2000 may be sandwiched between the projection 8120 and the second portion 5200 of the inner housing 5000. Specifically, the projection 8120 may abut against the second surface 2003 of the connecting portion 2001 of the flexible cable 2000, which is opposite to the first surface 2002 with the contact pads 2220 along the vertical direction of the electrical connector. This configuration allows the projection 8120 of the first locking member 8100 and the second portion 5200 of the inner housing 5000 to restrict the connecting portion 2001 along the vertical direction of the electrical connector, preventing disengagement between the first openings 2600 on the connecting portion 2001 and the first protrusions 5600 on the second portion 5200. Additionally, the projection 8120 of the first locking member 8100 may abut against the rear surface of the first portion 5100 of the inner housing 5000. In this way, the connecting portion 2001 of the flexible cable 2000 and at least a portion of the inner housing 5000 can be locked in the mating and the vertical directions. Furthermore, the second groove 5450 recessed from the upper surface of the second portion 5200 of the inner housing 5000 may receive the front end of the connecting portion 2001 of the flexible cable 2000, and thus, the connecting portion 2001 can be restrained by the second groove 5450 in the lateral direction. The contact portions 1220 on the beams 1210 of the conductive terminals 1000 press against the contact pads 2220 on the first surface 2002 of the flexible cable 2000 via elastic force. Thus, the flexible cable 2000 can be prevented from being separated from the conductive terminals 1000 in the vertical direction, and the electrical connection between the conductive terminals 1000 and the flexible cable 2000 can be more reliable. To prevent side edges of the connecting portion 2001 from warping, which would cause unstable contact between the contact pads 2220 of the connecting portion 2001 and the contact portions 1220 on the beams 1210 of the conductive terminals 1000, the projection 8120 may substantially span the entire lateral width of the connecting portion 2001, spanning at least all the contact pads 2220 of the connecting portion 2001. The projection 8120 may be in arm-shaped, extending along the lateral direction. When the first locking member 8100 is inserted into the outer housing 7000, the projection 8120 of the first locking member 8100 moves relative to the connecting portion 2001. Designed to abut only the second surface 2003 of the flexible cable 2000 without any contact pads, the projection 8120 avoids scratching the contact pads during the installation of the first locking member 8100.

As shown in FIG. 14B, once the connecting portion 2001 of the flexible cable 2000 is inserted into the inner housing 5000 in place, the first protrusions 5600 on the inner housing 5000 can be inserted into the first openings 2600 of the connecting portion 2001 of the flexible cable 2000. However, as shown in FIG. 13B, the contact portions 1220 of the beams 1210 protrude beyond the second portion 5200 of the inner housing 5000, so the connecting portion 2001 of the flexible cable 2000 is slightly lifted upward. In this case, exemplarily, the projection 8120 of the first locking member 8100 may comprise a fourth guiding surface 8122, as shown in FIGS. 10A and 13D. The fourth guiding surface 8122 may be configured to guide the projection 8120 onto the second surface 2003 of the connecting portion 2001 while inducing elastic deformation of the beams 1210 as the first locking member 8100 is inserted along the lateral direction of the electrical connector. This design prevents the projection 8120 from scratching or damaging the side edge of the connecting portion 2001 of the flexible cable 2000 during the insertion of the first locking member 8100 into the first recess 7310 of the outer housing 7000.

Exemplarily, in some embodiments, the first locking member 8100 is movable between a pre-locked position and a locked position. The first locking member 8100 may be configured to engage the housing, e.g., including the inner housing 5000 and the outer housing 7000, and the connecting portion 2001 of the flexible cable 2000 when in the locked position, so as to restrain the relative movement therebetween. As shown in FIGS. 1C to 1D, the electrical connector may further include a shield 3000 disposed between the inner housing 5000 and the outer housing 7000, which is to be described in more detail later. In embodiments including the shield 3000, the first locking member 8100 also engages the shield 3000 when in the locked position. FIGS. 13C to 13D show the first locking member 8100 in the locked position. In this locked position, the projection 8120 of the first locking member 8100 extends sequentially through the outer housing 7000 and the shield 3000 to a position above the second portion 5200 of the inner housing 5000. Thus, the projection 8120 of the first locking member 8100 and the second portion 5200 of the inner housing 5000 limit the connecting portion 2001 of the flexible cable 2000 in the vertical direction. This configuration prevents the first protrusions 5600 from disengaging from the first openings 2600 and additionally restricts the movement of the connecting portion 2001 of the flexible cable 2000 in the vertical direction. Furthermore, the projection 8120 of the first locking member 8100 and the second portion 5200 of the inner housing 5000 can apply pressure to the connecting portion 2001 of the flexible cable 2000 in the vertical direction, thereby positioning the connecting portion 2001.

Exemplarily, the first locking member 8100 engages with the outer housing 7000 when in the pre-locked position, the connecting portion 2001 of the flexible cable 2000 may be inserted into the inner housing 5000, where the connecting portion 2001 is lifted by the first protrusions 5600 on the inner housing 5000, unobstructed by the first locking member 8100, until the first openings 2600 of the connecting portion 2001 align with the first protrusions 5600. The connecting portion 2001 then drop into place to establish electrical coupling with the conductive terminals 1000. Additionally, when the first locking member 8100 is in the pre-locked position, the flexible cable 2000 can be detached if necessary. Specifically, the second surface 2003 of the connecting portion 2001 of the flexible cable 2000 may face downward to disengage the first openings 2600 of the connecting portion 2001 from the first protrusions 5600, after which the flexible cable 2000 can be pulled out along the mating direction (e.g., in the backward direction). This design eliminates the need to fully remove the first locking member 8100 from the outer housing 7000 when detaching or inserting the connecting portion 2001 of the flexible cable 2000 relative to the inner housing 5000. The first locking member 8100 also maintains the relative positions of the shield 3000 (if present), outer housing 7000, and inner housing 5000.

Exemplarily, as shown in FIG. 10A, the first locking member 8100 may further comprise a first arm 8110 extending from the first body 8130. The projection 8120 may also be arm-shaped To distinguish from the first arm 8110, the projection 8120 is referred to as a second arm. Exemplarily, the first arm 8110 may extend along the lateral direction of the electrical connector. As illustrated in FIGS. 4A to 4B and 10B to 10C, the first body 8130 of the first locking member 8100 may be configured to be spaced apart from the side 7300 of the outer housing 7000 when the first locking member 8100 is in the pre-locked position (FIG. 10C), and disposed in the first recess 7310 of the side 7300 of the outer housing 7000 when the first locking member 8100 is in the locked position (FIG. 10B), such that the outer surface of the first body 8130 may be substantially flush with the outer side surface of the outer housing 7000. Exemplarily, the first arm 8110 may extend beyond the second arm (i.e., the projection 8120) along the lateral direction. The bottom 7200 of the outer housing 7000 may further have a first locking portion 7210 and a second locking portion 7220 aligned along the lateral direction. The first arm 8110 may be configured to latch to the first locking portion 7210 of the bottom 7200 of the outer housing 7000 when the first locking member 8100 is in the pre-locked position. The first arm 8110 may also be configured to latch to the second locking portion 7220 of the bottom 7200 of the outer housing 7000 when the first locking member 8100 is in the locked position. Along the direction from the pre-locked position to the locked position of the first locking member 8100, the first locking portion 7210 and the second locking portion 7220 may be arranged in sequence.

Exemplarily, the first arm 8110 of the first locking member 8100 may comprise a first locking portion 8111. The first locking portion 8111 may engage with either the first locking portion 7210 or the second locking portion 7220 of the outer housing 7000, positioning the first locking member 8100 in the pre-locked position or the locked position on the outer housing 7000, respectively. The first locking portion 8111 may be configured as a projection protruding from the first arm 8110. Exemplarily, the first locking portion 8111 of the first locking member 8100 may have a third engaging surface 8113 and a third guiding surface 8114. The third guiding surface 8114 may be configured to guide the first locking portion 8111 to a target locking portion of the first locking portion 7210 and the second locking portion 7220 during the movement of the first locking member 8100. Subsequently, the third engaging surface 8113 engages with the target locking portion. Specifically, the third engaging surface 8113 engages with the first locking portion 7210 when the first locking member 8100 is in the pre-locked position, and engages with the second locking portion 7220 when the first locking member 8100 is in the locked position.

The outer housing 7000 may comprise a first engaging channel 7321 extending from the first recess 7310 along the lateral direction. The first engaging channel 7321 may be generally located at the bottom 7200 of the outer housing 7000. The first locking portion 7210 and the second locking portion 7220 may be in communication with the first engaging channel 7321, such that when the first arm 8110 of the first locking member 8100 is inserted into the first engaging channel 7321, the first locking portion 8111 on the first arm 8110 may selectively engage with the first locking portion 7210 or the second locking portion 7220 to achieve the pre-locked position or the locked position. Optionally, the first locking portion 7210 and the second locking portion 7220 may be configured to be accessible from the outside of the outer housing 7000. Thus, the first locking portion 8111, when engaged in either the first locking portion 7210 or the second locking portion 7220, is accessible from the outer side of the outer housing 7000, so that the first locking portion 8111 is disengaged from its current locking portion, thereby unlocking the first locking member 8100 from the pre-locked position or the locked position.

In some embodiments, as shown in FIG. 4A, the first locking portion 7210 and the second locking portion 7220 may be respectively configured as a first aperture and a second aperture extending from the side wall of the first engaging channel 7321 to the outer surface of the outer housing 7000. Exemplarily, both the first aperture and the second aperture extend to the bottom surface of the bottom 7200 along the vertical direction. Optionally, each of the first aperture and the second aperture may be configured as a straight through hole (as shown), an inverted T-shaped through hole, a tapered through hole, etc. The first locking portion 8111 may protrude downward from the first arm 8110 of the first locking member 8100. The first locking portion 8111 is automatically latched to a target aperture of the first aperture and the second aperture when the first locking member 8100 moves along the lateral direction. When it is desired to move the first locking member 8100, a tool can be inserted into the target aperture to force the free end of the first arm 8110 to move upward, so as to disengage the first locking portion 8111 from the target aperture. To provide space for the free end of the first arm 8110 to move upward, as shown in FIG. 13C, the vertical dimension of the first arm 8110 may be less than the vertical dimension of the first engaging channel 7321.

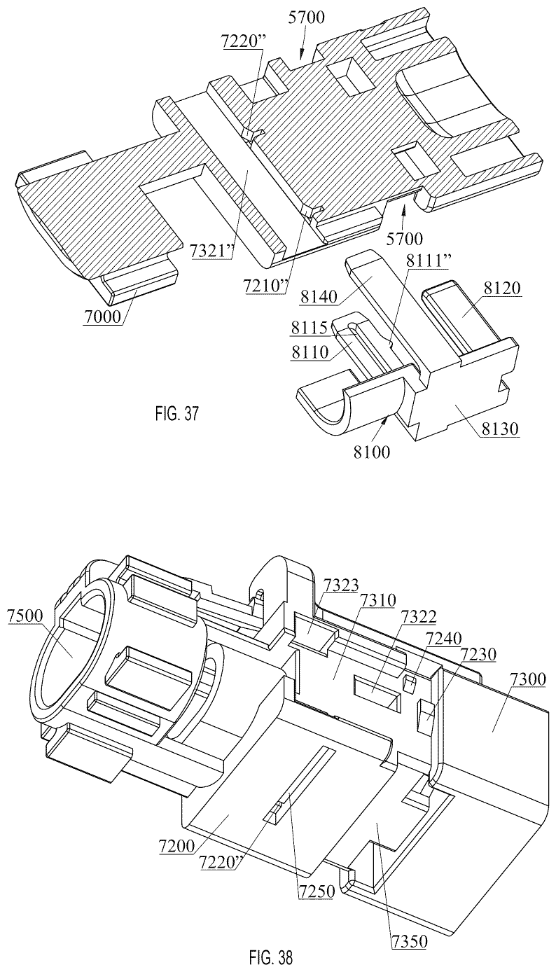

In other embodiments, as shown in FIG. 37, the first locking portion 7210″ and the second locking portion 7220″ may respectively be configured as a first groove and a second groove recessed from the side wall of the first engaging channel 7321″ along the mating direction. In the illustrated embodiment, the first groove and the second groove are recessed in a rearward direction. In alternative unillustrated embodiments, the first groove and the second groove are recessed in a forward direction. To allow external access to the first groove and the second groove from outside the outer housing 7000, the bottom 7200 of the outer housing 7000 may further include a window 7250, as shown in FIG. 38. The window 7250 may be recessed from the outer surface of the bottom 7200 and extend to expose the first groove and the second groove. Correspondingly, the first locking portion 8111″ may protrude from the first arm 8110 of the first locking member 8100 along the mating direction. As the first arm 8110 moves within the first engaging channel 7321″, the first locking portion 8111″ may automatically engage with the first groove or the second groove, thereby retaining the first locking member 8100 in the corresponding pre-locked or the locked position. The window 7250 provides an external accessible path to the first locking portion 8111″, such that a tool inserted through the window 7250 may force the first locking portion 8111″ to disengage from a corresponding groove. In the illustrated embodiment, a single window 7250 is provided, and the first groove and the second groove may share the window 7250. In other unillustrated embodiments, a plurality of windows may be included to expose the first groove and the second groove respectively. Exemplarily, the first arm 8110 may have a slit 8115. The slit 8115 may extend along the lateral direction, endowing the first arm 8110 with a degree of deformability along the mating direction. When the first locking portion 8111″ is actuated by a tool, the portion of the first arm 8110 having the first locking portion 8111″ may undergo elastic deformation, such as compression, such that the first locking portion 8111″ is disengaged from the corresponding groove. In this way, in a plane perpendicular to the extending direction of the first arm 8110, the first arm 8110 in the natural state may match the first engaging channel 7321″ in both shape and size. Thus, even if the first engaging channel 7321″ penetrates the outer housing 7000 along the lateral direction (as shown FIG. 37), the first arm 8110 cannot be accidentally moved along the mating direction. As a result, the first locking portion 8111″ of the first arm 8110 is prevented from accidental disengagement from the first locking portion 7210″ or the second locking portion 7220″. In addition, in the design where the window 7250 exposes the first locking portion 7210″ and the second locking portion 7220″, the first locking portion 8111″ engages with either the first locking portion 7210″ or the second locking portion 7220″ at a position remote from the outer surface of the bottom 7200 of the outer housing 7000, preventing easy external access to the first locking portion 8111″, thereby avoiding the risk of accidental unlocking.

Referring back to FIGS. 4A and 4B, a second engaging channel 7322 may further extend from the first recess 7310 along the lateral direction. With reference to FIG. 9D, the second engaging channel 7322 may extend through the outer housing 7000 and the shield 3000, reaching above the connecting portion 2001 of the flexible cable 2000 mounted on the second portion 5200 of the inner housing 5000. The projection 8120, e.g., the second arm, may be inserted into the second engaging channel 7322. The projection 8120 is disposed between the shield 3000 and the connecting portion 2001 of the flexible cable 2000 when the first locking member 8100 is in the locked position. Thus, the connecting portion 2001 of the flexible cable 2000 can be restrained between the projection 8120 and the second portion 5200 of the inner housing 5000.

Exemplarily, as shown in FIG. 10A, the first locking member 8100 may further comprise a third arm 8140 extending from the first body 8130. The outer housing 7000 may comprise a third engaging channel 7323 extending from the first recess 7310 along the lateral direction. The third engaging channel 7323 may be substantially located in the top 7100 of the outer housing 7000. The third engaging channel 7323 and the first engaging channel 7321 may be disposed on opposite sides of the assembly mounting channel 7500 along the vertical direction of the electrical connector. The third arm 8140 may be inserted into the third engaging channel 7323, and together with the first arm 8110, it enables reliable and precise positioning of the first locking member 8100 relative to the outer housing 7000.

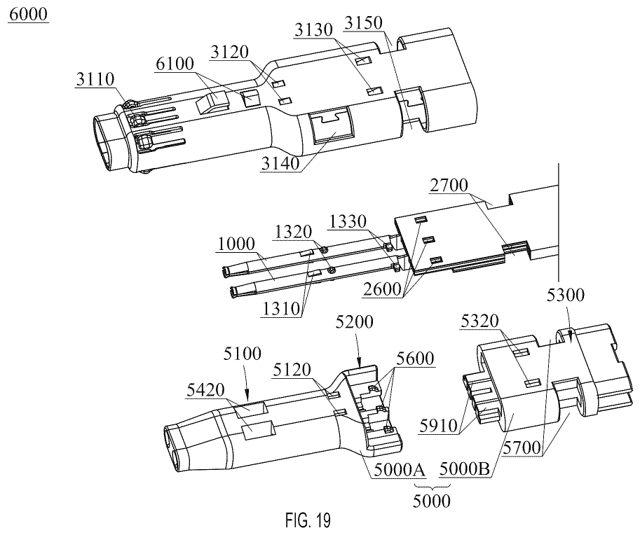

Exemplarily, the electrical connector may further comprise a second locking member 8200, as shown in FIGS. 9A to 9E. The second locking member 8200 may comprise a second body 8230, along with first projections 8210 (e.g., first arms) and second projections 8220 (e.g., second arms) extending from the second body 8230. As shown in FIGS. 4A to 4B and 10B to 10C, the outer housing 7000 may comprise a pair of sides 7300 opposite to each other along the lateral direction of the electrical connector, with each side 7300 comprising a second recess 7330. The bottom 7200 of the outer housing 7000 may comprise a third recess 7350. The third recess 7350 may be in communication with the second recesses 7330 of the two sides 7300 to form a U-shaped slot. The second body 8230 may be disposed in the third recess 7350 of the outer housing 7000 when in a locked position. The first projections 8210 may extend from the second body 8230 into the second recesses 7330, while the second projections 8220 may extend from the second body 8230 through the third portion 5300 of the inner housing 5000 and the flexible cable 2000. Specifically, once the second locking member 8200 is mounted to the outer housing 7000, the second projections 8220 may be inserted into inner housing notches 5700 of the third portion 5300 of the inner housing 5000 (see FIG. 7 and FIGS. 9B to 9E) and cable notches 2700 of the flexible cable 2000 (see FIGS. 2A to 2B and FIGS. 9B to 9E), such that the positional relationship among the outer housing 7000, the third portion 5300 of the inner housing 5000 and the flexible cable 2000 can be locked at least along the mating direction of the electrical connector. The first projections 8210 and the second projections 8220 of the second locking member 8200 may extend along the vertical direction of the electrical connector. Exemplarily, as shown in FIGS. 4A to 4B and FIGS. 9B to 9E, each side 7300 of the outer housing 7000 may comprise a first protrusion 7230 and a second protrusion 7240. The first protrusion 7230 and the second protrusion 7240 may be disposed in the second recess 7330 of the respective side 7300. The first protrusion 7230 may be offset from the second protrusion 7240 along the vertical direction of the electrical connector. Each first projection 8210 may be engages either the first protrusion 7230 or the second protrusion 7240 of the respective side 7300, so that the second locking member 8200 is retained in a pre-locked position or the locked position, respectively. As the second locking member 8200 is moved from the locked position to the pre-locked position, the second projections 8220 may release a component of a terminal assembly 6000 relative to the outer housing 7000. Referring to FIGS. 19 to 21, the terminal assembly 6000 may comprise conductive terminals 1000, a flexible cable 2000, an inner housing 5000 and a shield 3000 (if present). The conductive terminals 1000, the inner housing 5000 and the shield 3000 may be assembled first and then integrally mounted into the outer housing 7000, followed by mounting the connecting portion 2001 of the flexible cable 2000 into the inner housing 5000. The first protrusion 7230 and the second protrusion 7240 of each side 7300 are also offset along the mating direction of the electrical connector, simplifying the molding process of the outer housing 7000.

The second body 8230 of the second locking member 8200 may be configured to be spaced apart from the bottom 7200 of the outer housing 7000 when the second locking member 8200 is in the pre-locked position (see FIG. 9B). The second body 8230 may be configured to be disposed in the third recess 7350 of the bottom 7200 of the outer housing 7000 when the second locking member 8200 is in the locked position (see FIG. 9D). When the second locking member 8200 is in the locked position, the second body 8230 may abut against the bottom 7200 of the outer housing 7000. The first projections 8210 of the second locking member 8200 may extend beyond the second projections 8220 along the vertical direction of the electrical connector. The first projections 8210 may be configured to engage the first protrusions 7230 on the sides 7300 of the outer housing 7000 when the second locking member 8200 is in the pre-locked position. The first projections 8210 may also be configured to engage the second protrusions 7240 on the sides 7300 of the outer housing 7000 when the second locking member 8200 is in the locked position. This allows the second locking member 8200 to latch to the outer housing 7000 in both the locked position and the pre-locked position. The second projections 8220 of the second locking member 8200 may be configured to extend through the shield 3000, the inner housing 5000 and the connecting portion 2001 of the flexible cable 2000 when the second locking member 8200 is in the locked position. This configuration restricts the positions of the shield 3000, the inner housing 5000 and the connecting portion 2001 of the flexible cable 2000 relative to the outer housing 7000 at least along the mating direction of the electrical connector via the second projections 8220, when the second locking member 8200 is in the locked position. The second projections 8220 of the second locking member 8200 may be configured to release the connecting portion 2001 of the flexible cable 2000 at least along the mating direction of the electrical connector when the second locking member 8200 is in the pre-locked position. Additionally, the second projections 8220 of the second locking member 8200 may be configured to further release the shield 3000 and the inner housing 5000 along the mating direction of the electrical connector when the second locking member 8200 is in the pre-locked position.

The first projections 8210 of the second locking member 8200 may comprise second locking portions 8222. The second locking portions 8222 may engage either the first protrusions 7230 or the second protrusions 7240 of the outer housing 7000, so that the second locking member 8200 is latched to the outer housing 7000 in the pre-locked position or the locked position. Exemplarily, as shown in FIGS. 4A to 4B, each of the first protrusions 7230 of the outer housing 7000 may have a first guiding surface 7234, a first engaging surface 7232 and a first transition surface 7233 joining the first guiding surface 7234 and the first engaging surface 7232. The first guiding surface 7234 may be configured to guide the respective second locking portion 8222 onto the first transition surface 7233 of the first protrusion 7230 during the movement of the second locking portion 8222 of the second locking member 8200 to engage the first protrusion 7230. The first transition surface 7233 may extend substantially along the vertical direction. The first engaging surface 7232 may be configured to engage the respective first protrusion 7230 when the second locking member 8200 is in the pre-locked position, so that the second locking member 8200 is retained in the pre-locked position. This allows user to operate the components released by the second projections 8220, for example, mounting or removing the flexible cable 2000, and/or mounting or removing the terminal assembly 6000.

Similarly, each of the second protrusions 7240 may have a second guiding surface 7244, a second engaging surface 7242 and a second transition surface 7243 joining the second guiding surface 7244 and the second engaging surface 7242. The second guiding surface 7244 may be configured to guide the respective second locking portion 8222 onto the second transition surface 7243 of the second protrusion 7240 during the movement of the second locking portion 8222 of the second locking member 8200 to engage the second protrusion 7240. The second transition surface 7243 may extend substantially along the vertical direction. The second engaging surface 7242 may be configured to engage the respective second protrusion 7240 when the second locking member 8200 is in the locked position. In this way, the second locking member 8200 can be reliably retained in the locked position during the electrical connector's normal operation.

By reasonably designing the structures of the second locking member 8200 together with the first protrusions 7230 and second protrusions 7240 on the outer housing 7000, the second locking member 8200 may be restricted to move between the locked position and the pre-locked position, unless an external force far exceeding that applied during normal operation is applied to the second locking member 8200. Optionally, moving the second locking member 8200 between the locked position and the pre-locked position allows different components of the terminal assembly 6000 to be released from the outer housing 7000, so as to achieve disassembling and assembling the components of the terminal assembly 6000. Exemplarily, the second locking member 8200 also has a transition position between the locked position and the pre-locked position, as shown in FIG. 9C. It can be understood that the insertion depth of the second locking member 8200 into the outer housing 7000 in the transition position is less than that in the locked position. Thus, when the second locking member 8200 is in the transition position, the second projections 8220 of the second locking member 8200 may only release the flexible cable 2000. When the second locking member 8200 is in the pre-locked position, the second projections 8220 of the second locking member 8200 may fully release the terminal assembly 6000.

Exemplarily, as shown in FIG. 9C, along the vertical direction of the electrical connector, the second engaging surfaces 7242 of the second protrusions 7240 may be longer than the second guiding surfaces 7244. As the second locking member 8200 is moved from the transition position to the locked position, the second projections 8220 slide over the second transition surfaces 7243 and the second engaging surfaces 7242 with a first distance. The minimum value of the first distance may be greater than half the vertical dimension of the terminal assembly 6000, for example, substantially equal to or exceeding the sum of half the vertical dimension of the terminal assembly 6000 and half the vertical dimension of the flexible cable 2000. In this way, when the second locking member 8200 is in the locked position, the second projections 8220 may span the terminal assembly 6000 in the vertical direction. When the second locking member 8200 is in the transition position, the second projections 8220 may vertically disengage from the cable notches 2700 of the connecting portion 2001 of the flexible cable 2000, so that the connecting portion 2001 of the flexible cable 2000 is released along the mating direction. However, the second projections 8220 may remain engaged with the inner housing notches 5700 and the shield notches 3150 of the shield 3000, allowing the inner housing 5000 and the shield 3000 to stay latched while the flexible cable 2000 is released. When the second locking member 8200 is in the transition position, the second locking portions 8222 of the first projections 8210 of the second locking member 8200 may slide onto the second transition surfaces 7243. This enables the second locking member 8200 to be retained in the transition position without external force, facilitating easy installation and/or removal of the flexible cable 2000.

To fully release the terminal assembly 6000 (i.e., reach the pre-locked position), the second locking member 8200 only needs to move a second distance, less than the first distance, from the transition position. The minimum value of this second distance may be less than half the vertical dimension of the terminal assembly 6000, for example, substantially equal to or greater than the difference between half the vertical dimension of the terminal assembly 6000 and half that of the flexible cable 2000. This allows the second guiding surfaces 7244 to be designed relatively short. As the second locking member 8200 is moved from the transition position to the pre-locked position, the second locking portions 8222 of the first projections 8210 slide from the second transition surfaces 7243 over the second guiding surfaces 7244. When only inserting or withdrawing the flexible cable 2000, the second locking portions 8222 need only slide onto the second transition surfaces 7243 (i.e., the transition position), rather than to the pre-locked position. This reduces the likelihood of the second locking portions 8222 moving between the second transition surfaces 7243 and the second guiding surfaces 7244, thereby minimizing bending fatigue of the first projections 8210. Additionally, the second guiding surfaces 7244 of the second protrusions 7240 may be shorter than the second engaging surfaces 7242 along the vertical direction of the electrical connector, which means the second guiding surfaces 7244 are steeper. Thus, the second guiding surfaces 7244 and the first protrusions 7230 may jointly define limiting spaces for the second locking portions 8222 on the first projections 8210 of the second locking member 8200. This ensures that once the second locking member 8200 is moved to the pre-locked position, it cannot freely shift toward the locked position unless a certain external force is applied.

Exemplarily, as shown in FIG. 9B, the first engaging surfaces 7232 of the first protrusions 7230 may be steeper than the second engaging surfaces 7242 of the second protrusions 7240. This makes it difficult for the second locking portions 8222 on the first projections 8210 of the second locking member 8200 to disengage from the first engaging surfaces 7232 and separate from the outer housing 7000. Exemplarily, the first engaging surfaces 7232 may extend substantially along the lateral direction of the electrical connector, for example, perpendicular to the sides 7300 of the outer housing 7000. Exemplarily, along the lateral direction of the electrical connector, the second protrusions 7240 may protrude further than the first protrusions 7230. This further increases the difficulty for the second locking portions 8222 of the second locking member 8200 to disengage from the first engaging surfaces 7232 and separate from the outer housing 7000.

When both the first locking member 8100 and the second locking member 8200 are in their respective locked positions, the projection 8120 of the first locking member 8100 may restrict movement of the connecting portion 2001 of the flexible cable 2000 at least in the vertical direction, while the second projections 8220 of the second locking member 8200 may restrict movement of the connecting portion 2001 of the flexible cable 2000 at least in the mating direction. The connecting portion 2001 of the flexible cable 2000 can be positioned within the electrical connector through the first locking member 8100 and the second locking member 8200. Along the lateral direction of the electrical connector, the connecting portion 2001 of the flexible cable 2000 may be restrained by the slot 5340 in the third portion 5300 of the inner housing 5000. Thus, after the first locking member 8100 and the second locking member 8200 are moved to their respective pre-locked positions, the connecting portion 2001 of the flexible cable 2000 can be installed into or removed from the electrical connector. Optionally, the second projections 8220 of the second locking member 8200 may also be configured to restrain the connecting portion 2001 of the flexible cable 2000 along the lateral direction. As shown in FIGS. 9A to 9C, the second locking member 8200 may comprise a pair of second projections 8220, which are respectively disposed on opposite sides of the connecting portion 2001 of the flexible cable 2000 along the lateral direction, so as to restrain the connecting portion 2001 of the flexible cable 2000 along the lateral direction.

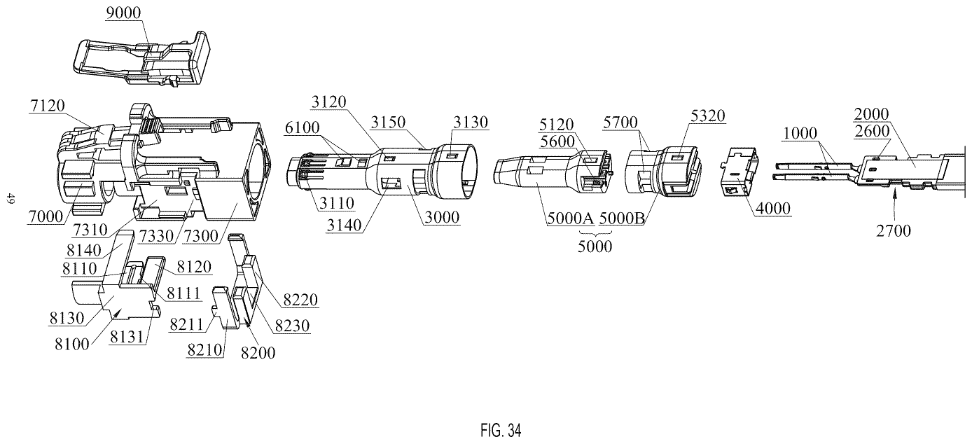

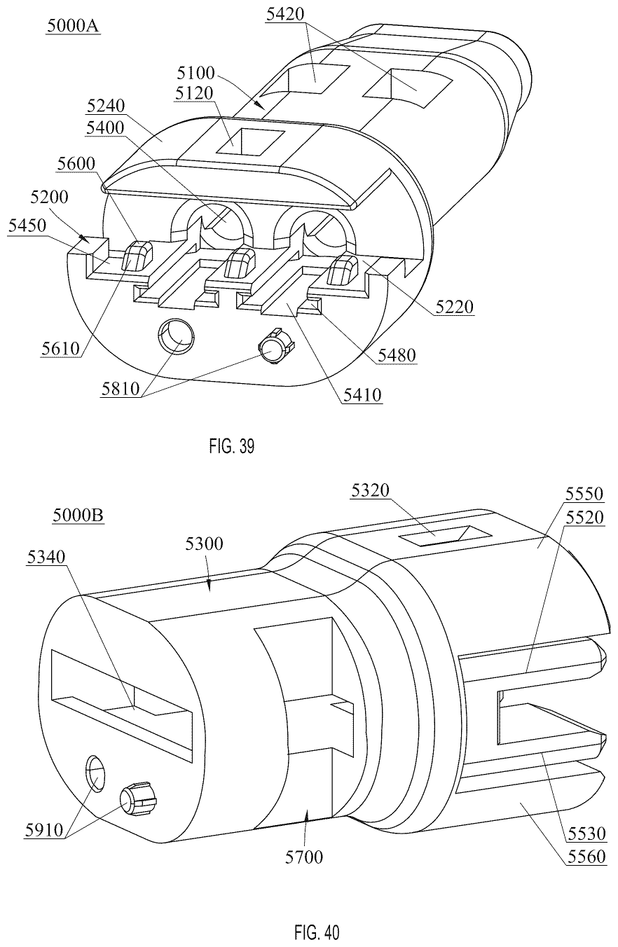

In some embodiments, with reference to FIGS. 34 to 36, the first locking member 8100 may be configured to be mountable to the outer housing 7000 only after the second locking member 8200 has been mounted in place to the outer housing 7000. The first locking member 8100 and the second locking member 8200 are thus configured for assembly in a predetermined sequence, so as to ensure the correctness of assembly and the reliability of the electrical connector. As described above, when the second locking member 8200 is mounted in place to the outer housing 7000 (e.g., in its locked position), the second projection 8220 of the second locking member 8200 may engage with the inner housing notch 5700 in the third portion 5300 of the inner housing 5000 and the cable notch 2700 of the flexible cable 2000, as shown in FIGS. 34 and 37. This engagement serves to position the connecting portion 2001 of the flexible cable 2000 at least along the mating direction, which means that the connecting portion 2001 of the flexible cable 2000 is already mounted in place relative to the inner housing 5000 and the outer housing 7000. At this time, the first protrusions 5600 on the second portion 5200 of the inner housing 5000 (see FIG. 39) are inserted into the first openings 2600 in the connecting portion 2001 of the flexible cable 2000, with the connecting portion 2001 of the flexible cable 2000 generally seated on the second portion 5200 of the inner housing 5000. The first locking member 8100 is then moved from the pre-locked position to the locked position, thereby preventing damage to the connecting portion 2001 of the flexible cable 2000. This design is particularly suitable for scenarios where the locking members are pre-installed in the factory (i.e., with both the first locking member 8100 and the second locking member 8200 retained in their respective pre-locked positions), while the flexible cable 200 is subject to on-site installation or replacement. Notably, if the first protrusions 5600 on the second portion 5200 of the inner housing 5000 are not inserted into the first openings 2600 of the connecting portion 2001 of the flexible cable 2000, the second locking member 8200 cannot be moved to its locked position from its pre-locked position, and the first locking member 8100 cannot be moved to its locked position either. When the first protrusions 5600 of the inner housing 5000 fail to achieve proper engagement with the first openings 2600 of the connecting portion 2001 of the flexible cable 2000, which in turn causes significant warpage of the connecting portion 2001 of the flexible cable 2000, the first locking member 8100 cannot moved to its locked position inadvertently.

Exemplarily, the first locking member 8100 may be configured to be mountable to the outer housing 7000 along the lateral direction perpendicular to the mating direction of the electrical connector; and the second locking member 8200 may be configured to be mountable to the outer housing 7000 along the vertical direction perpendicular to both the lateral direction and the mating direction. Exemplarily, as shown in FIG. 34, on the side 7300 of the outer housing 7000, the first recess 7310 accommodating the first body 8130 of the first locking member 8100 may be in communication with the second recess 7330 accommodating the first projection 8210 of the second locking member 8200. To prevent the first locking member 8100 from moving to the locked position when the second locking member 8200 is in the pre-locked position, various structural designs may be adopted.

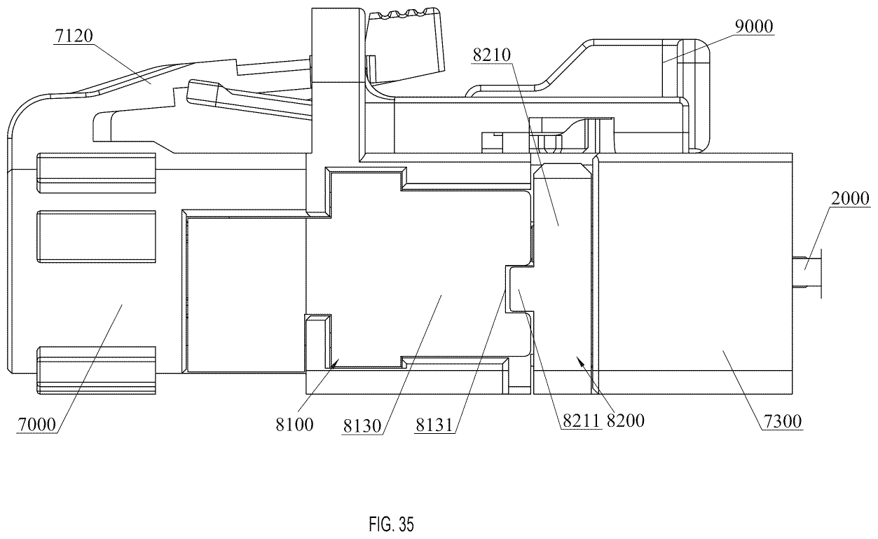

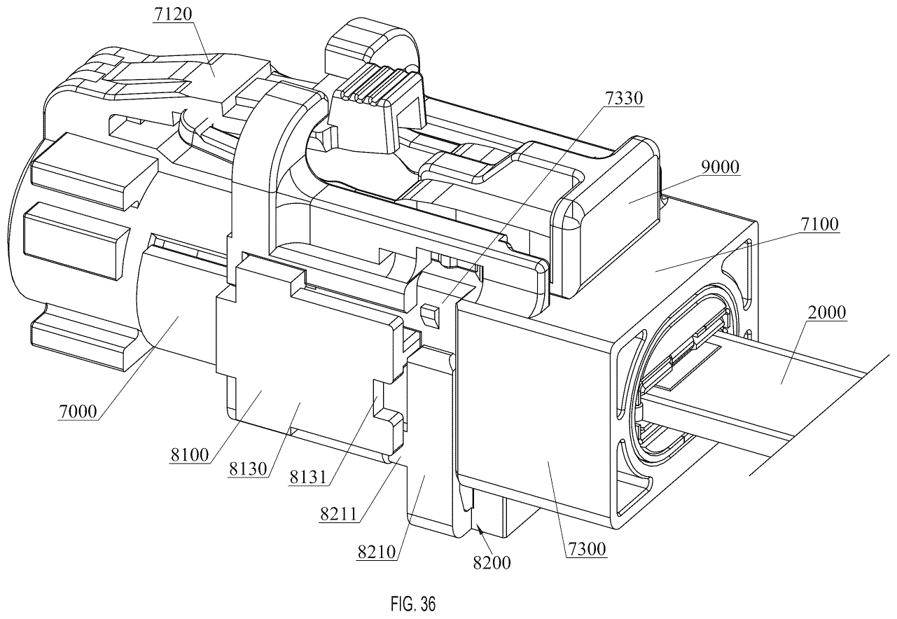

In an exemplary embodiment, a portion of the first projection 8210 of the second locking member 8200 may extend into the first recess 7310 to engage with the first body 8130 of the first locking member 8100. Exemplarily, as shown in FIGS. 35 and 36, the first projection 8210 of the second locking member 8200 may include a third protrusion 8211 protruding along the mating direction of the electrical connector. The third protrusion 8211 is not limited to the shape illustrated herein. Any shape is acceptable provided that it can extend into the first recess 7310 In the illustrated embodiment, the first recess 7310 is in communication with the second recess 7330. The third protrusion 8211 may extend into the first recess 7310 through the communicating part. Optionally, the first recess 7310 may also be spaced apart from the second recess 7330. In this case, the third protrusion 8211 may be configured to extend into the first recess 7310 across the space between the first recess 7310 and the second recess 7330. The first body 8130 of the first locking member 8100 may include a third groove 8131. Only when the second locking member 8200 is placed in its locked position, as shown in FIG. 35, the third protrusion 8211 on the first projection 8210 may be aligned with the third groove 8131 of the first locking member 8100 along the lateral direction. In this case, the first body 8130 of the first locking member 8100 can be inserted into the first recess 7310 along the lateral direction without obstruction, thereby enabling the third groove 8131 of the first locking member 8100 to engage with the third protrusion 8211 on the first projection 8210. On the contrary, if the second locking member 8200 is in its pre-locked position during the movement of the first locking member 8100 from its pre-locked position to its locked position, as shown in FIG. 36, the third protrusion 8211 on the second locking member 8200 is staggered from the third groove 8131 of the first locking member 8100 along the lateral direction. Thus, the third protrusion 8211 blocks the first locking member 8100 from moving into its locked position, thereby enforcing the predetermined assembly sequence of the first locking member 8100 and the second locking member 8200.

In another unillustrated embodiment, a portion of the first body 8130 of the first locking member 8100 may extend into the second recess 7330 to engage with the first projection 8210 of the second locking member 8200. Exemplarily, the aforementioned third groove and third protrusion may be interchanged between the first locking member 8100 and the second locking member 8200. Specifically, the first locking member 8100 may be configured with a third protrusion extending into the second recess 7330, while the second locking member 8200 may be configured with a third groove adapted to engage with the third protrusion. In cases where the second locking member 8200 has not been moved to the locked position, any attempt to insert the first body 8130 of the first locking member 8100 into the first recess 7310 of the outer housing 7000 along the lateral direction (i.e., to move the first locking member 8100 to its locked position) may result in interference between the third protrusion on the first locking member 8100 and the first projection 8210 of the second locking member 8200, thereby preventing the first body 8130 of the first locking member 8100 from fully seating in the first recess 7310.

In other unillustrated embodiments, at least portions of adjacent edges of the first body 8130 of the first locking member 8100 and the first projection 8210 of the second locking member 8200 are complementary in shape, and this complementary configuration is not limited to the aforementioned third groove and third protrusion. For example, the at least portions of adjacent edges may be configured as mutually complementary serrated or corrugated profiles, among other geometries. In fact, the aforementioned third groove and third protrusion may also be considered a specific form of shape complementarity between the adjacent edges of the first body 8130 of the first locking member 8100 and the first projection 8210 of the second locking member 8200.

This edge shape-complementary design may be regarded as a secondary locking mechanism, which improves the overall reliability of the electrical connector in harsh environments (such as those presented by automobiles). Specifically, once the first locking member 8100 is mounted on the outer housing 7000 and secured in the locked position, it serves to prevent the second locking member 8200 already mounted on the outer housing 7000 in place from disengaging from its locked position. This configuration effectively mitigates the risk of the second locking member 8200 becoming disengaged from its locked position due to automotive vibration or other external factors.

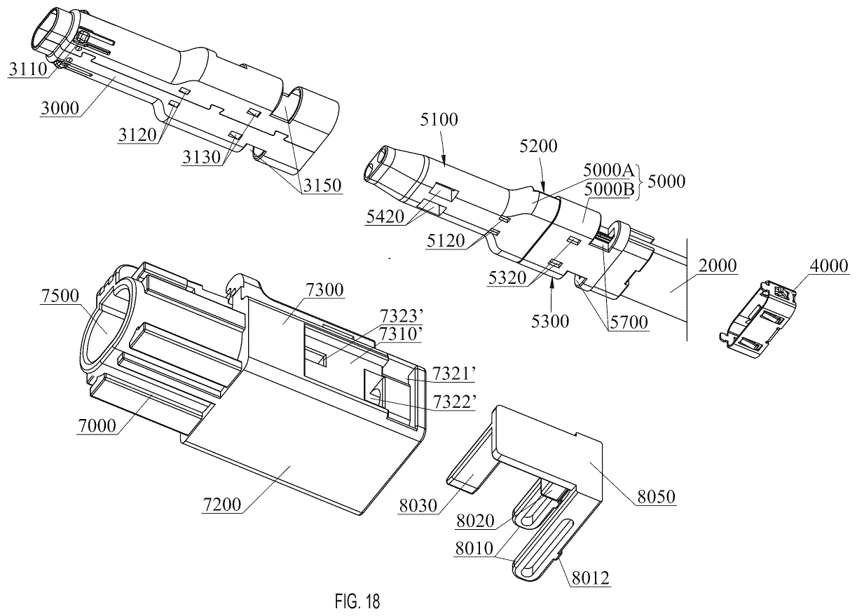

In other embodiments, the connecting portion 2001 of the flexible cable 2000 may be restrained along both the vertical direction and the mating direction by a single locking member 8000. For example, the locking member 8000 may be a one-piece member. In this way, the locking member 8000 may be manufactured via processes such as injection molding, resulting in lower production costs. When the locking member 8000 is in the pre-locked position, the connecting portion 2001 of the flexible cable 2000 can be installed into or removed from the electrical connector. As shown in FIGS. 18, 23, and 32, the locking member 8000 may comprise a first projection 8010, a second projection 8020, a third projection 8030, and a third body 8050. The first projection 8010, the second projection 8020 and the third projection 8030 all extend from the third body 8050, for example, along the lateral direction.

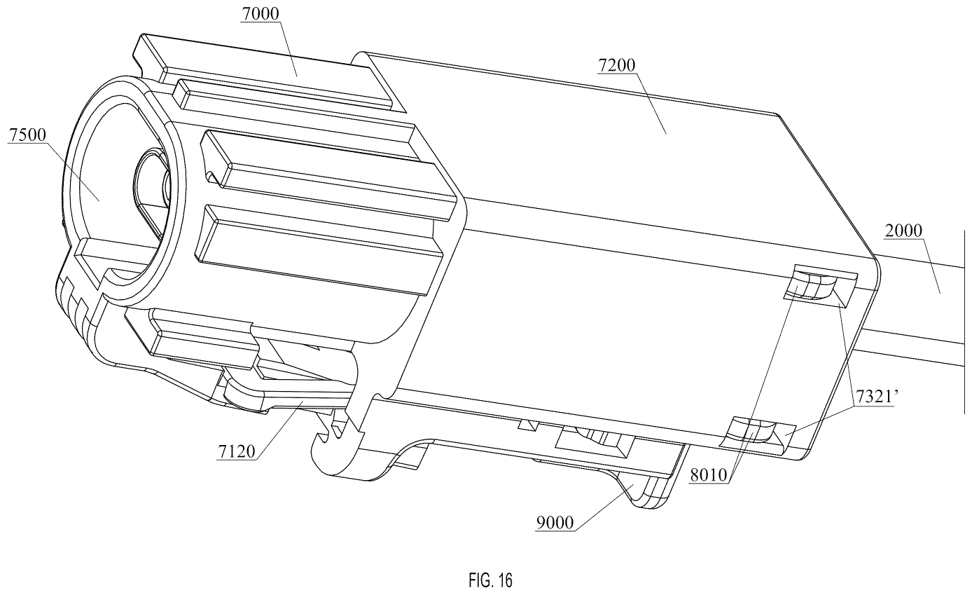

When the locking member 8000 is in the locked position, the third body 8050 of the locking member 8000 may be disposed in the first recess 7310′ of the side 7300 of the outer housing 7000 (see FIG. 18). The outer housing 7000 may include a first engaging channel 7321′ extending from the first recess 7310′ along the lateral direction. The first projection 8010 may be inserted into the first engaging channel 7321′. As shown in FIG. 15, the outer housing 7000 may include a first locking portion 7210′ and a second locking portion 7220′. Exemplarily, the first locking portion 7210′ and the second locking portion 7220′ may be configured as apertures extending from the side wall of the first engaging channel 7321′ to the outer surface of the outer housing 7000. Exemplarily, the locking member 8000 may include a pair of first projections 8010 spaced apart along the vertical direction. As shown in FIG. 16, a pair of first engaging channels 7321′ is arranged on upper and lower sides of the assembly mounting channel 7500, respectively. The pair of first projections 8010 is fitted into the pair of first engaging channels 7321′, respectively. Each of the first engaging channels 7321′ has a first locking portion 7210′ and a second locking portion 7220′. In the illustrated embodiment, both the first locking portion 7210′ and the second locking portion 7220′ extend from the side wall of the first engaging channel 7321′ to the rear surface of the outer housing 7000. Alternatively, in other unillustrated embodiments, the first locking portion 7210′ and the second locking portion 7220′ may configured as apertures extending from the side wall of the first engaging channel 7321′ to the top surface and/or bottom surface of the outer housing 7000. For example, the first locking portion 7210′ and the second locking portion 7220′ of the upper first engaging channel 7321′ may be formed as apertures extending to the top surface of the outer housing 7000, while the first locking portion 7210′ and the second locking portion 7220′ of the lower first engaging channel 7321′ may be formed as apertures extending to the bottom surface of the outer housing 7000.

Optionally, the first locking portion 7210′ and the second locking portion 7220′ may also be located inside the outer housing 7000, yet accessible from outside the outer housing 7000 through a window 7250 similar to that shown in FIGS. 37 and 38, so as to unlock the first projections 8010 latched with the first locking portions 7210′ or the second locking portions 7220′.

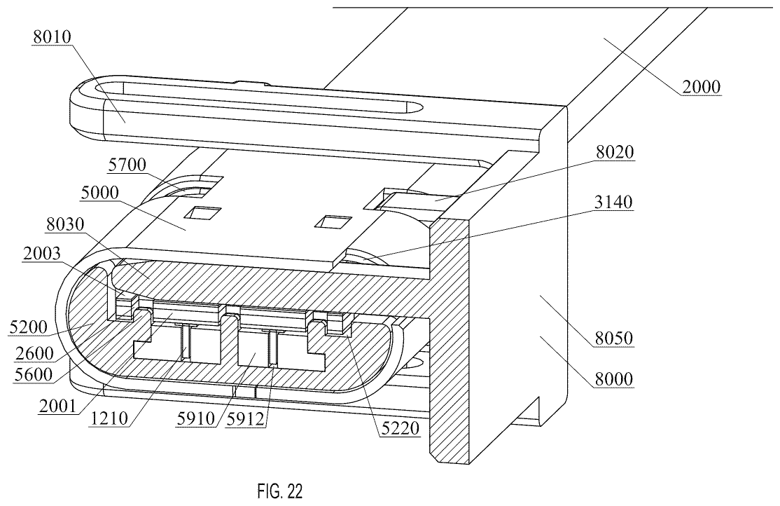

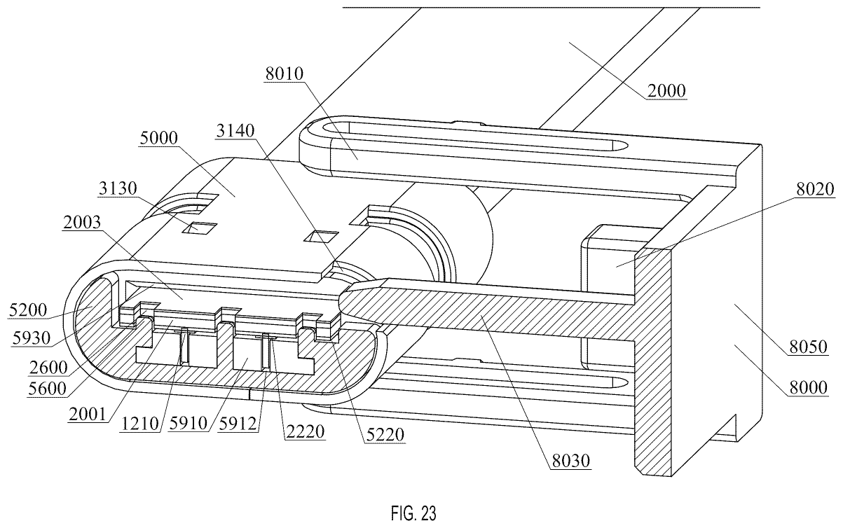

Exemplarily, each of the first projections 8010 may include a locking portion 8012. The locking portion 8012 is configured to engage with a respective first locking portion 7210′ or second locking portion 7220′, so that the locking member 8000 is in the pre-locked position (as shown in FIG. 23) or the locked position (as shown in FIG. 22), respectively. Exemplarily, the first projections 8010 each may be in the shape of an arm extending along the lateral direction, and the locking portion 8012 may protrude from the side surface of the arm.

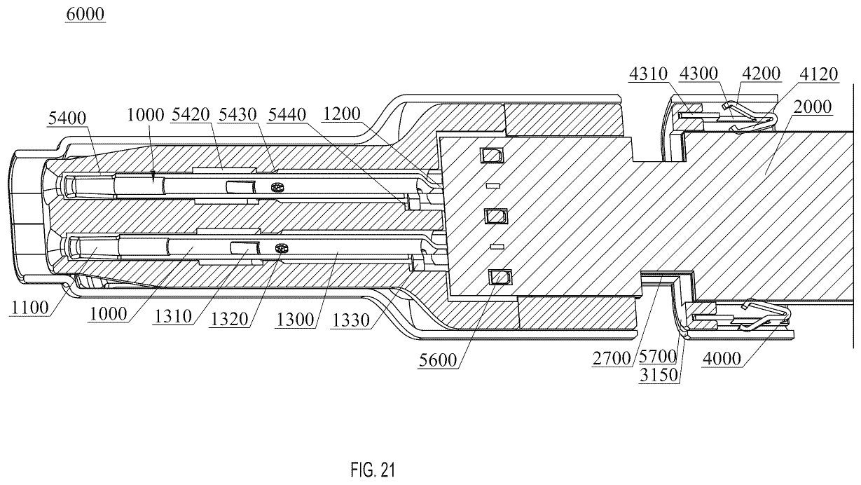

As shown in FIG. 18, a second engaging channel 7322′ may also extend from the first recess 7310 along the lateral direction. The second engaging channel 7322′ may pass through the outer housing 7000, the shield 3000, the third portion 5300 of the inner housing 5000, and extend to the connecting portion 2001 of the flexible cable 2000 mounted to the second portion 5200 of the inner housing 5000. Exemplarily, as shown in FIGS. 21-23 and 27-30, the second projection 8020 of the locking member 8000 may engage with the shield notch 3150 of the shield 3000 and the inner housing notch 5700 of the inner housing 5000 to lock the shield 3000 and the inner housing 5000 at least along the mating direction of the electrical connector. The second projection 8020 may be located behind the third projection 8030. The inner housing notch 5700 may be located in the third portion 5300 of the inner housing 5000. Although the flexible cable 2000 can be locked to the inner housing 5000 along the mating direction of the electrical connector by the first openings 2600 of the connecting portion 2001 of the flexible cable 2000 and the first protrusions 5600 of the second portion 5200 of the inner housing 5000, optionally, the flexible cable 2000 may be further locked by the locking member 8000. Exemplarily, the flexible cable 2000 may include a cable notch 2700. The cable notch 2700 may be located in the thicker portion of the flexible cable 2000 to reliably lock the flexible cable 2000. The inner housing notch 5700 is substantially aligned with the cable notch 2700. The second projection 8020 may be inserted into the inner housing notch 5700 and the cable notch 2700 to lock both the inner housing 5000 and the flexible cable 2000 to the outer housing 7000, thereby simplifying the structure. Thus, the shield notch 3150 of the shield 3000, the inner housing notch 5700 of the inner housing 5000, and the cable notch 2700 of the flexible cable 2000 may be considered as portions of the second engaging channel 7322′.

Referring back to FIG. 18, a third engaging channel 7323′ may also extend from the first recess 7310 along the lateral direction. The third engaging channel 7323′ may pass through the outer housing 7000 and the shield 3000. The shield 3000 may include a third opening 3140, as shown in FIGS. 22 and 23, which may be a portion of the third engaging channel 7323′. The third projection 8030 of the locking member 8000 may be inserted into the third engaging channel 7323′ and extend above the second portion 5200 of the inner housing 5000. The third projection 8030 and the second portion 5200 of the inner housing 5000 clamp the connecting portion 2001 of the flexible cable 2000 along the vertical direction of the electrical connector to restrain the connecting portion 2001 of the flexible cable 2000 along the vertical direction. The third projection 8030 may be inserted above the second portion 5200 of the inner housing 5000 along the lateral direction of the electrical connector. Once inserted into place, the third projection 8030 abuts against the second surface 2003 of the connecting portion 2001, preventing the first openings 2600 of the connecting portion 2001 from disengaging from the first protrusions 5600 on the second portion 5200. The third projection 8030 may also abut against the rear of the first portion 5100 of the inner housing 5000. In this way, at least a portion of the inner housing 5000 and the connecting portion 2001 of the flexible cable 2000 can be locked along the mating direction and the vertical direction. In addition, the second portion 5200 of the inner housing 5000 may have a second groove 5450, which may be recessed from the upper surface of the second portion 5200. By trapping the connecting portion 2001 in the second groove 5450 along the lateral direction, the connecting portion 2001 can be reliably locked to the inner housing 5000, so that the conductive terminals 1000 maintain a reliable electrical connection with the flexible cable 2000. As shown in FIG. 26, the first positioning slots 5460 for receiving at least portions of the beams 1210′ of the conductive terminals 1000 may be located below the second groove 5450, so that the third projection 8030 of the locking member 8000 abuts against the connecting portion 2001 above the second groove 5450.

Exemplarily, as shown in FIGS. 1C and 6-7, the inner housing 5000 may comprise a separated first sub-inner housing 5000A and second sub-inner housing 5000B. The second sub-inner housing 5000B may be located behind the first sub-inner housing 5000A. The first sub-inner housing 5000A may be engaged with the second sub-inner housing 5000B by any suitable means such as plugging or clamping. The plurality of conductive terminals 1000 may be held in the first sub-inner housing 5000A. The first sub-inner housing 5000A may comprise terminal mounting channels 5400. Exemplarily, the first sub-inner housing 5000A may comprise the first portion 5100 and the second portion 5200 of the inner housing 5000. The second sub-inner housing 5000B may be provided with a slot 5340, as shown in FIG. 9E. Exemplarily, the second sub-inner housing 5000B may comprise the third portion 5300 of the inner housing 5000. The connecting portion 2001 of the flexible cable 2000 may be inserted forward into the slot 5340. The connecting portion 2001 of the flexible cable 2000 may be mainly accommodated in the second sub-inner housing 5000B. Compared with the integral structure, the separated inner housing 5000 is easier to process.

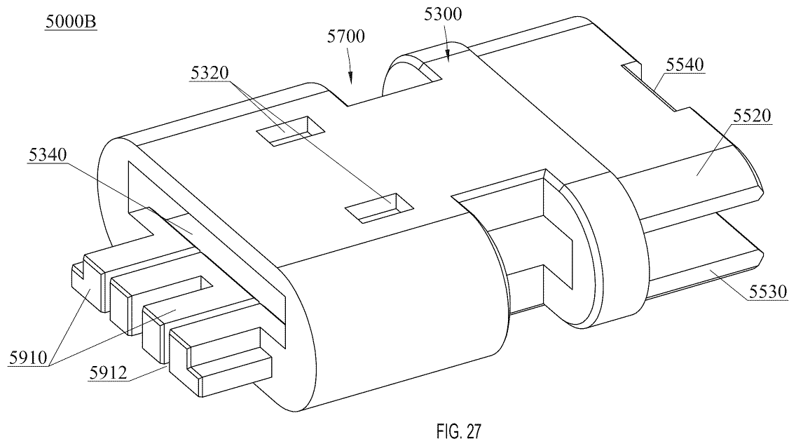

In the embodiments shown in FIGS. 15-33, exemplarily, the first sub-inner housing 5000A may comprise first positioning features 5810 (see FIGS. 24 and 26), and the second sub-inner housing 5000B may comprise second positioning features 5910 (see FIG. 27). The first positioning feature 5810 may mate with the second positioning feature 5910 to maintain the relative position between the first sub-inner housing 5000A and the second sub-inner housing 5000B at least along the directions perpendicular to the mating direction (i.e., the lateral direction and the vertical direction). In the illustrated embodiment, the first positioning feature 5810 may comprise at least one positioning groove, which may be disposed in the second portion 5200 of the inner housing 5000. The second positioning feature 5910 may comprise at least one positioning protrusion inserted into the at least one positioning groove. The at least one positioning protrusion may be disposed at the front end of the second sub-inner housing 5000B. Exemplarily, there are a plurality of positioning groove, the number of which matches that of the conductive terminals 1000. A separating rib 5830 is formed between any adjacent positioning grooves, which not only enhance the mechanical strength of the first sub-inner housing 5000A, but also provide a location for a portion of the first protrusions 5600. The portion of the first protrusions 5600 may engage with the first openings 2600 on the flexible cable 2000 between adjacent conductive terminals 1000.

Since the second positioning feature 5910 is inserted into the first sub-inner housing 5000A, as shown in FIGS. 24 and 27, second positioning slots 5912 may also be disposed in the second positioning feature 5910. The second positioning slots 5912 and the first positioning slots 5460 cooperate to jointly accommodate the beams 1210′ of the conductive terminals 1000. The second positioning feature 5910 and the third projection 8030 of the locking member 8000 may be disposed on opposite sides of the flexible cable 2000 along the vertical direction, respectively, which can minimize the electrical connector.

In some embodiments, exemplarily, as shown in FIGS. 39 to 40, the first positioning feature 5810 may include a positioning pin and a positioning slot. The second positioning feature 5910 may include a positioning slot and a positioning pin that are respectively mated with the positioning pin and the positioning slot of the first positioning feature 5810. In this manner, the relative position between the first sub-inner housing 5000A and the second sub-inner housing 5000B can be constrained through the mating engagement of the first positioning feature 5810 and the second positioning feature 5910. This configuration offers excellent positioning performance, a simple structure, and ease of manufacturing and processing. Optionally, the second positioning feature 5910 may be configured to form an interference fit with the first positioning feature 5810.

Optionally, the shield 3000 surrounding the first sub-inner housing 5000A and second sub-inner housing 5000B may also be used to restrain the relative position between the first sub-inner housing 5000A and the second sub-inner housing 5000B along the directions perpendicular to the mating direction. Thus, the first positioning feature 5810 and the second positioning feature 5910 can be omitted, as in the embodiments shown in FIGS. 1A to 14B.

In the first set of embodiments shown in FIGS. 1A to 14B and the second set of embodiments shown in FIGS. 15 to 33, the shield 3000 is fixed to the first sub-inner housing 5000A and the second sub-inner housing 5000B in a similar manner. Taking the second set of embodiments, which better illustrate the fixing structure, as an example, as shown in FIGS. 18 to 20, the shield 3000 may comprise first engaging features 3120; and as shown in FIGS. 18-20 and 26, the first sub-inner housing 5000A may comprise second engaging features 5120. The second engaging features 5120 may engage the first engaging features 3120 for maintaining the relative position of the first sub-inner housing 5000A and the shield 3000 along the mating direction. The second engaging features 5120 may directly engage the first engaging features 3120. For example, the first engaging features 3120 and the second engaging features 5120 may be configured as protrusions and grooves, or rotary locking grooves and rotary locking protrusions, respectively.

Optionally, the first engaging features 3120 may be disposed on opposite sides of the shield 3000 along the vertical direction of the electrical connector, and the first engaging features 3120 may engage the second engaging features 5120 in a one-to-one correspondence. The first engaging features 3120 may comprise projections protruding inward from the side wall of the shield 3000. The second engaging features 5120 may comprise recesses recessed from the side surface of the inner housing 5000. The projections may engage with the recesses. Exemplarily, the projections may comprise tabs bent inward from the side wall of the shield 3000. The tabs may have a certain elasticity. After the inner housing 5000 is inserted into the shield 3000, the tabs can be rebounded and bent inward to be inserted into and engaged with the recesses.

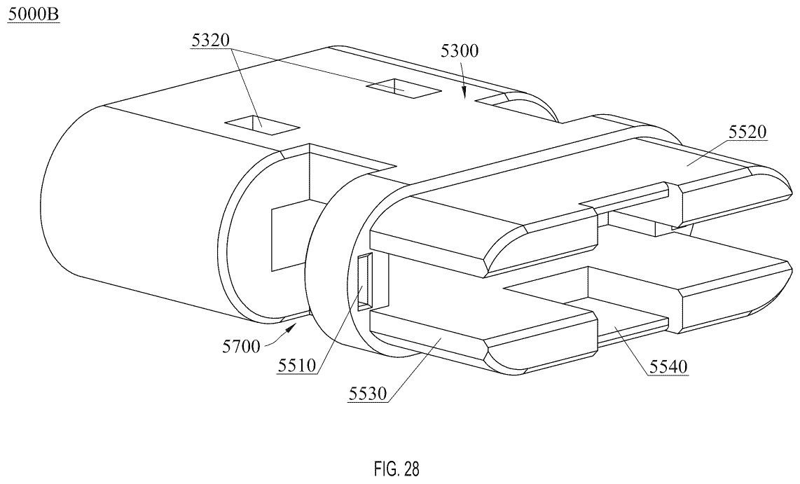

Optionally, as shown in FIGS. 18 to 20, the shield 3000 may comprise third engaging features 3130; and as shown in FIGS. 27 to 28, the second sub-inner housing 5000B may comprise fourth engaging features 5320. The fourth engaging features 5320 may engage the third engaging features 3130 for maintaining the relative position of the second sub-inner housing 5000B and the shield 3000 along the mating direction. The third engaging features 3130 may be directly engage the fourth engaging features 5320. For example, the third engaging features 3130 and the fourth engaging features 5320 may be configured as protrusions and grooves, or rotary locking grooves and rotary locking protrusions, respectively. Exemplarily, the third engaging features 3130 and the fourth engaging features 5320 may be configured similarly to or differently from the first engaging features 3120 and the second engaging features 5120, respectively, provided that they can restrain relevant movements between the second sub-inner housing 5000B and the shield 3000.

The first sub-inner housing 5000A, the second sub-inner housing 5000B, and the shield 3000 can be assembled together via the aforementioned engaging features, with the conductive terminals 1000 mounted in the first sub-inner housing 5000A. The assembled components can be integrally installed into the outer housing 7000. Either before or after the assembled components are installed into the outer housing 7000, the flexible cable 2000 can be inserted into the second sub-inner housing 5000B to be electrically coupled with the conductive terminals 1000. The aforementioned first sub-inner housing 5000A, second sub-inner housing 5000B, shield 3000, conductive terminals 1000, and flexible cable 2000 are collectively referred to as the terminal assembly 6000.

After the terminal assembly 6000 is installed into the outer housing 7000, multiple components of the terminal assembly 6000 can be fixed to the outer housing 7000 either by the locking member 8000, or by the first locking member 8100 and the second locking member 8200. Taking the second set of embodiments as an example, as shown in FIGS. 21 to 23, the second projection 8020 of the locking member 8000 may engage with the shield notch 3150 of the shield 3000, the inner housing notch 5700 of the inner housing 5000, and the cable notch 2700 of the flexible cable 2000. This allows the shield 3000, the inner housing 5000, and the flexible cable 2000 to be locked together.

The first projection 8010 of the locking member 8000 may pass through the third opening 3140 of the shield 3000. The vertical dimension of the third opening 3140 may be substantially the same as that of the first projection 8010. After the first projection 8010 is inserted into the third opening 3140 of the shield 3000, the top wall of the shield 3000 may abut against the top surface of the first projection 8010, and the bottom surface of the first projection 8010 may abut against the second surface 2003 of the connecting portion 2001 of the flexible cable 2000 and/or the second portion 5200 of the inner housing 5000. Along the mating direction of the electrical connector, the dimension of the third opening 3140 may be substantially the same as that of the first projection 8010. Additionally, the first projection 8010 of the locking member 8000 may abut against the first sub-inner housing 5000A from the rear. This restricts the positions of the first sub-inner housing 5000A and the shield 3000 relative to the outer housing 7000.

In some embodiments, as shown in FIG. 39, the second portion 5200 of the inner housing 5000 may be configured with a top arm 5240. With reference to FIG. 34, after the first projection (e.g., first arm 8110) of the locking member 8000 is inserted into the third opening 3140 of the shield 3000, the top arm 5240 of the second portion 5200 may abut against the top surface of the first projection 8010. The bottom surface of the first projection 8010 may in turn abut against the second surface 2003 of the connecting portion 2001 of the flexible cable 2000 and/or the outer top surface of the second portion 5200 adjacent to the second groove 5450. In this way, the first arm 8110 can be vertically positioned solely by the inner housing 5000, without the need for cooperation with auxiliary components such as the shield 3000. In cases where the position of the first arm 8110 is constrained via the mating engagement of multiple components, the assembly of the first arm 8110 shall be subject to the cumulative machining tolerances of the respective components, which is more likely to cause loosening or misalignment of the first arm 8110 after installation, or increase the risk that the first arm 8110 cannot be seated in place properly.

Thus, even in high-vibration environments, all components of the electrical connector can maintain a stable connection relationship, resisting relative movement. This ensures reliable signal transmission and delivers more consistent signal paths.

Exemplarily, the shield 3000 may at least surround the conductive terminals 1000 and the connecting portion 2001 of the flexible cable 2000. In the illustrated embodiment, along the length direction of the conductive terminals 1000, the shield 3000 may accommodate all the conductive terminals 1000 therein. The shield 3000 may be made of a metal material. The shield 3000 may provide full shielding for the conductive terminals 1000 along the length direction of the conductive terminals 1000 and provide shielding for the conductive layer on the connecting portion 2001. The shield 3000 may be electrically isolated from the conductive terminals 1000 by the inner housing 5000.

Exemplarily, as shown in FIGS. 2A to 2B, the flexible cable 2000 may further comprise at least one reference layer 2400. The at least one reference layer 2400 may be electrically isolated from the conductive layer. Exemplarily, the at least one reference layer 2400 may be formed on the outer side of the insulating layer 2300. A bonding layer 2520 may join the at least one reference layer 2400 and the insulating layer 2300. Exemplarily, along the lateral direction, the at least one reference layer 2400 may cover at least the conductive layer in the flexible cable 2000. Optionally, referring to FIG. 30 of the second set of embodiments, the at least one reference layer 2400 may completely cover the outer side of the insulating layer 2300. Along the mating direction of the electrical connector, the at least one reference layer 2400 may be spaced a sufficient distance from the tails 1200 of the conductive terminals 1000 to prevent the at least one reference layer 2400 from being electrically coupled with the conductive terminals 1000. The reference layer 2400 may surround four sides of the flexible cable 2000.

The reference layer 2400 may be connected to a reference voltage, such as a signal ground, to act as a shield and improve electromagnetic compatibility (EMC) performance. The reference layer 2400 may be made of materials including, but not limited to, copper foil, aluminum foil, or conductive adhesive. The shield 3000 may be coupled to each of the at least one reference layer 2400. In this way, the at least one reference layer 2400 and the shield 3000 can effectively shield the conductive terminals 1000 and the conductive layer in the flexible cable 2000, achieving excellent EMC performance.

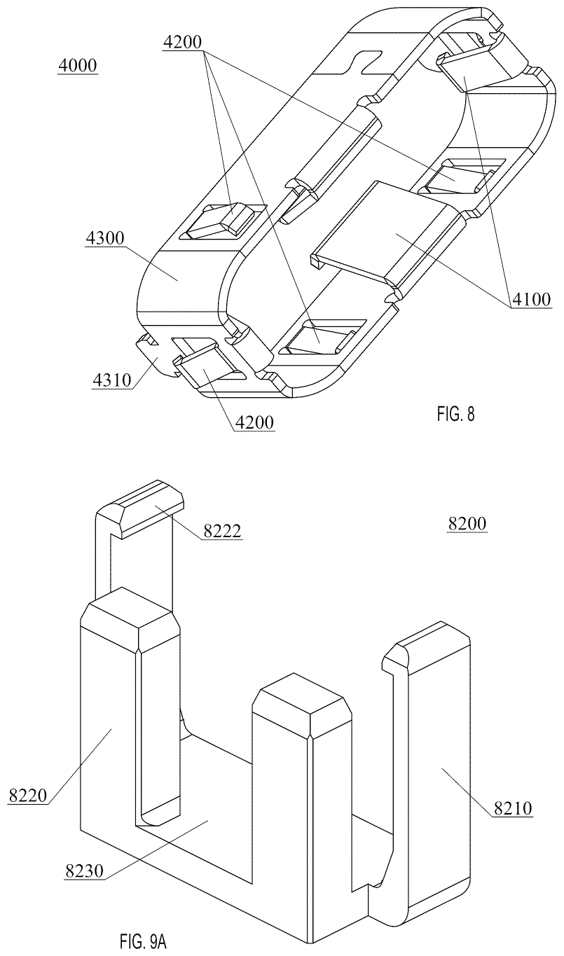

As shown in FIGS. 1C-1D and 8, the electrical connector may further comprise a conductive member 4000. The conductive member 4000 may be electrically connected between the reference layer 2400 and the shield 3000. Exemplarily, the conductive member 4000 may comprise a first beam 4100 and a second beam 4200. The first beam 4100 may be in electrical contact with the reference layer 2400 of the flexible cable 2000, while the second beam 4200 of the conductive member 4000 may be in electrical contact with the shield 3000. This arrangement enables the conductive member 4000 to electrically couple the shield 3000 and the reference layer 2400, effectively shielding against external interference and achieving excellent EMC performance. The first beam 4100 and the second beam 4200 may exert elastic forces on the reference layer 2400 of the flexible cable 2000 and the shield 3000, respectively, facilitating easy installation of the conductive member 4000 between the flexible cable 2000 and the shield 3000. Optionally, there may be multiple first beams 4100 and multiple second beams 4200, evenly distributed around the flexible cable 2000. This forms multi-point electrical contact between the shield 3000 and the reference layer 2400 of the flexible cable 2000, improving the stability of electrical coupling.

Exemplarily, the conductive member 4000 may be disposed between the shield 3000 and the flexible cable 2000. Exemplarily, the conductive member 4000 may be disposed on the third portion 5300 of the inner housing 5000. As shown in FIG. 7, the third portion 5300 of the inner housing 5000 may comprise an upper extension 5520 and a lower extension 5530. Each of the upper extension 5520 and the lower extension 5530 may comprise a conductive notch 5540. The conductive member 4000 may comprise a main body 4300. The main body 4300 may surround the upper extension 5520 and the lower extension 5530. The upper extension 5520 and the lower extension 5530 may be recessed toward the inner side of the inner housing 5000, so that the outer surface of the main body 4300 is substantially flush with that of the inner housing 5000. The first beam 4100 of the conductive member 4000 may be bent from the main body 4300, passing through the conductive notches 5540 into the upper extension 5520 and the lower extension 5530 to be in electrical contact with the reference layer 2400 of the flexible cable 2000. The first beam 4100 may be configured as an elastic cantilever, with its free end in contact with the reference layer 2400. The second beam 4200 of the conductive member 4000 may be disposed in the side wall of the main body 4300. Similarly configured as an elastic cantilever, the second beam 4200 has a free end that contacts the shield 3000. The main body 4300 may surround at least a portion of the connecting portion 2001 of the flexible cable 2000 on four sides. Optionally, multiple first beams 4100 and multiple second beams 4200 may be provided to ensure uniform electrical contact with the reference layer 2400 of the flexible cable 2000 and the shield 3000, respectively. Exemplarily, the main body 4300 may comprise tabs 4310. The tabs 4310 may be inserted into engaging slots (e.g., the engaging slots 5510 in FIG. 28) at the rear of the second sub-inner housing 5000B. The tabs 4310 may be arranged in pairs, located on opposite sides of the main body 4300 along the lateral direction.

In some embodiments, as shown in FIG. 40, the third portion 5300 of the inner housing 5000 may comprise a top arm 5550 disposed above the upper extension 5520, and a bottom arm 5560 disposed below the lower extension 5530. With reference to FIG. 34, the top of the conductive member 4000 may be clamped between the upper extension 5520 and the top arm 5550, and the bottom of the conductive member 4000 may be clamped between the lower extension 5530 and the bottom arm 5560. This configuration enables more reliable fixation of the conductive member 4000, thereby mitigating the risk of unstable electrical coupling between components arising from loosening of the conductive member 4000. Additionally, elastic beams electrically coupled to the shield 3000 may be provided exclusively on the sides of the conductive member 4000, thereby simplifying the structure of the conductive member 4000 and facilitating production and processing.

As shown in FIG. 1C, the front portion of the shield 3000 may further comprise a mating beam 3110. The mating beam 3110 may be configured to be electrically coupled with the shield of the complementary electrical component once the electrical connector is mated with the complementary electrical component. This allows the shield of the complementary electrical component and the shield 3000 of the electrical connector to jointly provide full shielding for the conductive components of both the complementary electrical component and the electrical connector. The shield 3000 may comprise a plurality of mating beams 3110. The plurality of mating beams 3110 may be arranged around the mating ends 1100 of the conductive terminals 1000. Thus, the EMC performance can be improved. The first engaging feature 3120, which secures the shield 3000 to the inner housing 5000, may be located behind the mating beams 3110.

Exemplarily, as shown in FIGS. 12A and 14A, the outer housing 7000 may be provided with an outer housing engagement feature 7520, and the terminal assembly 6000 may be provided with a terminal assembly engagement feature 6100. The outer housing engagement feature 7520 may engage with the terminal assembly engagement feature 6100, abutting against the latter both forward and backward to restrain the terminal assembly 6000 from moving forward and backward relative to the outer housing 7000. In the illustrated embodiment, the terminal assembly engaging feature 6100 may be configured to comprise an outwardly protruding elastic portion stamped from the shield 3000, and a rigid protrusion located behind the elastic portion. The outer housing engaging feature 7520 may be configured to comprise an inwardly protruding stopper on the inner wall of the outer housing 7000. During insertion of the terminal assembly 6000 into the outer housing 7000 from the rear side, the elastic portion is elastically deformed when passing through the stopper. Once the elastic portion passes through the stopper, it reverts to its original shape, trapping the stopper between the elastic portion and the rigid protrusion.

For each set of embodiments, after the terminal assembly 6000 is initially locked to the outer housing 7000 via the terminal assembly engaging feature 6100 and the outer housing engaging feature 7520, a locking member may provide secondary locking to secure the terminal assembly 6000 to the outer housing 7000. For the first set of embodiments, as shown in FIGS. 1C, 2A to 2B, 7, and 9B, once the second locking member 8200 is in the locked position, the second projection 8220 thereof may lock the terminal assembly 6000 by engaging corresponding notches (e.g., the cable notch 2700, the inner housing notch 5700, and the shield notch 3150) of the terminal assembly 6000. For the second set of embodiments, as shown in FIG. 21, the second projection 8020 of the locking member 8000 may lock the terminal assembly 6000 by engaging corresponding notches (e.g., the cable notch 2700, the inner housing notch 5700, and the shield notch 3150) of the terminal assembly 6000.

Various aspects are described in this disclosure, which include, but are not limited to, the following aspects:
1. An electrical connector comprising: a housing (e.g., 5000) comprising a first portion (e.g., 5100) and a second portion (e.g., 5200), the first portion comprising a plurality of channels (e.g., 5400), the second portion comprising a plurality of protrusions (e.g., 5600), and a plurality of grooves (e.g., 5410) disposed between adjacent protrusions of the plurality of protrusions and each in communication with a respective channel of the plurality of channels; a plurality of conductive terminals (e.g., 1000), each of the plurality of conductive terminals comprising a mating end (e.g., 1100) disposed in a respective channel of the plurality of channels, a tail (e.g., 1200) extending out of the respective channel, and an intermediate portion (e.g., 1300) disposed in the respective channel and between the mating end and the tail; and a flexible cable (e.g., 2000) comprising a connecting portion (e.g., 2001) disposed on the second portion of the housing, the connecting portion comprising a plurality of openings (e.g., 2600) and a plurality of contact pads (e.g., 2220) disposed between adjacent openings of the plurality of openings, each opening of the plurality of openings receiving a respective protrusion of the plurality of protrusions, each contact pad of the plurality of contact pads electrically connected to a respective tail of a respective conductive terminal of the plurality of conductive terminals.
2. The electrical connector of aspect 1 or any other aspect, wherein each of the plurality of protrusions comprises a slanted surface (e.g., 5610) facing away from the mating ends of the plurality of conductive terminals.
3. The electrical connector of aspect 1 or any other aspect, wherein: the housing comprises a third portion (e.g., 5300) comprising a slot (e.g., 5340); the second portion of the housing is between the first portion and the third portion; and the flexible cable extends through the slot of the third portion of the housing.
4. The electrical connector of aspect 3 or any other aspect, wherein: the housing is an inner housing (e.g., 5000); the electrical connector comprises a shield (e.g., 3000) disposed outside the inner housing, an outer housing (e.g., 7000) disposed outside the shield, and a locking member (e.g., 8100); the outer housing comprises a side wall (e.g., 7300) having a recess (e.g., 7310); and the locking member comprises a body (e.g., 8130) disposed in the recess of the side wall of the outer housing, and a projection (e.g., 8120) extending from the body and above the second portion of the inner housing so as to sandwich the connecting portion of the flexible cable therebetween.
5. The electrical connector of aspect 4 or any other aspect, wherein: the recess of the side wall of the outer housing is a first recess (e.g., 7310); the side wall of the outer housing comprises a second recess (e.g., 7330); the outer housing comprises a bottom wall (e.g., 7200) having a third recess (e.g., 7350); the locking member is a first locking member (e.g., 8100); the electrical connector comprises a second locking member (e.g., 8200); and the second locking member comprises a body (e.g., 8230) disposed in the third recess of the outer housing, a first projection (e.g., 8210) extending from the body and into the second recess, and a second projection (e.g., 8220) extending from the body and engaging with both the third portion of the inner housing and the flexible cable.
6. The electrical connector of aspect 5 or any other aspect, wherein: the projection of the first locking member extends in a lateral direction perpendicular to a mating direction of the electrical connector; and the first and second projections of the second locking member extend in a vertical direction perpendicular to both the lateral direction and the mating direction.
7. The electrical connector of aspect 5 or any other aspect, wherein: the first locking member is configured to be mountable to the outer housing after the second locking member is mounted in place to the outer housing.
8. The electrical connector of aspect 6 or any other aspect, wherein: the first locking member is configured to be mountable to the outer housing along a lateral direction perpendicular to the mating direction of the electrical connector, and the second locking member is configured to be mountable to the outer housing along a vertical direction perpendicular to both the lateral direction and the mating direction, wherein: a portion of the body of the first locking member extends into the second recess to engage with the first projection of the second locking member; and/or a portion of the first projection of the second locking member extends into the first recess to engage with the body of the first locking member.
9. The electrical connector of any of aspects 4-8 or any other aspect, comprising: a conductive member (e.g., 4000) disposed on the third portion of the housing and electrically connecting the shield and a reference layer (e.g., 2400) of the flexible cable.
10. The electrical connector of aspect 9 or any other aspect, wherein: the third portion of the housing comprises upper and lower extensions (e.g., 5520, 5530), each of the upper and lower extensions comprising a notch (e.g., 5540); and the conductive member encloses the upper and lower extensions and comprises beams (e.g., 4100) extending inside through the notches.
11. The electrical connector of aspect 2 or any other aspect, wherein: the second portion comprises a first surface (e.g., 5220), and the plurality of protrusions protrude from the first surface; and toward the mating ends of the plurality of conductive terminals, the slanted surface extends gradually away from the first surface.
12. The electrical connector of aspect 2 or any other aspect, wherein: the tail of each of the plurality of conductive terminals comprises a contact portion (e.g., 1220) that is electrically connected to a respective contact pad of the plurality of contact pads, wherein: the slanted surface protrudes beyond the contact portion in a direction away from the mating ends of the plurality of conductive terminals; and/or at least portions of the plurality of protrusions protrude beyond the contact portions of the plurality of conductive terminals in a protruding direction thereof.
13. The electrical connector of aspect 1 or any other aspect, wherein: each of the plurality of conductive terminals comprises a first limiting portion, the housing comprises a second limiting portion, for each of the plurality of conductive terminals: the second limiting portion is configured to engage with the first limiting portion to restrain rotations of a respective conductive terminal about an axis thereof.
14. The electrical connector of aspect 13 or any other aspect, wherein: the second limiting portion comprises a slot (e.g., 5480) for receiving the first limiting portion, the first limiting portion comprises a bulge (e.g., 1230) protruding from a surface thereof, and the first limiting portion is in interference fit with the slot through the bulge.
15. The electrical connector of aspect 13 or any other aspect, wherein the tail of each of the plurality of conductive terminals comprises: a rigid portion (e.g., 1240) parallel to the connecting end of the flexible cable; and a beam (e.g., 1210) arranged in the rigid portion and electrically connected to a respective contact pad of the plurality of contact pads, wherein the rigid portion comprises sub-portions located on two sides of the beam, and the first limiting portion comprises the sub-portions.
16. The electrical connector of aspect 15 or any other aspect, wherein: the plurality of contact pads are electrically connected to the plurality of conductive terminals in a vertical direction perpendicular to a mating direction of the electrical connector; and the beam has a thickness along the vertical direction and a width along a lateral direction perpendicular to both the vertical direction and the mating direction, and the thickness is less than the width.
17. The electrical connector of aspect 13 or any other aspect, wherein: the first limiting portion comprises a side flange (e.g., 1330) protruding from an outer side surface of the intermediate portion of the respective conductive terminal, and the side flange is arranged at an end of the intermediate portion adjacent to the tail of the respective conductive terminal; the second limiting portion comprises a slot (e.g., 5440) engaged with the side flange.
18. The electrical connector of aspect 17 or any other aspect, wherein the side flange protrudes along a lateral direction perpendicular to a mating direction of the electrical connector.
19. An electrical connector comprising: a housing comprising an outer housing (e.g., 7000) and an inner housing (e.g., 5000); a plurality of conductive terminals (e.g., 1000) held in the inner housing, each of the plurality of conductive terminals comprising a mating end (e.g., 1100), a tail (e.g., 1200) comprising a contact portion (e.g., 1220), and an intermediate portion (e.g., 1300) between the mating end and the tail; a shield (e.g., 3000) disposed in the outer housing and enclosing the inner housing; a flexible cable (e.g., 2000) comprising a connecting portion (e.g., 2001) disposed in the inner housing and electrically connected to the contact portions of the tails of the plurality of conductive terminals; and a locking member (e.g., 8100) movable between a pre-locked position and a locked position, and configured to engage the outer housing in the pre-locked position, and engage the housing, the shield, and the connecting portion of the flexible cable in the locked position so as to restrain relevant movements therebetween.
20. The electrical connector of aspect 19 or any other aspect, wherein: the outer housing comprises a top (e.g., 7100) having an overhanging beam (e.g., 7120), a bottom (e.g., 7200) having first and second locking portions (e.g., 7210, 7220) aligned in a lateral direction perpendicular to a mating direction of the electrical connector, and a side (e.g., 7300) between the top and the bottom and comprising a recess (e.g., 7310); and the locking member comprises a body (e.g., 8130), and first and second arms (e.g., 8110, 8120) extending from the body, the body configured to be spaced from the side of the outer housing in the pre-locked position of the locking member and disposed in the recess of the side of the outer housing in the locked position of the locking member, the first arm extending beyond the second arm in the lateral direction and configured to latch to the first locking portion at the bottom of the outer housing in the pre-locked position of the locking member and the second locking portion at the bottom of the outer housing in the locked position of the locking member, the second arm configured to be disposed between the shield and the connecting portion of the flexible cable in the locked position of the locking member.
21. The electrical connector of aspect 20 or any other aspect, wherein: the bottom of the outer housing includes an engaging channel (e.g., 7321) extending along the lateral direction, and the first locking portion and the second locking portion are arranged in sequence along the engaging channel; the first arm of the locking member is configured to be mounted into the engaging channel to latch to the first locking portion when the locking member is in the pre-locked position and to latch to the second locking portion when the locking member is in the locked position; and the first locking portion and the second locking portion are configured to be accessible from an outside of the outer housing to release the locking member in the pre-locked position and the locking member in the locked position respectively from the outside of the outer housing.
22. The electrical connector of aspect 21 or any other aspect, wherein: the first locking portion and the second locking portion are respectively configured as a first aperture and a second aperture extending from a side wall of the engaging channel to an outer surface of the outer housing; or the first locking portion and the second locking portion are respectively a first groove and a second groove recessed from a side wall of the engaging channel along the mating direction, and the bottom of the outer housing further includes a window (e.g., 7250) recessed from an outer surface of the bottom to the first groove and the second groove and exposing the first groove and the second groove.
23. The electrical connector of aspect 20 or any other aspect, wherein: the locking member is a first locking member (e.g., 8100); the electrical connector comprises a second locking member (e.g., 8200); the side of the outer housing comprises first and second protrusions (e.g., 7230, 7240) offset in both the mating direction and a vertical direction, the vertical direction perpendicular to both the mating direction and the lateral direction; and the second locking member comprises a body (e.g., 8230), and first and second arms (e.g., 8210, 8220) extending from the body, the body configured to be spaced from the bottom of the outer housing in a pre-locked position of the second locking member and disposed in a recess (e.g., 7350) of the bottom of the outer housing in a locked position of the second locking member, the first arm extending beyond the second arm in the vertical direction and configured to latch to the first protrusion at the side of the outer housing in the pre-locked position of the second locking member and the second protrusion at the side of the outer housing in the locked position of the second locking member, the second arm configured to extend through the shield, the inner housing, and the connecting portion of the flexible cable in the locked position of the second locking member.
24. The electrical connector of aspect 23 or any other aspect, wherein: the second arm of the second locking member is configured to release the shield, the inner housing, and the connecting portion of the flexible cable in the pre-locked position of the second locking member.
25. The electrical connector of aspect 23 or any other aspect, wherein: the second locking member further has a transition position between the pre-locked position and the locked position; the second arm of the second locking member is configured to release only the connecting portion of the flexible cable in the pre-locked position of the second locking member.
26. The electrical connector of aspect 20 or any other aspect, wherein: the locking member further comprises a third arm (e.g., 8140) extending from the body; the third arm is configured to extend through the shield, the inner housing and the connecting portion of the flexible cable in the pre-locked position of the locking member.
27. The electrical connector of aspect 23 or any other aspect, wherein: the inner housing comprises a first sub-inner housing (e.g., 5000A) and a second sub-inner housing (e.g., 5000B), the plurality of conductive terminals are held in the first sub-inner housing, and the connecting portion of the flexible cable is electrically coupled to the plurality of conductive terminals through the second sub-inner housing; the second arm of the first locking member is configured to restrain movements of the first sub-inner housing at least along the mating direction; and the second arm of the second locking member is configured to restrain movements of the second sub-inner housing at least along the mating direction.
28. The electrical connector of aspect 23 or any other aspect, wherein the first protrusion is shorter than the second protrusion in the vertical direction.
29. An electrical connector comprising: a housing (e.g., 5000) comprising one or more channels (e.g., 5400); and one or more conductive terminals (e.g., 1000) held in respective channels of the housing, each of the one or more conductive terminals comprising a mating end (e.g., 1100), a tail (e.g., 1200), and an intermediate portion (e.g., 1300) between the mating end and the tail, the tail comprising a rigid portion (e.g., 1240) comprising one or more bulges (e.g., 1230) engaging the housing, and an elastic beam (e.g., 1210) comprising a contact portion (e.g., 1220) configured to electrically couple to a connecting end of a flexible cable (e.g., 2000).
30. The electrical connector of aspect 29 or any other aspect, wherein, for each of the one or more conductive terminals: the rigid portion of the tail comprises a frame around the elastic beam; the elastic beam protrudes from the frame in a vertical direction perpendicular to a mating direction of the electrical connector; and the one or more bulges protruding from the frame in the vertical direction.
31. The electrical connector of aspect 30 or any other aspect, wherein: the one or more bulges comprise four bulges each adjacent a respective corner of the frame.
32. The electrical connector of aspect 30 or any other aspect, wherein: the mating end and the intermediate portion are tubular; and the intermediate portion comprises features (e.g., 1310, 1320) protruding therefrom in a lateral direction perpendicular to both the vertical direction and the mating direction.
33. The electrical connector of aspect 32 or any other aspect, wherein: the housing comprises one or more grooves (e.g., 5410), each of the one or more grooves in communication with a respective channel of the one or more channels; and configured to receive a tail of a respective conductive terminal of the one or more conductive terminals.
34. The electrical connector of aspect 33 or any other aspect, wherein: the frame has a thickness in the vertical direction ranging from 0.14 mm to 0.16 mm; each of the one or more bulges has a thickness in the vertical direction ranging from 0.04 mm to 0.06 mm; and each of the one or more grooves has a thickness in the vertical direction ranging from 0.16 mm to 0.18 mm.
35. The electrical connector of any of aspects 32-34 or any other aspect, comprising: the flexible cable comprising one or more contact pads (e.g., 2220), wherein each of the one or more conductive terminals comprises a transition portion (e.g., 1250) joining the intermediate portion and the frame of the tail such that the intermediate portion is substantially aligned with the connecting end of the flexible cable in the mating direction and the frame is offset from the intermediate portion in the vertical direction.
36. The electrical connector of aspect 35 or any other aspect, wherein: the flexible cable comprises an opening (e.g., 2600) between adjacent contact pads of the one or more contact pads; the housing comprises a protrusion (e.g., 5600) protruding into the opening so as to restrain the flexible cable from moving in both the mating direction and the lateral direction; and the one or more bulges are configured to restrain the flexible cable from moving in the vertical direction.
37. A method for manufacturing an electrical connector comprises: mounting a conductive terminal (e.g., 1000) to a housing (e.g., 5000); and inserting a connecting portion (e.g., 2001) of a flexible cable (e.g., 2000) into the housing, wherein: the housing comprises a first feature (e.g., 5600), and the connecting portion of the flexible cable comprises a second feature (e.g., 2600); the first feature is configured to form interference with the second feature during the insertion of the connecting portion into the housing, so as to prevent a contact pad (e.g., 2220) on the connecting portion from contacting the conductive terminal; and the first feature is configured to release the interference when the connecting portion is inserted into place in the housing, so as to enable the contact pad to be electrically connected to the conductive terminal.
38. An electrical connector comprising: a housing comprising one or more grooves; and one or more conductive terminals (e.g., 1000) held in the housing, each of the one or more conductive terminals comprising a mating end (e.g., 1100), a tail (e.g., 1200) disposed in a respective groove of the one or more grooves, and an intermediate portion (e.g., 1300) between the mating end and the tail, the tail comprising a rigid portion (e.g., 1240), and an elastic beam (e.g., 1210) comprising a contact portion (e.g., 1220) configured to electrically couple to a connecting portion (e.g., 2001) of a flexible cable (e.g., 2000).
39. The electrical connector of aspect 38 or any other aspect, wherein, for each of the one or more conductive terminals: the rigid portion (e.g., 1240) of the tail comprises a frame around the elastic beam (e.g., 1210), and one or more bulges (e.g., 1230) engaging the housing; the elastic beam protrudes from the frame in a vertical direction perpendicular to a mating direction of the electrical connector; and the one or more bulges protrude from the frame in the vertical direction.
40. The electrical connector of aspect 39 or any other aspect, wherein: the one or more bulges (e.g., 1230) comprise four bulges each adjacent to a respective corner of the frame.
41. The electrical connector of aspect 39 or any other aspect, wherein: the mating end (e.g., 1100) and the intermediate portion (e.g., 1300) are tubular; and the intermediate portion comprises one or more features protruding therefrom in a lateral direction perpendicular to both the vertical direction and the mating direction.
42. The electrical connector of aspect 41 or any other aspect, wherein: the housing comprises one or more channels (e.g., 5400), each of the one or more channels in communication with a respective groove of the one or more grooves.
43. The electrical connector of aspect 42 or any other aspect, wherein: the frame has a thickness in the vertical direction ranging from 0.14 mm to 0.16 mm; each of the one or more bulges (e.g., 1230) has a thickness in the vertical direction ranging from 0.04 mm to 0.06 mm; and each of the one or more grooves has a thickness in the vertical direction ranging from 0.16 mm to 0.18 mm.
44. The electrical connector of any of aspects 41-43 or any other aspect, comprising: the flexible cable (e.g., 2000) comprising one or more contact pads (e.g., 2220), wherein each of the one or more conductive terminals comprises a transition portion (e.g., 1250) joining the intermediate portion (e.g., 1300) and the frame of the tail, such that the intermediate portion is substantially aligned with the connecting portion (e.g., 2001) of the flexible cable in the mating direction and that the frame is offset from the intermediate portion in the vertical direction.
45. The electrical connector of aspect 44 or any other aspect, wherein: the flexible cable (e.g., 2000) comprises an opening (e.g., 2600) between adjacent contact pads (e.g., 2220) of the one or more contact pads; the housing comprises a protrusion (e.g., 5600) protruding into the opening so as to restrain the flexible cable from moving in both the mating direction and the lateral direction; and the one or more bulges (e.g., 1230) are configured to restrain the flexible cable from moving in the vertical direction.
46. An electrical connector comprising: a housing comprising a first portion (e.g., 5100) and a second portion (e.g., 5200); a plurality of conductive terminals (e.g., 1000) held in the first portion of the housing, each of the plurality of conductive terminals comprising a mating end (e.g., 1100), a tail (e.g., 1200) configured for engaging a pad on an FFC, and an intermediate portion (e.g., 1300) between the mating end and the tail, wherein: the second portion of the housing is configured to receive a connecting portion (e.g., 2001) of a flexible cable (e.g., 2000) comprising a plurality of contact pads (e.g., 2220); and the second portion of the housing is configured to engage the flexible cable such the tails of the plurality of conductive terminals engage respective contact pads of the plurality of contact pads of the flexible cable without wiping the respective contact pads.
47. The electrical connector of aspect 46 or any other aspect, wherein: the first portion (e.g., 5100) of the housing comprises a plurality of channels (e.g., 5400); the second portion (e.g., 5200) of the housing comprises a plurality of protrusions (e.g., 5600), and a plurality of grooves (e.g., 5410) disposed between adjacent protrusions of the plurality of protrusions and each in communication with a respective channel of the plurality of channels; for each of the plurality of conductive terminals (e.g., 1000), the mating end (e.g., 1100) is disposed in a respective channel of the plurality of channels, the tail (e.g., 1200) extends out of the respective channel, and the intermediate portion (e.g., 1300) is disposed in the respective channel; the flexible cable (e.g., 2000) comprises a plurality of openings (e.g., 2600) disposed between adjacent contact pads (e.g., 2220) of the plurality of contact pads; and the plurality of protrusions of the second portion of the housing are configured to protrude into respective openings of the plurality of openings of the second portion of the housing.
48. The electrical connector of aspect 47 or any other aspect, wherein: each of the plurality of protrusions (e.g., 5600) comprises a slanted surface (e.g., 5610) facing away from the mating ends of the plurality of conductive terminals.
49. The electrical connector of aspect 47 or any other aspect, wherein: the housing comprises a third portion (e.g., 5300) comprising a slot (e.g., 5340) configured to receive the flexible cable (e.g., 2000); and the second portion (e.g., 5200) of the housing is between the first portion (e.g., 5100) and the third portion.
50. The electrical connector of aspect 49 or any other aspect, wherein: the housing is an inner housing (e.g., 5000); the electrical connector comprises a shield (e.g., 3000) disposed outside the inner housing, an outer housing (e.g., 7000) disposed outside the shield, and a locking member (e.g., 8100); the outer housing comprises a side wall (e.g., 7300) having a recess (e.g., 7310); and the locking member comprises a body (e.g., 8130) configured to be disposed in the recess of the side wall of the outer housing, and a projection (e.g., 8120) extending from the body and configured to extend above the second portion (e.g., 5200) of the inner housing so as to sandwich the connecting portion (e.g., 2001) of the flexible cable (e.g., 2000) therebetween.
51. The electrical connector of aspect 50 or any other aspect, wherein: the recess of the side wall of the outer housing is a first recess (e.g., 7310); the side wall (e.g., 7300) of the outer housing comprises a second recess (e.g., 7330); the outer housing (e.g., 7000) comprises a bottom wall (e.g., 7200) having a third recess (e.g., 7350); the locking member is a first locking member (e.g., 8100); the electrical connector comprises a second locking member (e.g., 8200); and the second locking member comprises a body (e.g., 8230) configured to be disposed in the third recess of the outer housing, a first projection (e.g., 8210) extending from the body and configured to extend into the second recess, and a second projection (e.g., 8220) extending from the body and configured to engage with both the third portion (e.g., 5300) of the inner housing and the flexible cable (e.g., 2000).
52. The electrical connector of aspect 51 or any other aspect, wherein: the projection (e.g., 8120) of the first locking member (e.g., 8100) extends in a lateral direction perpendicular to a mating direction of the electrical connector; and the first and second projections (e.g., 8210, 8220) of the second locking member (e.g., 8200) extend in a vertical direction perpendicular to both the lateral direction and the mating direction.
53. The electrical connector of aspect 51 or any other aspect, wherein: the first locking member (e.g., 8100) is configured to be mountable to the outer housing (e.g., 7000) after the second locking member (e.g., 8200) is mounted in place to the outer housing.
54. The electrical connector of aspect 51 or any other aspect, wherein: the first locking member (e.g., 8100) is configured to be mountable to the outer housing (e.g., 7000) along a lateral direction perpendicular to a mating direction of the electrical connector, and the second locking member (e.g., 8200) is configured to be mountable to the outer housing along a vertical direction perpendicular to both the lateral direction and the mating direction; a portion of the body (e.g., 8130) of the first locking member extends into the second recess (e.g., 7330) to engage with the first projection (e.g., 8210) of the second locking member; and/or a portion of the first projection of the second locking member extends into the first recess (e.g., 7310) to engage with the body of the first locking member.
55. The electrical connector of any of aspects 50-54 or any other aspect, comprising: a conductive member (e.g., 4000) disposed on the third portion (e.g., 5300) of the inner housing (e.g., 5000) and configured to electrically connect the shield (e.g., 3000) and a reference layer (e.g., 2400) of the flexible cable (e.g., 2000).
56. The electrical connector of aspect 55 or any other aspect, wherein: the third portion (e.g., 5300) of the housing comprises upper and lower extensions (e.g., 5520, 5530), each of the upper and lower extensions comprising a notch (e.g., 5540); and the conductive member (e.g., 4000) encloses the upper and lower extensions and comprises beams (e.g., 4100, 4200) extending inside through the notches.
57. An electrical connector comprising: a housing comprising an outer housing (e.g., 7000), and an inner housing (e.g., 5000) configured to receive a connecting portion (e.g., 2001) of a flexible cable (e.g., 2000); a plurality of conductive terminals (e.g., 1000) held in the inner housing, each of the plurality of conductive terminals comprising a mating end (e.g., 1100), a tail (e.g., 1200) comprising a contact portion (e.g., 1220) configured to be electrically connected to a contact pad (e.g., 2220) of the flexible cable, and an intermediate portion (e.g., 1300) between the mating end and the tail; and a locking member (e.g., 8100, 8200) movable between a pre-locked position and a locked position, the locking member configured to engage the outer housing in the pre-locked position, and configured to engage the housing, and the connecting portion of the flexible cable in the locked position so as to restrain movements therebetween.
58. The electrical connector of aspect 57 or any other aspect, comprising a shield (e.g., 3000) disposed in the outer housing and enclosing the inner housing, wherein the locking member is configured to engage the shield (e.g., 3000).
59. The electrical connector of aspect 57 or any other aspect, wherein: the outer housing (e.g., 7000) comprises a top (e.g., 7100), a bottom (e.g., 7200) having first and second locking portions (e.g., 7210, 7220) aligned in a lateral direction perpendicular to a mating direction of the electrical connector, and a side (e.g., 7300) between the top and the bottom and comprising a recess (e.g., 7310); and the locking member (e.g., 8100) comprises a body (e.g., 8130), and first and second arms (e.g., 8110, 8120) extending from the body, the first arm extending beyond the second arm in the lateral direction, the locking member configured to: in the pre-locked position, have the body spaced from the side of the outer housing, and have the first arm latched to the first locking portion (e.g., 7210) at the bottom of the outer housing; and in the locked position, have the body disposed in the recess of the side of the outer housing, have the first arm latched to the second locking portion (e.g., 7220) at the bottom of the outer housing, and have the second arm disposed between the shield (e.g., 3000) and the connecting portion (e.g., 2001) of the flexible cable (e.g., 2000).
60. The electrical connector of aspect 59 or any other aspect, wherein: the side (e.g., 7300) of the outer housing comprises first and second protrusions (e.g., 7230, 7240) offset in both the mating direction and a vertical direction, the vertical direction perpendicular to both the mating direction and the lateral direction; the locking member is a first locking member (e.g., 8100); and the electrical connector comprises a second locking member (e.g., 8200), the second locking member comprising a body (e.g., 8230), and first and second arms (e.g., 8210, 8220) extending from the body, the first arm extending beyond the second arm in the vertical direction, the second locking member configured to: in a pre-locked position, have the body spaced from the bottom (e.g., 7200) of the outer housing, and have the first arm latched to the first protrusion (e.g., 7230) at the side of the outer housing; and in a locked position, have the body disposed in a recess (e.g., 7350) of the bottom of the outer housing, have the first arm latched to the second protrusion (e.g., 7240) at the side of the outer housing, and have the second arm (e.g., 8220) extend through the shield (e.g., 3000), the inner housing (e.g., 5000), and the connecting portion (e.g., 2001) of the flexible cable (e.g., 2000).
61. The electrical connector of aspect 59 or any other aspect, wherein: the locking member (e.g., 8100) further comprises a third arm (e.g., 8140) extending from the body (e.g., 8130); and the third arm is configured to extend through the shield (e.g., 3000), the inner housing (e.g., 5000) and the connecting portion (e.g., 2001) of the flexible cable (e.g., 2000) in the locked position of the locking member.
62. The electrical connector of aspect 60 or any other aspect, wherein: the inner housing (e.g., 5000) comprises a first sub-inner housing (e.g., 5000A) and a second sub-inner housing (e.g., 5000B), the plurality of conductive terminals (e.g., 1000) are held in the first sub-inner housing, and the connecting portion (e.g., 2001) of the flexible cable (e.g., 2000) is electrically coupled to the plurality of conductive terminals through the second sub-inner housing; the second arm (e.g., 8120) of the first locking member (e.g., 8100) is configured to restrain movements of the first sub-inner housing at least along the mating direction; and the second arm (e.g., 8220) of the second locking member (e.g., 8200) is configured to restrain movements of the second sub-inner housing at least along the mating direction.
63. The electrical connector of aspect 60 or any other aspect, wherein: the first protrusion (e.g., 7230) is shorter than the second protrusion (e.g., 7240) in the vertical direction.

Having thus described several aspects of several embodiments, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only comprise the orientations of the components shown in the accompanying drawings, but also comprise different orientations in use or operation. For example, if the component in the accompanying drawings is turned upside down completely, the component “above other components or features” or “on other components or features” will comprise the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to comprise all these cases.

It should be noted that the terms used herein are only for describing specific embodiments, and are not intended to limit the exemplary embodiments according to the present application. As used herein, an expression of a singular form comprises an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing comprising one or more grooves; and
one or more conductive terminals held in the housing, each of the one or more conductive terminals comprising a mating end, a tail disposed in a respective groove of the one or more grooves, and an intermediate portion between the mating end and the tail, the tail comprising a rigid portion, and an elastic beam comprising a contact portion configured to electrically couple to a connecting portion of a flexible cable.

2. The electrical connector of claim 1, wherein, for each of the one or more conductive terminals:
the rigid portion of the tail comprises a frame around the elastic beam, and one or more bulges engaging the housing;
the elastic beam protrudes from the frame in a vertical direction perpendicular to a mating direction of the electrical connector; and
the one or more bulges protrude from the frame in the vertical direction.

3. The electrical connector of claim 2, wherein:
the one or more bulges comprise bulges adjacent to respective corners of the frame.

4. The electrical connector of claim 2, wherein:
the mating end and the intermediate portion are tubular; and
the intermediate portion comprises one or more features protruding therefrom in a lateral direction perpendicular to both the vertical direction and the mating direction.

5. The electrical connector of claim 4, wherein:
the housing comprises one or more channels, each of the one or more channels in communication with a respective groove of the one or more grooves.

6. The electrical connector of claim 5, wherein:
the frame has a thickness in the vertical direction ranging from 0.14 mm to 0.16 mm;
each of the one or more bulges has a thickness in the vertical direction ranging from 0.04 mm to 0.06 mm; and
each of the one or more grooves has a thickness in the vertical direction ranging from 0.16 mm to 0.18 mm.

7. An electrical connector comprising:
a housing comprising a first portion and a second portion;
a plurality of conductive terminals held in the first portion of the housing, each of the plurality of conductive terminals comprising a mating end, a tail configured for engaging a pad on an FFC, and an intermediate portion between the mating end and the tail, wherein:
the second portion of the housing is configured to receive a connecting portion of a flexible cable comprising a plurality of contact pads; and
the second portion of the housing is configured to engage the flexible cable such the tails of the plurality of conductive terminals engage respective contact pads of the plurality of contact pads of the flexible cable without wiping the respective contact pads.

8. The electrical connector of claim 7, wherein:
the first portion of the housing comprises a plurality of channels;
the second portion of the housing comprises a plurality of protrusions, and a plurality of grooves disposed between adjacent protrusions of the plurality of protrusions and each in communication with a respective channel of the plurality of channels;
for each of the plurality of conductive terminals, the mating end is disposed in a respective channel of the plurality of channels, the tail extends out of the respective channel, and the intermediate portion is disposed in the respective channel;
the flexible cable comprises a plurality of openings disposed between adjacent contact pads of the plurality of contact pads; and
the plurality of protrusions of the second portion of the housing are configured to protrude into respective openings of the plurality of openings of the second portion of the housing.

9. The electrical connector of claim 8, wherein:
each of the plurality of protrusions comprises a slanted surface facing away from the mating ends of the plurality of conductive terminals.

10. The electrical connector of claim 8, wherein:
the housing comprises a third portion comprising a slot configured to receive the flexible cable; and
the second portion of the housing is between the first portion and the third portion.

11. The electrical connector of claim 10, wherein:
the housing is an inner housing;
the electrical connector comprises a shield disposed outside the inner housing, an outer housing disposed outside the shield, and a locking member;
the outer housing comprises a side wall having a recess; and
the locking member comprises a body configured to be disposed in the recess of the side wall of the outer housing, and a projection extending from the body and configured to extend above the second portion of the inner housing so as to sandwich the connecting portion of the flexible cable therebetween.

12. The electrical connector of claim 11, comprising:
a conductive member disposed on the third portion of the inner housing and configured to electrically connect the shield and a reference layer of the flexible cable.

13. The electrical connector of claim 12, wherein:
the third portion of the housing comprises upper and lower extensions, each of the upper and lower extensions comprising a notch; and
the conductive member encloses the upper and lower extensions and comprises beams extending inside through the notches.

14. An electrical connector comprising:
a housing comprising an outer housing, and an inner housing configured to receive a connecting portion of a flexible cable;
a plurality of conductive terminals held in the inner housing, each of the plurality of conductive terminals comprising a mating end, a tail comprising a contact portion configured to be electrically connected to a contact pad of the flexible cable, and an intermediate portion between the mating end and the tail; and
a locking member movable between a pre-locked position and a locked position, the locking member configured to engage the outer housing in the pre-locked position, and configured to engage the housing, and the connecting portion of the flexible cable in the locked position so as to restrain movements therebetween.

15. The electrical connector of claim 14, comprising:
a shield disposed in the outer housing and enclosing the inner housing,
wherein the locking member is configured to engage the shield.

16. The electrical connector of claim 15, wherein:
the outer housing comprises a top, a bottom having first and second locking portions aligned in a lateral direction perpendicular to a mating direction of the electrical connector, and a side between the top and the bottom and comprising a recess; and
the locking member comprises a body, and first and second arms extending from the body, the first arm extending beyond the second arm in the lateral direction, the locking member configured to:
in the pre-locked position, have the body spaced from the side of the outer housing, and have the first arm latched to the first locking portion at the bottom of the outer housing; and
in the locked position, have the body disposed in the recess of the side of the outer housing, have the first arm latched to the second locking portion at the bottom of the outer housing, and have the second arm disposed between the shield and the connecting portion of the flexible cable.

17. The electrical connector of claim 16, wherein:
the side of the outer housing comprises first and second protrusions offset in both the mating direction and a vertical direction, the vertical direction perpendicular to both the mating direction and the lateral direction;
the locking member is a first locking member; and
the electrical connector comprises a second locking member, the second locking member comprising a body, and first and second arms extending from the body, the first arm extending beyond the second arm in the vertical direction, the second locking member configured to:
in a pre-locked position, have the body spaced from the bottom of the outer housing, and have the first arm latched to the first protrusion at the side of the outer housing; and
in a locked position, have the body disposed in a recess of the bottom of the outer housing, have the first arm latched to the second protrusion at the side of the outer housing, and have the second arm extend through the shield, the inner housing, and the connecting portion of the flexible cable.

18. The electrical connector of claim 16, wherein:
the locking member further comprises a third arm extending from the body; and
the third arm is configured to extend through the shield, the inner housing and the connecting portion of the flexible cable in the locked position of the locking member.

19. The electrical connector of claim 17, wherein:
the inner housing comprises a first sub-inner housing and a second sub-inner housing, the plurality of conductive terminals are held in the first sub-inner housing, and the connecting portion of the flexible cable is electrically coupled to the plurality of conductive terminals through the second sub-inner housing;
the second arm of the first locking member is configured to restrain movements of the first sub-inner housing at least along the mating direction; and
the second arm of the second locking member is configured to restrain movements of the second sub-inner housing at least along the mating direction.

20. The electrical connector of claim 17, wherein:
the first protrusion is shorter than the second protrusion in the vertical direction.
